(19) United States
(12) Patent Application Publication
(10) Pub. No.: US 2026/0322630 A1
(43) Pub. Date: Oct. 15, 2026

(54) STATE-BOUND AUTHORITY CERTIFICATES, SEMANTIC-DELTA ENVELOPES, DERIVATION-GRAPH AUTHORIZATION, DELEGATED SUB-CAPABILITIES, DRIFT-AWARE REAUTHORIZATION, AND SECRET-FIREWALLED EXECUTION FOR AUTONOMOUS AI SYSTEMS

(71) Applicant: Nirmal Singh Baid, Miami, FL (US)

(72) Inventor: Nirmal Singh Baid, Miami, FL (US)

(21) Appl. No.: 19/697,382

(22) Filed: Jun. 3, 2026

Related U.S. Application Data
(63) Continuation-in-part of application No. 19/642,501, filed on Apr. 8, 2026.
Application No. 19/642,501 is a continuation-in-part of application No. 19/349,934, filed on Oct. 3, 2025, now Pat. No. 12,675,385.
(63) Continuation-in-part of application No. 19/458,768, filed on Jan. 24, 2026.
(63) Continuation-in-part of application No. 19/677,996, filed on May 14, 2026.
(60) Provisional application No. 63/704,626, filed on Oct. 8, 2024.
(60) Provisional application No. 63/749,218, filed on Jan. 24, 2025.
(60) Provisional application No. 63/857,378, filed on Aug. 4, 2025.
(60) Provisional application No. 63/929,760, filed on Dec. 2, 2025.

(51) Int. Cl. H04L 9/32

(52) U.S. Cl. CPC H04L 9/3268

(57) ABSTRACT

A control-plane architecture for autonomous AI execution receives a proposed action, canonicalizes it into a canonical action descriptor, and binds a signed authority certificate to a canonical action digest with state, policy, environment, derivation, and semantic-delta values. Execution is gated on certificate validation and may be delayed, transformed, rerouted, queued, or suppressed. Channel-binding records may identify primary and alternate source-analysis, GUI, browser, operating-system, mobile, or programmatic channels, switch predicates, verifier sufficiency profiles, environment classes, and non-expansion constraints. Upon drift or channel failure, a continuity capsule may link predecessor and successor authority artifacts with checkpoint and digest values. Replay bundles, delegated sub-capabilities, secret-firewalled execution, graph fusion, and cyber-defense evidence bundles are also supported.

### CROSS-REFERENCE TO RELATED APPLICATIONS

This application is a continuation-in-part of U.S. patent application Ser. No. 19/642,501, entitled HARDENED AUTOMATION OF OS-LEVEL TASKS BY ARTIFICIAL INTELLIGENCE AGENTS WITH APPROVAL-BOUND EXECUTION AND TAMPER-EVIDENT PROVENANCE, filed on Apr. 8, 2026, which is a continuation-in-part of U.S. patent application Ser. No. 19/349,934, entitled AUTOMATING CODE ANALYSIS, DEPENDENCY MAPPING, AND ADAPTIVE TASK EXECUTION WITH AI, filed on Oct. 3, 2025, which claims the benefit of U.S. Provisional Patent Application No. 63/704,626, entitled SYSTEM AND METHOD FOR AUTOMATED CODE ANALYSIS, META TAGGING, DEPENDENCY MAPPING, AND DYNAMIC HELP DESK GENERATION USING AI, LLMS, GANS, AND MULTI-MODAL INTERFACES, filed on Oct. 8, 2024. The entire disclosures of the foregoing applications are incorporated herein by reference to the extent permitted by law.

This application is also a continuation-in-part of U.S. patent application Ser. No. 19/458,768, entitled SYSTEMS AND METHODS FOR DYNAMIC CONTEXT RETRIEVAL, CONTEXTUAL MEMORY, AND AUTONOMOUS SOFTWARE CREATION USING SWARM-BASED ORCHESTRATION AND EPHEMERAL VALIDATION, filed on Jan. 24, 2026, which claims the benefit of U.S. Provisional Patent Application No. 63/749,218, entitled DYNAMIC CONTEXT RETRIEVAL AND AUTONOMOUS SOFTWARE CREATION SYSTEM FOR CONVERSATIONAL AI, filed on Jan. 24, 2025. The entire disclosures of the foregoing applications are incorporated herein by reference to the extent permitted by law.

This application is also a continuation-in-part of U.S. patent application Ser. No. 19/677,996, entitled DETERMINISTIC AGENT COMPUTATION PLATFORM WITH UNIFIED COMPONENT NORMALIZATION, BLUEPRINT COMPILATION, ENVIRONMENT LINEAGE CONTROL, MOBILE-HYBRID EXECUTION, RETRIEVAL-AUGMENTED MEMORY, ARCHITECTURE EVOLUTION, AND WORKFLOW-CONDITIONED APPLICATION CONSTRUCTION, filed on May 14, 2026, which claims the benefit of U.S. Provisional Patent Application No. 63/857,378, entitled WORKFLOW-CONDITIONED UI LAYOUT GENERATION, CRUD APPLICATION SCAFFOLDING, AI-ASSISTED DEBUGGING, PREDICTIVE SCHEDULING, COLLABORATIVE WORKFLOW EDITING, AND MULTI-SOURCE COMMUNICATION INGESTION FOR ADVANCED HELP DESK AUTOMATION, filed on Aug. 4, 2025, and U.S. Provisional Patent Application No. 63/929,760, entitled UNIFIED AGENTIC COMPUTATION, ARCHITECTURE EVOLUTION, AND AUTOMATIC APPLICATION CONSTRUCTION SYSTEM WITH MULTI-AGENT ORCHESTRATION, DETERMINISTIC RUNTIMES, RETRIEVAL-AUGMENTED MEMORY, UNIVERSAL COMPONENT NORMALIZATION, AND MOBILE-HYBRID EXECUTION, filed on Dec. 2, 2025. The entire disclosures of the foregoing applications are incorporated herein by reference to the extent permitted by law.

### FIELD OF TECHNOLOGY

The present disclosure relates generally to artificial intelligence, secure execution control, policy-constrained automation, and provenance-aware action authorization.

More specifically, the present disclosure relates to systems that bind authority for AI-generated actions to a canonical action descriptor, a pre-execution state digest, a policy snapshot hash, an environment measurement digest, an approved semantic-delta envelope, and a derivation-graph digest, and that enforce execution, delegation, reauthorization, secret handling, and replay verification based on such bindings.

### BACKGROUND

Autonomous AI systems increasingly perform consequential actions through application programming interfaces, scripts, connectors, browsers, operating-system-level controls, and mobile devices. Conventional security mechanisms often treat such actions as ordinary software requests without capturing the semantic context in which the AI system proposed the actions.

Generic approval workflows may require a user or policy service to approve an action, but the approval is often detached from the exact machine-interpretable action description that was executed.

Small changes in parameters, target resources, or surrounding state may therefore evade the original approval context.

Likewise, many existing systems verify only whether an action completed, not whether the action changed the world within an approved envelope. A task that finishes successfully may still produce an unauthorized semantic change to a file, a spreadsheet, a DOM tree, an access-control list, a record set, a configuration object, or a mobile device state.

Modern AI actions are also influenced by mixed-source derivation chains including user instructions, retrieved documents, screenshots, messages, memory entries, connector responses, tool outputs, and model-generated intermediates. Conventional systems often mark some sources as trusted or untrusted, but they do not bind the actual influence structure for a specific proposed action into the authorization artifact itself.

Existing systems further allow secrets, credentials, keys, tokens, or protected content to flow into model-visible context or logs. Generic vault integration does not by itself prevent secret-bearing content from being reintroduced into prompt context, memory, or exported artifacts after execution.

Paused, queued, recurring, or scheduled AI workflows introduce further problems. An authority decision made at one time may become stale when the environment, policy, resource state, derivation graph, permissions, or tool configuration drifts before the workflow resumes.

Multi-agent systems create additional attack surfaces because a parent orchestrator may ask a sub-agent or tool-specific worker to perform a narrower task, yet conventional systems often fail to encode a provable narrowing of scope or a cascade-revocation relationship.

There remains a need for concrete, machine-verifiable authority structures that bind AI execution to state, policy, derivation, environment, and approved semantic-change boundaries, and that support delegation, reauthorization, secret firewalls, revocation, and replay verification.

### SUMMARY

In one aspect, a method receives an AI-generated proposed action and canonicalizes the proposed action into a canonical action descriptor having a deterministic serialization and a canonical action digest.

In another aspect, the method captures or receives a pre-execution state artifact and computes a pre-execution state digest over a canonical representation of the pre-execution state artifact.

In another aspect, the method computes or receives a policy snapshot hash that represents a policy state under which the proposed action may be authorized, and computes or receives an environment measurement digest that represents an execution substrate or environment state under which the proposed action may be authorized.

In another aspect, the method predicts, computes, or receives an approved semantic-delta envelope that specifies one or more permitted or forbidden semantic changes associated with execution of the proposed action, and binds the approved semantic-delta envelope or a digest thereof into an authority artifact.

In another aspect, the method constructs a derivation graph for the proposed action, the derivation graph representing one or more influencing sources and transformations associated with the proposed action, and computes a derivation-graph digest over a canonical representation of the derivation graph.

In another aspect, a certificate service generates a signed action authority certificate bound to the canonical action digest, the pre-execution state digest, the policy snapshot hash, the environment measurement digest, the approved semantic-delta envelope or digest thereof, and the derivation-graph digest.

In another aspect, an execution gate validates the action authority certificate before permitting execution and suppresses execution if any required binding fails validation, if a nonce is reused, if an expiration condition is violated, if a revocation condition is present, or if a current digest no longer matches a certificate-bound digest.

In another aspect, a delegated sub-capability service derives a child authority artifact from a parent authority artifact, the child authority artifact encoding a strict narrowing of at least one of scope, resource set, action class, allowed semantic delta, or expiration window.

In another aspect, a resume or schedule package stores one or more authority-bound digests and, upon resume or scheduled activation, invalidates a stale authority artifact if current state, policy, environment, derivation, or permission conditions materially drift from the stored package.

In another aspect, a secret broker resolves placeholder references to secrets only inside an execution substrate that is outside model-visible context, and restricted output handling rules prevent secret-derived data from reentering model context, memory, or export channels absent authorization.

In another aspect, a replay subsystem verifies an execution by recomputing one or more digests, validating one or more signatures, validating nonce uniqueness, comparing an actual semantic delta against the approved semantic-delta envelope, and reconstructing lineage among a proposed action, an authority artifact, an execution result, and an audit bundle.

These and other aspects increase authorization fidelity, constrain side effects to approved semantic boundaries, reduce derivation-based injection risk, provide provable delegation semantics, protect secret material, and improve auditability of autonomous AI execution.

In another aspect, the control-plane architecture issues or validates a verified-state checkpoint token after one or more intermediate actions have satisfied one or more precondition, postcondition, semantic-delta, policy, or derivation checks, and a recovery subsystem replays from a checkpoint, activates a compensating-action plan, restores a prior state artifact, or branches into a recovery workflow when divergence or failure is detected.

In another aspect, the architecture fuses source-derived workflow structures and GUI-derived workflow structures by computing node-correspondence scores, edge weights, hidden-state hypotheses, and ranked path selections across a merged graph, and the ranked path selections may be used by a root-cause hypothesis engine, a policy queue, a shared-control remediation session, or a delegated sub-capability service.

In another aspect, an action-level policy orchestration service performs allow, deny, transform, delay, reroute, queue, or approval-routing decisions for contemplated actions, may issue just-in-time scoped credentials or scoped execution tokens, may synchronize remediation state with a ticket or case object, and may support shared-control remediation in which a human operator and an AI agent exchange bounded control of a remote or local session under provenance and authority constraints.

In another aspect, an artifact-aware channel selector computes a channel availability vector for a contemplated action, workflow segment, recovery branch, or graph edge and selects a primary channel together with one or more bounded alternate channels, the channels including at least a source-analysis channel, a GUI-observation or GUI-action channel, and a programmatic execution channel.

In another aspect, a channel-binding record or a digest thereof is bound into an authority artifact and encodes at least one of a primary channel identifier, one or more alternate channel identifiers, one or more switch predicates, a verifier sufficiency profile, a permitted environment-class set, a semantic-delta ceiling, a side-effect budget, a privilege ceiling, or one or more non-expansion constraints.

In another aspect, when drift, insufficiency, or failure is detected, a continuity capsule links a predecessor authority artifact, a verified-state checkpoint token, one or more state digests, one or more policy or environment digests, and a successor authority artifact so that execution may continue in a different channel without losing replayability, provenance continuity, or authorization fidelity.

In another aspect, a fused provenance timeline records source-analysis steps, GUI-observation or GUI-action steps, and programmatic execution steps in a shared lineage graph and permits later verification that cross-channel execution remained within approved semantic bounds and did not expand scope, privilege, environment class, or side-effect budget without reauthorization.

### BRIEF DESCRIPTION OF THE DRAWINGS

FIG. 1 illustrates an example authority-plane architecture including a canonicalizer, policy snapshot service, environment measurement service, state capture service, derivation graph builder, certificate service, execution gate, secret broker, replay service, and revocation service.

FIG. 2 illustrates an example canonical action descriptor and action authority certificate issuance pipeline.

FIG. 3 illustrates an example pre-execution state capture and state-digest validation flow.

FIG. 4 illustrates an example approved semantic-delta envelope generation process and post-execution semantic-delta comparison process.

FIG. 5 illustrates an example derivation graph, derivation metadata, and derivation-graph digest authorization flow.

FIG. 6 illustrates an example delegated sub-capability chain with narrowing constraints and revocation cascade.

FIG. 7 illustrates an example resume and schedule reauthorization workflow responsive to drift.

FIG. 8 illustrates an example secret broker and model-context firewall architecture.

FIG. 9 illustrates an example revocation, containment, and replay-verification architecture.

FIG. 10 illustrates an example environment measurement and attestation binding flow.

FIG. 11 illustrates an example end-to-end method flow for state-bound authorization of autonomous AI actions.

FIG. 12 illustrates an example checkpoint-token issuance, verified-state recovery, and compensating-action workflow.

FIG. 13 illustrates an example graph-fusion architecture that merges source-derived and GUI-derived workflow graphs using correspondence scoring, hidden-state inference, and ranked path selection.

FIG. 14 illustrates an example root-cause hypothesis engine and action-level policy queue architecture with allow, deny, transform, delay, reroute, and approval outcomes.

FIG. 15 illustrates an example just-in-time scoped credential issuance and secret-redaction pipeline.

FIG. 16 illustrates an example environment-class routing, shared-control remediation, and ITSM ticket-lifecycle synchronization architecture.

FIG. 17 illustrates an example supervisor-coordinated role lineup including source-analysis, GUI-exploration, execution, verification, provenance, and policy-orchestration roles.

FIG. 18 illustrates an example vulnerability knowledge model and asset-exposure graph.

FIG. 19 illustrates an example defensive exposure-path engine and remediation selection pipeline.

FIG. 20 illustrates an example cyber validation sandbox and patch-effect verification flow.

FIG. 21 illustrates an example artifact-aware tri-modal channel-selection architecture including source-analysis, GUI-observation or GUI-action, and programmatic execution channels under certificate-bound control.

FIG. 22 illustrates an example channel availability vector and channel-binding record with switch predicates, verifier-sufficiency fields, alternate-channel fields, and non-expansion constraints.

FIG. 23 illustrates an example mid-workflow failover sequence in which a continuity capsule links a predecessor certificate, a verified-state checkpoint token, and a successor certificate for execution in a different channel.

FIG. 24 illustrates an example fused cross-channel provenance timeline and replay graph spanning source-derived, GUI-derived, and programmatic steps.

FIG. 25 illustrates an example cross-channel execution graph having channel-substitutable edges, channel-exclusive edges, verification-only edges, and environment-class promotion paths.

### DETAILED DESCRIPTION

### Definitions

As used herein, a canonical action descriptor is a deterministic machine-readable record that describes a proposed AI action in normalized form. A canonical action descriptor may include an action identifier, an action class, a target resource description, one or more parameter fields, one or more scope fields, one or more expected preconditions, one or more expected postconditions, one or more allowed semantic changes, and one or more environment constraints.

As used herein, an action authority certificate is a signed machine-verifiable artifact that grants authority to execute a specific proposed action or workflow edge under specified binding conditions. The action authority certificate may bind one or more digests, policy values, time values, scope values, actor values, or revocation values.

As used herein, a semantic-delta envelope is a machine-readable representation of permitted, forbidden, or bounded change semantics associated with an action. A semantic-delta envelope may include one or more field-level rules, object-level rules, graph-level rules, tolerance values, forbidden classes of modifications, and compensating-response instructions.

As used herein, a derivation graph is a graph representation of one or more source nodes, transformation nodes, model-output nodes, memory nodes, retrieval nodes, tool-response nodes, and approval nodes that influenced a proposed action.

As used herein, an environment measurement digest is a digest computed over one or more environment attributes such as image identifiers, package versions, tool bundle hashes, browser extension sets, connector sets, executable measurements, or attestation values.

As used herein, a policy snapshot hash is a hash or digest representing a machine-readable policy state or a canonical serialization thereof at a time relevant to authorization or execution.

As used herein, a resume package is a machine-readable package stored for a paused, queued, or recurring workflow and comprising sufficient metadata to determine whether prior authority remains valid at a later time.

As used herein, a delegated sub-capability is a child authority artifact derived from a parent authority artifact and encoding a narrower scope than the parent authority artifact.

As used herein, a model-context firewall is a boundary rule set and enforcement mechanism that prevents raw secret values or restricted secret-derived content from entering model-visible context absent authorization.

As used herein, a replay bundle is a machine-readable package that permits after-the-fact verification of a prior execution by validating one or more digests, one or more signatures, one or more nonce values, and one or more semantic-delta comparisons.

As used herein, a channel availability vector is a machine-readable record that represents whether, and under what constraints, one or more execution or analysis channels are available for a contemplated action, workflow segment, recovery branch, or graph edge. The vector may include source-visibility indicators, API or connector reachability indicators, GUI observability indicators, permission indicators, environment-class indicators, verifier-sufficiency indicators, latency or cost indicators, irreversibility indicators, risk indicators, or combinations thereof.

As used herein, a channel-binding record is a machine-readable record that identifies a primary channel, one or more alternate channels, one or more switch predicates, one or more verifier requirements, one or more permitted environment classes, and one or more non-expansion constraints applicable to a contemplated action or workflow segment. The channel-binding record may itself be signed, may be hashed into another signed artifact, or may be deterministically serialized for later replay verification.

As used herein, a verifier sufficiency profile is a machine-readable specification of evidence, observations, or checks required for a channel to be considered adequate for authorization, execution, verification, or replay. A verifier sufficiency profile may require one or more return codes, object-model states, screenshots, DOM or accessibility-tree evidence, log entries, file diffs, user-visible confirmations, or combinations thereof.

As used herein, a continuity capsule is a machine-readable package generated when execution is resumed, migrated, rerouted, or otherwise continued across a channel boundary. The continuity capsule may link a predecessor authority artifact, a successor authority artifact, a verified-state checkpoint token, one or more state digests, a policy snapshot hash, an environment measurement digest, a derivation-graph digest, unresolved obligations, and one or more portability or equivalence indicators.

As used herein, a channel-substitutable edge is a workflow or execution-graph edge for which more than one channel is authorized to achieve substantially the same semantic effect, subject to the conditions encoded in a channel-binding record. By contrast, a verification-only edge is an edge that authorizes a channel only for observation, confirmation, or replay support, without authorizing that channel to perform the underlying state-changing act.

As used herein, a “proposed action” refers to an action, workflow step, command, request, operation, or execution intent that is contemplated for performance by or on behalf of an autonomous artificial intelligence system before the action is executed. A proposed action may be represented in human-readable form, machine-readable form, or both, and may be received from a planner, orchestrator, agent runtime, workflow compiler, user interface, schedule trigger, message queue, or human reviewer.

As used herein, an “autonomous artificial intelligence system” refers to a computer-based system that uses one or more artificial intelligence models, agents, planners, orchestrators, or automated decision components to generate, select, review, or cause execution of actions with limited or no contemporaneous human control. An autonomous artificial intelligence system may include a single agent, a multi-agent arrangement, or a supervisor-coordinated role lineup.

As used herein, a “canonical action descriptor” refers to a deterministic machine-readable record that describes a proposed action in normalized form. A canonical action descriptor may include an action identifier, action class, target resource description, parameter fields, scope fields, expected preconditions, expected postconditions, allowed semantic changes, environment constraints, derivation references, policy references, time values, a nonce, or metadata.

As used herein, a “canonical action digest” refers to a digest computed over a canonical representation of a canonical action descriptor. A canonical action digest may be computed after deterministic normalization of fields and after omission of fields designated as non-material for digest purposes.

As used herein, a “deterministic serialization” refers to a serialization format or process that produces the same machine-readable representation for semantically equivalent input data. Deterministic serialization may normalize field order, whitespace, aliases, field formats, or other non-material presentation differences.

As used herein, a “pre-execution state artifact” refers to a captured or received representation of a state that exists before execution of a proposed action. A pre-execution state artifact may include structured API object state, file snapshots, document object model snapshots, accessibility tree snapshots, spreadsheet object-model state, configuration state, permission state, mobile device state, or other state information relevant to validation or replay.

As used herein, a “pre-execution state digest” refers to a digest computed over a canonical representation of a pre-execution state artifact. A pre-execution state digest may be used to determine whether a current state matches a state bound into an authority artifact.

As used herein, a “policy snapshot hash” refers to a hash or digest representing a machine-readable policy state or a canonical serialization thereof at a time relevant to authorization or execution. A policy snapshot hash may represent policies inherited from tenant, application, workflow, environment, or resource scopes.

As used herein, an “environment measurement digest” refers to a digest computed over one or more attributes of an execution environment. An environment measurement digest may reflect image identifiers, package versions, tool bundle hashes, browser extension sets, connector sets, executable measurements, package manifests, hardware-attestation values, or other environment measurements.

As used herein, an “execution environment” refers to a runtime, substrate, device, session, container, virtual machine, browser automation harness, mobile sandbox, application context, connector context, or other environment in which a proposed action may be executed.

As used herein, an “approved semantic-delta envelope” refers to a machine-readable representation of permitted, forbidden, or bounded change semantics associated with a proposed action. An approved semantic-delta envelope may include field-level rules, object-level rules, graph-level rules, tolerance values, forbidden classes of modifications, and compensating-response instructions.

As used herein, a “derivation graph” refers to a graph representation of one or more source nodes, transformation nodes, model-output nodes, memory nodes, retrieval nodes, tool-response nodes, approval nodes, or other nodes that influenced a proposed action. A derivation graph may also include edges representing transformations, dependencies, or influence relationships.

As used herein, a “derivation-graph digest” refers to a digest computed over a canonical representation of a derivation graph. A derivation-graph digest may be used to bind an influence structure for a proposed action into a certificate or other authority artifact.

As used herein, a “signed action authority certificate” refers to a signed machine-verifiable artifact that grants authority to execute a specific proposed action or workflow edge under specified binding conditions. A signed action authority certificate may bind one or more of a canonical action digest, pre-execution state digest, policy snapshot hash, environment measurement digest, approved semantic-delta envelope or digest thereof, derivation-graph digest, actor value, tenant value, session value, time value, nonce, revocation value, or signature metadata.

As used herein, an “actual semantic delta” refers to a semantic change that results from execution of a proposed action. An actual semantic delta may represent a change to a file, spreadsheet, document object model tree, access-control list, record set, configuration object, mobile device state, database object, or other target resource.

As used herein, a “containment action” refers to an action initiated to limit, reverse, quarantine, freeze, cancel, abort, snapshot, reroute, or otherwise control an execution or resource state when validation fails or when an actual semantic delta exceeds an approved semantic-delta envelope.

As used herein, a “trust metadata” refers to metadata indicating a trust characteristic of a node, source, transformation, output, or other element of a derivation graph. Trust metadata may indicate source type, trust level, verification status, origin, integrity status, or related information used in validating an authority artifact.

As used herein, a “confidentiality metadata” refers to metadata indicating a confidentiality characteristic of a node, source, transformation, output, or other element of a derivation graph. Confidentiality metadata may indicate a data classification, secret-derived status, restricted-output status, authorized visibility, or handling requirement.

As used herein, a “delegated child authority certificate” refers to an authority certificate derived from a parent authority certificate and encoding a narrower scope than the parent authority certificate. A delegated child authority certificate may encode a strict subset of one or more authority dimensions encoded in the parent authority certificate.

As used herein, a “parent authority certificate” refers to an authority certificate from which another authority certificate or authority artifact is derived. A parent authority certificate may define a scope, resource set, action class, allowed semantic delta, expiration window, privilege ceiling, execution count, or other authority dimension that constrains a delegated child authority certificate.

As used herein, “authority dimensions” refer to categories of authority constraints or boundaries encoded in an authority certificate or authority artifact. Authority dimensions may include resource scope, target-resource scope, action class, environment class, time window, allowed semantic delta, semantic-delta envelope, privilege ceiling, execution count, actor binding, tenant binding, or policy constraint.

As used herein, a “resume package” refers to a machine-readable package stored for a paused, queued, recurring, or scheduled workflow and comprising metadata sufficient to determine whether prior authority remains valid at a later time. A resume package may store certificate identifiers, canonical action digests, state digests, policy hashes, environment digests, derivation graph digests, semantic-delta envelope references, permission-state digests, connector manifests, or related values.

As used herein, a “material drift” refers to a change in state, policy, environment, derivation, permission, connector configuration, tool configuration, or other condition that is sufficient to affect whether prior authority remains valid. Material drift may be detected by recomputing one or more current digests and comparing the current digests to stored or certificate-bound values.

As used herein, a “secret broker” refers to a service or component that resolves placeholder references or opaque handles to secrets while withholding raw secret values from model-visible context. A secret broker may resolve a placeholder only inside a non-model execution substrate and may record secret-use metadata without disclosing the secret itself.

As used herein, a “model-visible context” refers to prompt content, intermediate model messages, model memory, graph-memory records, evidence blocks, exported reports, logs, ticket comments, or other content that is accessible to, generated for, or used by an artificial intelligence model.

As used herein, a “restricted-output label” refers to a label, tag, flag, or dataflow marking applied to content derived from an execution that consumed a secret or otherwise restricted content. A restricted-output label may indicate that content is prevented from entering model-visible context absent authorization.

As used herein, a “replay bundle” refers to a machine-readable package that permits after-the-fact verification of a prior execution. A replay bundle may include a canonical action descriptor, one or more authority certificates, one or more state artifacts or state digests, semantic-delta envelopes, derivation graph records or digests, environment measurements, provenance records, and signature-verification artifacts.

As used herein, a “verified-state checkpoint token” refers to a token issued after one or more verification conditions are satisfied for an intermediate or final state. A verified-state checkpoint token may reference or incorporate a checkpoint identifier, certificate identifier, state digest, environment digest, policy hash, derivation digest, permitted replay scope, signature, or integrity digest.

As used herein, a “compensating-action plan” refers to a plan defining one or more reversal actions, corrective actions, neutralizing actions, rollback actions, quarantine actions, or other operations that reduce, reverse, or control the effect of one or more already-executed operations.

As used herein, a “policy orchestration service” refers to a service that evaluates policy for a proposed action and produces routing or authorization outcomes. A policy orchestration service may produce allow, deny, transform, delay, reroute, queue, or require-approval outcomes and may route a proposed action to a sandbox class, staging class, pre-production class, production class, replay class, or forensic class.

As used herein, an “execution gate” refers to a component that validates certificate fields or other authority conditions before permitting execution of a proposed action. An execution gate may suppress, delay, reroute, escalate, or otherwise control execution when validation fails or when drift is detected.

As used herein, a “non-model execution substrate” refers to an execution substrate that is outside model-visible context. A non-model execution substrate may include a signed process, secure enclave, container, browser automation harness, mobile sandbox, or other policy-approved runtime boundary.

As used herein, “VulnerabilityRecords” refers to one or more normalized records representing vulnerability data. A VulnerabilityRecord may include an advisory identifier, component fingerprint, version range, exploit-precondition data, exposure evidence digests, remediation state, patch state, environment binding, confidence score, confidentiality class, or other vulnerability-related fields.

As used herein, an “AssetExposureGraph” refers to a graph that links one or more assets, identities, privileges, environment measurements, vulnerable components, reachable targets, services, packages, roles, credentials, network segments, trust boundaries, connector endpoints, tickets, or remediation objects. An AssetExposureGraph may include edges representing installation, reachability, dependency, trust, credential use, role inheritance, delegated authority, communication, patch lineage, or remediation lineage.

As used herein, “exposure paths” refer to one or more paths through an AssetExposureGraph that represent reachable relationships relevant to vulnerability exposure. An exposure path may begin from an entry condition and terminate at a protected target, and may incorporate identity states, role assignments, network reachability, privilege requirements, trust boundaries, policy constraints, or semantic-delta risk.

As used herein, a “signed authority artifact” refers to a signed machine-verifiable artifact that constrains execution of an action, including a defensive action. A signed authority artifact may bind digests, policy values, scope values, actor values, time values, semantic-delta constraints, revocation values, or other execution constraints.

As used herein, a “semantic-delta constraint” refers to a constraint that limits, permits, forbids, or bounds one or more semantic changes associated with an action. A semantic-delta constraint may be represented by, referenced by, or included within a semantic-delta envelope.

As used herein, an “evidence bundle” refers to a package of evidence records associated with an action, defensive action, validation, remediation, or verification. An evidence bundle may include execution events, exposure evidence, replay information, patch-effect information, containment simulation information, remediation selection information, provenance information, or records synchronized with an ITSM or case-management object.

As used herein, a “vulnerability-confirmation sandbox” refers to a non-production validation environment configured to confirm, analyze, or validate vulnerability-related conditions while suppressing destructive actions. A vulnerability-confirmation sandbox may be instantiated using a snapshot, clone, synthetic twin, emulator, replay environment, scrubbed replica, digital twin, instrumented container stack, or provider-managed validation lab.

As used herein, a “proof-of-exposure bundle” refers to an evidence bundle or record set indicating exposure associated with a vulnerability or reachable path. A proof-of-exposure bundle may exclude reusable executable exploit code, reusable exploit payloads, and unrestricted exploit scripts configured for reuse outside a non-production validation environment.

As used herein, a “patch-effect verification record” refers to a record that indicates the effect of a patch or remediation on one or more vulnerability, exposure, reachability, or environment conditions. A patch-effect verification record may include before-and-after evidence, recomputed reachability, environment measurements, package information, or validation results.

As used herein, an “ITSM or case-management object” refers to a ticket, case, workflow object, or other service-management record used to track execution events, evidence records, remediation records, or lifecycle state. An ITSM or case-management object may have a lifecycle state such as create, queue, assign, escalate, contain, validate, remediate, verify, reopen, close, SLA-breach, or policy-breach.

As used herein, a “just-in-time scoped credential” refers to a credential issued for a limited time, scope, action, target, environment, or policy condition. A just-in-time scoped credential may be bound to a signed authority artifact and resolved only inside a non-model execution substrate.

As used herein, a “scoped execution token” refers to a token issued for a limited scope of execution. A scoped execution token may constrain an action, target resource, environment, time window, privilege, or semantic-delta constraint and may be resolved only inside a non-model execution substrate.

### Related Architecture Embodiments

Subject matter includes a server-platform-based system that (a) receives a codebase and associated documentation, (b) parses the input data to extract task parameters, generate meta tags describing functions and dependencies, and construct a workflow representation consisting of operating-system-level input events and associated state transitions, (c) executes the workflow by injecting the OS-level input events and verifying state transitions through a perception layer that captures pre-execution and post-execution states, and (d) logs each event and state transition in a provenance module using cryptographic metadata to create a tamper-evident audit record.

Subject matter also includes an autonomous help desk engine that applies the same workflow-execution-and-perception architecture to handle user-reported computer issues without human intervention.

### Input Data Parsing and Workflow Construction

A system receives a codebase and documentation and applies AI (including LLMs and GANs) to: extract task parameters; generate meta tags describing functions, classes, and dependencies; and construct a workflow representation. The workflow representation encodes OS-level input events (cursor movements, keystrokes, mouse clicks, touch gestures, command-line inputs) and the expected state transitions associated with each event. When source code is unavailable, the system autonomously explores GUIs by simulating user actions, capturing screenshots, and constructing workflows empirically.

### Dependency Graph Generation

A system generates a dependency graph that visually represents relationships among functions, classes, modules, and external libraries. The graph is rendered through an interactive interface supporting filtering by relationship type and zoom into specific nodes. Abstract syntax tree (AST) parsing underlies the code-side dependency extraction.

### Perception Layer for State Verification

A perception layer captures pre-execution and post-execution operating system states. Verification techniques include: (a) screenshot capture and pixel-difference analysis; (b) optical character recognition (OCR) for text extraction and error-message detection; (c) accessibility tree parsing and comparison of hierarchical structures; and (d) document object model (DOM) analysis for browser-based interfaces. On mismatch between expected and actual state, the system triggers adaptive fallback workflows including alternative OS-level input events.

### Cryptographic Provenance Module

Each executed input event and corresponding state transition is logged in a provenance module. Log entries include: timestamps, unique event identifiers, cryptographic hashes of pre-execution and post-execution states, and workflow instance identifiers. The provenance module creates a tamper-evident ledger enabling forensic reconstruction, replay, and compliance auditing. In enterprise deployments, cryptographic metadata may be encrypted with a key from a secure key management system, accessible via an authentication protocol.

### Adaptive and Predictive Workflow Extension

The system analyzes historical user interactions to predict subsequent tasks, appending predicted tasks to the workflow for execution. Machine learning models are trained on meta tags and task parameters to refine parsing and improve workflow accuracy over time. The workflow representation also supports conditional logic for selecting alternative state transitions in response to specific detected error conditions.

### Multi-Modal Help Desk Engine

A help desk engine generates user-facing outputs in multiple modalities: text, voice, graphics, media, and URLs. Outputs are dynamically adapted to user input and software changes, providing real-time assistance. The help desk engine can both explain workflows and autonomously execute help desk actions. When executed autonomously, the same perception-and-provenance loop governs the help desk execution.

### Parallel LLM/GAN Architecture With Consensus

Multiple LLMs and GANs operate in parallel to parse input data and generate outputs. A consensus module determines the next action or response based on collective results. GANs specifically generate visual aids including task flow diagrams, flowcharts, and UI mockups corresponding to the identified workflows.

Subject matter also includes provisioning a dedicated computing environment, instantiated as a virtual machine, container, sandbox, remote desktop session, or cloud-hosted desktop instance-exclusively for an AI agent. The agent computing environment exposes OS-level input channels and perception channels, executes workflow representations of tasks, and maintains a cryptographically verifiable tamper-evident provenance log. A central new contribution over the parent is approval-bound execution: before executing a workflow action, the system hashes the pre-execution state and includes that hash in an approval request. Execution is suppressed if the current pre-execution state hash does not match the hash at the time of approval, preventing stale-approval attacks.

### Agent Computing Environment (AgentOS) Provisioning

A server platform provisions a dedicated computing environment for the exclusive use of an AI agent. Provisioning modalities include virtual machines, containerized execution environments, remote desktop sessions, sandboxed contexts, and cloud-hosted desktop instances. The environment runs applications without modification to underlying software and is capable of executing workflows on desktop, browser, and mobile targets. Multiple agent computing environments can be provisioned concurrently across data centers, cloud regions, or devices, with an orchestration layer for task assignment, load balancing, and log aggregation.

### OS-level Event Injection Mechanisms

The agent computing environment includes an operating system configured to receive synthetic input events. Event injection mechanisms include: Win32 API event generation (Windows), X11/Wayland windowing-system APIs (Linux), macOS event taps, mobile touchscreen emulators, HID emulator drivers, synthetic keyboard and mouse interfaces, and command-line invocation interfaces. In some embodiments, OS-level input events interact with a browser or webview UI, and the perception layer captures rendered pixels, accessibility tree snapshots, or DOM snapshots associated with that interface.

### Perception Pipeline Detail

The environment includes a perception pipeline comprising: screenshot capture utilities; OCR engines (including Tesseract, PaddleOCR, cloud OCR, or custom models); DOM inspection utilities; accessibility tree inspection APIs; pixel-difference modules; and UI-component state parsers. Pre-execution and post-execution states are captured and compared. Deviation between expected and actual state triggers adaptation: retry, insertion of additional steps, or switching to a fallback path encoded in the workflow graph.

### Approval-Bound Execution With Hash-Match Gate

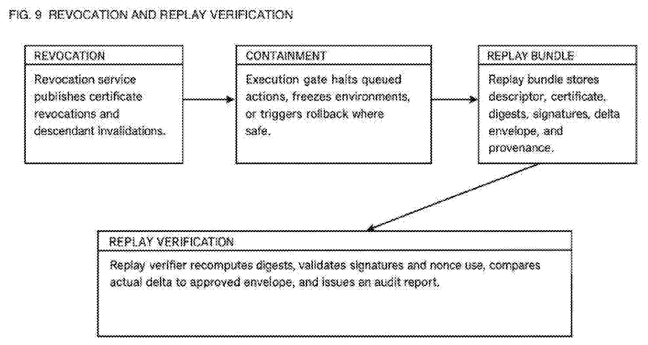

A novel embodiment disclosed in FIG. 9 introduces approval-bound execution. The sequence is: (a) a pre-execution state artifact is captured and hashed; (b) an approval request is issued that includes the pre-execution state hash; (c) an approval token is generated that is bound to both an action descriptor and the pre-execution hash; (d) immediately before execution, the current pre-execution state is re-hashed; (e) a hash-match gate suppresses execution if the current hash does not match the hash in the approval token; and (f) the tamper-evident provenance chain records the outcome. This mechanism prevents execution under stale approvals when the UI state has changed between approval issuance and execution.

### Structured Workflow Graph With Dependency Mapping

The workflow engine maintains a structured workflow graph with nodes representing screens or states and directed edges representing transitions or dependencies. The graph encodes conditional branches, fallback paths, retry policies, timing optimizations, and error-handling triggers. A dependency mapping engine identifies required data values, prerequisite screens, and ordering constraints. Machine learning models trained on execution history rank candidate fallback sequences by past success rates.

### Security, Isolation, and Encapsulation

The agent computing environment is provisioned as an isolated execution domain. Isolation techniques include: hypervisors; container security boundaries; restricted file systems; sandboxed network access; limited system-call surfaces; virtualized display buffers; and non-privileged execution modes. Snapshot-based resets return the environment to a known-good state. Forensic reconstruction using provenance logs supports step-by-step replay for debugging, audit, and compliance.

### Surrogate-Interface Rendering Embodiment

In some embodiments, the agent computing environment receives externally generated interface data (images, pixel buffers, accessibility metadata, UI element descriptors, or DOM structures) originating from an external computing system. The environment renders this data locally as a surrogate interface surface. The AI agent injects OS-level input events into the local OS, and the perception layer verifies state transitions based on the locally rendered surrogate. A translation pipeline transmits the resulting effects to the external system. This embodiment allows the agent to operate on remote-system UI data without requiring remote-desktop protocols or remote OS session control.

### Multi-Modal Help Desk Output Generation

The system generates multi-modal help outputs from the same workflow graph used for autonomous execution, including: (A) step-by-step textual instructions; (B) annotated screenshots; (C) diagrams showing state transitions; (D) UI snippets with annotations; and (E) composite text-diagram-image explanations. Multi-modal outputs can be tailored to user roles or expertise levels and are automatically updated when workflows change.

### Software Enablement Pseudocode

The specification provides enabling pseudocode-level examples for OS-level execution (click-action, text-entry, and navigation-step sequences) and explicitly states that any OCR engine, accessibility API, screenshot capture mechanism, workflow representation format, hash function, AI/ML model, or OS platform within the disclosed functional categories may be substituted as alternative embodiments.

Subject matter further includes a closed-loop system that: (i) retrieves candidate context items from a corpus (vector database and/or knowledge graph) and compresses them into a bounded context package under a resource budget constraint; (ii) generates end-to-end executable software artifacts using a swarm-based architecture of specialized AI models; (iii) executes and validates the artifacts in ephemeral isolated environments using programmatic verification (return codes, test results, logs, file diffs, object-model state); (iv) outputs machine-interpretable compliance violation packets; (v) derives structured regeneration constraints from the violation packets; (vi) injects the constraints into the next generation cycle; (vii) updates a causal memory structure to bias future retrieval and generation; and (viii) iterates until a defined convergence condition is satisfied.

### Multi-Stage Retrieval and Bounded Context Assembly

The retrieval module performs coarse retrieval (e.g., top-K by embedding similarity from a vector database) followed by fine-grained filtering (policy rules, trust scores, recency, provenance, causal-memory relevance) and ranking (weighted scoring function). A compression and packing module converts candidate items into compressed context units and packs them into a bounded context package under a budget constraint. Budget types include token, byte, character, time, compute-cost, memory, and latency budgets. A reserved constraint budget holds budget headroom for constraint units, schema extracts, and API signature extracts to prevent their omission. The bounded context package includes a context header (task requirements, assumptions, objective metrics, budget schema) and a manifest (included units, excluded candidates, exclusion reasons).

### Compressed Context Unit Types

Compressed context units may be: (a) summary units (extractive or abstractive summarization preserving constraints, e.g., BERT-based extractive, T5/BART abstractive); (b) rule extract units (compliance rules in structured fields); (c) schema extract units (data schemas and invariants); (d) API signature extract units (endpoints, parameters, return codes, error contracts); (e) code snippet units (selected code below threshold size); and (f) constraint units derived from prior validation cycles. Each unit carries a unit_id, unit_type, payload, size_estimate, confidence score, and optional evidence references.

### Swarm-Based Artifact Generation Architecture

An artifact generation module coordinates a swarm-based architecture of specialized models via an orchestration controller. Specialized roles include at minimum: code generation agent, test generation agent, quality assurance review agent, security review agent, and compliance review agent. Models may be separate networks or instances of a shared base model operating under different prompts, policies, tools, or constraints. The module generates end-to-end application artifact sets including front-end UI, back-end services, API definitions, database schemas, authentication configuration, infrastructure-as-code templates, build scripts, test artifacts, and deployment artifacts.

### Ephemeral Isolated Validation Environments

Generated artifacts are deployed into ephemeral test environments: containerized sandboxes, micro-virtual machines, sandboxes, emulators, device farms, or staging environments. Validation covers functional checks, security checks, and domain-specific compliance checks (HIPAA, PCI, GDPR). The validation module collects telemetry and outputs machine-interpretable compliance violation packets (ViolationPacket records) containing at minimum a rule_id and an evidence_pointer_or_digest, plus optional severity, affected component identifiers, and remediation hints.

### Machine-Interpretable Violation Packets and Constraint Derivation

ViolationPacket records are consumed by a constraint derivation module that derives ConstraintObject records. Constraint objects may specify: prohibited patterns; required patterns; replacement mappings; parameter overrides; or retrieval weight updates. Forms of constraint injection include additive, subtractive, replacement, weighting, and parameter override. Derived constraints are injected into the next bounded context package as constraint units or as machine-interpretable fields encoded in the context header.

### Causal Memory Structure

A causal memory module stores associations linking faults, violations, constraints, context units, and outcomes. Implementation forms include knowledge graphs, relational tables, adjacency lists, structured logs, and learned parameter tables. The causal memory biases subsequent retrieval (increasing weight for context items correlated with successful resolution of prior violation types) and generation (adjusting model parameters or prompts). Weight updates are bounded by stability policies (step-size limits, clamping, repeated-outcome requirements).

### Convergence Controller and Termination Conditions

A convergence controller iterates regeneration and re-validation until a convergence condition is satisfied (all compliance checks pass and functional correctness criteria met, optionally over N consecutive cycles) or a termination condition is reached (cycle limit exceeded). TelemetryPacket records normalize validation telemetry, each carrying a packet_id, correlation_id, cycle_id, packet_type, timestamp, and optional payload reference or digest.

### Real-Time Update Mechanism

A real-time update mechanism synchronizes newly acquired or updated data via WebSockets, server-sent events (SSE), polling, or message-queue subscriptions. Upon update events (new commits, new documents, updated policies, new telemetry), the system triggers automatic refetch, rerank, and repack of context, followed by regeneration or modification of the affected artifact portions.

### Programmatic Execution and Verification (Distinct From UI Automation)

Tasks are executed by invoking scripts, command-line tools, SDK calls, connectors, plugins, function calls, and application programming interfaces (APIs), locally and/or in cloud environments. Verification uses programmatic signals: return codes, exit codes, structured outputs with schema validation, test results, logs, telemetry metrics, file diffs, configuration diffs, or object-model state. This is explicitly distinguished from UI-automation-only approaches (addressed in the competitor workaround section).

### Non-Limiting Use Cases Disclosed for Scope Preservation

The specification includes fourteen labeled use cases (full-stack app generation, data model refactoring, streaming telemetry repair, multi-session memory, automated CI/CD remediation, infrastructure-as-code generation, data pipeline creation, enterprise connector workflows, document/spreadsheet automation, mobile app creation and emulator validation, security hardening loop, cost/latency budget optimization, and multi-modal task completion) and ten labeled competitor workaround counter-embodiments.

Subject matter further still includes a deterministic agent computation platform that: (1) receives heterogeneous computational artifacts (source code, UI structures, screenshots, accessibility trees, DOM structures, API definitions, tool descriptors, policy statements, telemetry, runtime logs, mobile traces, database schemas, user messages, voice transcripts, image-derived features, and previously generated workflows) and transforms them into canonical component records through a normalization engine; (2) compiles the canonical component records into a deterministic execution blueprint represented as a directed acyclic execution graph with branch nodes, fallback nodes, retry policies, environment-binding directives, condition-evaluation rules, policy hooks, and evidence references; (3) executes the blueprint via a deterministic runtime that validates preconditions, binds environment resources, issues operations (UI, API, script, mobile, data), validates postconditions, and records execution results with provenance; and (4) maintains environment lineage through a graph recording all spawn, snapshot, clone, branch, migrate, suspend, resume, rollback, reset, merge, and destroy transitions.

### Canonical Component Normalization Engine

A normalization engine applies deterministic canonicalization rules including: stable field ordering, duplicate elimination, type normalization, schema normalization, stable dependency sorting, canonical tokenization, canonical hashing, and conflict-marking of nonconforming fields. Each canonical component record contains typed fields for: component_id, component_class, semantic_role_tags, normalized inputs, normalized outputs, preconditions, postconditions, constraints, dependencies, evidence_refs, environment_suitability_data, and provenance_data. A conflict analyzer surfaces contradictions and emits conflict components or alternative candidate values for human or automated resolution.

### Blueprint Compiler

A blueprint compiler transforms canonical component records into a deterministic execution blueprint. The blueprint is a directed acyclic execution graph (or equivalent deterministic intermediate representation) with: branch nodes (conditional paths); fallback nodes (failure recovery paths); retry policies; environment-binding directives (specifying which execution class to use); condition-evaluation rules; policy hooks; and evidence references linking each blueprint node to the canonical components that justify it. Any intermediate representation format that preserves the disclosed deterministic properties (serialized plans, typed operation sets, graph encodings) falls within the disclosure.

### Deterministic Runtime With Precondition/postcondition Validation

A deterministic runtime executes the blueprint by: (a) selecting or provisioning an execution environment; (b) validating preconditions for each blueprint node; (c) binding environment resources; (d) issuing UI operations, API calls, script execution, mobile interactions, or data operations; (e) validating postconditions; and (f) recording normalized execution results and provenance data. The runtime supports UI-only, API-only, mobile-only, and hybrid execution channels within the same deterministic framework.

### Environment Lineage Subsystem

An environment lineage subsystem maintains an environment lineage graph recording parent-child environment relationships and all transition events: spawn, snapshot, clone, branch, migrate, suspend, resume, rollback, reset, merge, and destroy. An environment-class router assigns operations to execution classes—sandbox, staging, pre-production, production, forensic, replay, or branch-isolated—based on action type, confidence level, policy result, data classification, required capabilities, device restrictions, and rollback availability. Rollback transitions, restore candidates, and compensating branches are recorded in the lineage graph to support replay, reversal, or re-routing after verification failure or policy-triggered promotion denial.

### Mobile-Hybrid Execution Subsystem

A mobile execution subsystem performs deterministic mobile interaction using gesture descriptors, sensor-state descriptors, permission-state descriptors, and device sandbox controls. A mobile-hybrid routing protocol allows cooperation between on-device execution and cloud-side planning or verification modules. Privacy-sensitive operations may be kept on-device (device-restricted sandbox) while cloud-side modules provide bounded evidence and routing decisions. The environment-class router can deny production promotion for a low-confidence mobile branch and record a rollback transition to a previously validated device snapshot.

### Retrieval-Augmented Memory Subsystem

A retrieval-augmented memory subsystem packages retrieved evidence into normalized evidence blocks, links them to graph-memory entities, compresses or ranks the evidence blocks, and exposes them to the compiler or runtime without requiring free-form prompt concatenation. Contradiction handling is performed when conflicting evidence is detected, and the compiler may emit guarded branch nodes requiring additional verification before side effects are permitted when evidence conflicts cannot be resolved.

### Policy and Compliance Graph With Hook Architecture

A compliance and policy graph provides hook points at action, environment, data, retrieval, memory, and mobile layers. At each hook point, deterministic execution can be allowed, blocked, modified, rerouted, or constrained according to policy semantics. Policy outcomes are normalized (policy_outcome field in blueprint nodes). Policy materialization converts policy graph results into blueprint-level directives.

### Architecture Evolution Subsystem

An architecture evolution subsystem evaluates candidate schema revisions, compiler revisions, runtime revisions, and routing policies in isolated architecture sandboxes. Lineage links between predecessor and successor architectures are recorded. Deployment of a revised architecture requires passing defined validation criteria (regression blueprint testing, schema validation). Manual or automated proposal of architecture changes is supported; lineage-aware validation is required in all cases. This subsystem addresses schema drift that can cause replay mismatches in prior-art systems.

### Workflow-Conditioned Application Construction Subsystem

An application construction subsystem accepts high-level intent and: (a) decomposes intent into normalized requirement components (user stories, data schema, business logic, UI components, compliance rules); (b) generates a component graph; (c) compiles the component graph into application artifacts (code, interface definitions, data schemas, tests, deployment descriptors, environment directives); and (d) validates the generated artifacts under deterministic runtime control. A workflow-conditioned UI layout generator generates candidate layouts from a workflow graph-wireframes, structured UI definitions, component descriptors, field descriptors, accessibility metadata, screen-transition metadata, and layout confidence scores-scored against accessibility, focus order, usability, density, policy, and role suitability thresholds.

### CRUD and Backend-Binding Subsystem

A CRUD and backend-binding subsystem maps UI components to backend functions, API operations, database operations, or service operations using semantic matching, parameter-type matching, permission checks, and precondition/postcondition checks. A UIBackendBindingRecord links each UI component to: backend function identifier, generated handler reference, semantic match score, parameter match score, permission result, generated test result, confidence value, and provenance hash. A binding is accepted only when all matching and testing thresholds are satisfied.

### AI-Assisted Debugging, Predictive Scheduling, Collaborative Editing, and Communication Ingestion

The platform includes: (a) an AI-assisted debugging module that classifies log/trace data, selects or generates remediation proposals, and updates retry or fallback branches; (b) a predictive scheduling module that forecasts the next user task based on historical task sequences, workflow phase, user role, and outcome patterns; (c) a collaborative workflow editing module that records concurrent human or agent edits as CollaborationOperationRecord entries and detects semantic conflicts (mutually exclusive branches, incompatible validation rules, inconsistent bindings, conflicting permissions); and (d) a communication ingestion subsystem that extracts workflow candidates from emails, chat messages, support tickets, wiki pages, documents, logs, screenshots, transcripts, and knowledge-base articles.

### Secure Local Agent Bridge

A secure local bridge controller authorizes local or on-premises operations under a LocalBridgeManifest that defines allowed operation classes, file scopes, process scopes, screenshot scopes, network scopes, resource limits, authentication requirements, sandbox boundaries, audit requirements, and containment actions. A requested local operation executes only when the manifest, authorization context, policy outcome, environment binding, and blueprint node are all compatible. Violations place the bridge in read-only mode, terminate execution, restart the local agent, notify an administrator, or create a forensic event record.

### Multi-Agent Arbitration Subsystem

A multi-agent arbitration subsystem receives branch outputs, verification records, evidence blocks, policy outcomes, and environment observations from two or more specialized agents and computes a next-action decision using quorum thresholds, confidence-weighted ballots, role-weighted ballots, veto classes, tie-break rules, branch-comparison scores, or escalation rules. Specialized agent roles include source-analysis, GUI-exploration, execution, verification, provenance, planner, compliance, and retrieval.

### Adaptive Inference Routing Subsystem

An adaptive inference routing subsystem selects among model-based, rule-based, retrieval-based, graph-based, tool-based, local, cloud, on-device, or hybrid reasoning substrates for each blueprint node or application-construction step. Routing decisions are based on privacy class, risk, latency, cost, battery level, memory budget, evidence sufficiency, policy outcome, environment class, mobile state, expected determinism, or rollback availability. All routing decisions are logged under the deterministic runtime with canonical provenance.

In some embodiments, the authority-plane architecture described herein may be implemented within, layered over, or integrated with one or more earlier adaptive automation, autonomous task execution, code-analysis, dependency-mapping, help-desk, dynamic context retrieval, autonomous software generation, programmatic validation, and agent computing environment architectures disclosed in the related applications. The following embodiments are provided to make explicit, within the four corners of this application, parent-architecture support that may be used with the signed authority artifacts, certificate-bound execution gates, semantic-delta envelopes, derivation-graph digests, channel-binding records, continuity capsules, successor authority artifacts, and replay-verification mechanisms described elsewhere herein.

In some embodiments, an adaptive automation layer receives heterogeneous input data including one or more of source code, code repositories, documentation, frequently asked questions, help files, user guides, API specifications, configuration files, tests, build artifacts, logs, screenshots, accessibility-tree captures, document object model captures, user messages, voice transcripts, media files, workflow histories, ticket records, telemetry streams, or natural-language task descriptions. The adaptive automation layer may parse such input data using static analysis, dynamic analysis, abstract syntax tree parsing, dependency parsing, natural-language processing, image analysis, optical character recognition, accessibility-tree analysis, DOM analysis, rule-based parsing, model-based parsing, or combinations thereof.

When source code, documentation, or API specifications are available, the system may generate meta tags or canonical annotations describing functions, methods, classes, modules, parameters, return values, data dependencies, external libraries, API calls, user-interface handlers, endpoint mappings, database operations, error conditions, validation rules, and workflow-relevant relationships. The meta tags may be stored in a database, graph database, document store, canonical registry, or other storage system and may be used to generate documentation, workflow graphs, dependency graphs, task parameters, help-desk outputs, semantic-delta envelopes, verifier requirements, or authority-bound action descriptors.

A dependency mapping component may construct one or more dependency graphs, workflow graphs, relationship maps, or state-transition graphs. Nodes may represent code components, functions, classes, modules, screens, dialogs, forms, user-interface states, API endpoints, data objects, tasks, workflow steps, preconditions, postconditions, or verification states. Edges may represent function calls, imports, library dependencies, user-interface transitions, data dependencies, task ordering constraints, fallback relationships, permission relationships, or other dependency relationships. The graphs may be rendered through an interactive interface that supports filtering, zooming, searching, or visualization by relationship type.

When source code is unavailable, incomplete, inaccessible, or unreliable, the system may operate in a no-source or UI-exploration mode. In this mode, an agent may autonomously explore a graphical user interface by generating candidate operating-system-level input events, browser actions, mobile gestures, API calls where available, or other input actions; capturing screenshots, frame-buffer contents, OCR outputs, DOM snapshots, accessibility-tree snapshots, mobile UI trees, active-window metadata, dialog state, or rendered-screen state; and building a workflow representation from observed state transitions. The system may use large language models, vision models, rules, graph analysis, or other models to infer tasks, identify buttons or fields, detect errors, and select next actions.

A workflow representation may include an ordered sequence, graph, state machine, directed acyclic graph, tree, or hybrid representation of actions and expected state transitions. A workflow step may include one or more operating-system-level input events, application programming interface invocations, connector invocations, command-line instructions, browser operations, mobile gestures, or observation-only verification operations. A workflow step may also include preconditions, postconditions, conditional branches, retry rules, fallback paths, exception rules, dependency requirements, verifier sufficiency requirements, authority constraints, or semantic-delta constraints.

Operating-system-level input events may include cursor movements, mouse clicks, double-clicks, right-clicks, keyboard inputs, keyboard shortcuts, text entry, drag-and-drop operations, scroll operations, touch gestures, mobile swipes, mobile taps, file uploads, command-line inputs, window-management actions, browser actions, or other input events recognized by an operating system, application, browser, mobile device, virtual machine, container, sandbox, remote session, or other execution substrate. Such events may be generated through human-interface-device emulation, driver-level emulation, virtual keyboard or mouse interfaces, touch gesture emulators, windowing-system APIs, accessibility APIs, browser automation hooks, mobile automation frameworks, command-line interfaces, scripts, or tool invocations.

A perception layer may capture pre-execution and post-execution state artifacts for a workflow step or group of workflow steps. A state artifact may include one or more screenshots, frame-buffer captures, OCR outputs, accessibility-tree snapshots, DOM snapshots, mobile UI tree snapshots, active-window metadata, focus metadata, dialog metadata, pixel-difference evidence, structured API object states, file states, configuration states, database states, logs, return codes, metrics, or other state information. The perception layer may compare pre-execution and post-execution artifacts to verify an expected state transition, detect an unexpected state, compute an actual semantic delta, or trigger a fallback or containment response.

A provenance logging component may log input events, workflow steps, state artifacts, state hashes, pre-execution hashes, post-execution hashes, action descriptors, approval metadata, policy decisions, verifier results, agent identifiers, workflow identifiers, timestamps, fallback identifiers, ticket identifiers, or other metadata. The provenance logging component may maintain a tamper-evident record using hash chaining, digital signatures, message-authentication codes, integrity digests, append-only ledgers, distributed ledgers, transparency logs, external timestamping services, decentralized databases, audit services, or combinations thereof. A provenance or replay subsystem may reconstruct a workflow, verify cryptographic integrity, replay a workflow, support forensic review, or support audit reporting.

A multi-modal help desk or support-output engine may generate user-facing guidance from a workflow graph, dependency graph, state-transition graph, provenance record, or execution result. Outputs may include text instructions, voice scripts, audio explanations, diagrams, flowcharts, screenshots, annotated UI snippets, videos, URLs, step-by-step checklists, visual task maps, developer documentation, API documentation, or composite explanations combining multiple modalities. Such outputs may be tailored to a user role, expertise level, language preference, task context, or permission scope and may be updated when workflows, code, documentation, or application state change.

Multiple large language models, generative models, vision models, rules, symbolic analyzers, graph engines, code analyzers, or other specialized models may operate in parallel or in sequence to parse input data, generate outputs, generate visual aids, analyze screenshots, infer workflows, propose fallback paths, or verify state transitions. A consensus, arbitration, voting, scoring, or confidence-weighted mechanism may compare outputs from multiple models or agents and select a next action, output, workflow path, or escalation result.

An agent gateway may receive an agent request from a remote interface, local interface, API endpoint, browser interface, mobile device, help-desk system, ticketing system, command-line interface, or application. The agent gateway may bind the request to a session context that includes one or more of a user identity, device identity, agent identity, role, tenant, authorization scope, resource scope, time window, execution policy, channel scope, environment class, ticket identifier, approval state, credential state, or policy state. The session context may be used by a policy engine, execution gate, certificate service, or authority-plane service to determine whether a proposed action may proceed.

A capability manifest may define authorized action classes, resource scopes, tool scopes, channel scopes, environment classes, credential scopes, data classes, permitted applications, permitted files, permitted network destinations, permitted APIs, or permitted user-interface regions. A policy engine may map an action descriptor or canonical action descriptor to an action class using descriptor attributes including event type, target application identifier, target resource identifier, privilege level, data classification, network destination, action class, expected side effects, environment class, or semantic-delta risk.

A policy engine may produce a decision selected from allow, deny, require-approval, transform, delay, reroute, queue, require-credential-refresh, require-checkpoint, require-fusion-analysis, require-human-shared-control, downgrade-environment, promote-environment, or other policy outcomes. The policy engine may output a policy reason code that identifies a policy rule, violation category, risk classification, or approval prerequisite. Non-limiting examples include
POLICY.DENY.OUT_OF_SCOPE_RESOURCE, POLICY.DENY.UNTRUSTED_DERIVATION,
POLICY.REQUIRE_APPROVAL.HIGH_RISK_DELETE,
POLICY.REQUIRE_APPROVAL.HIGH_RISK_EXTERNAL_TRANSMIT,
POLICY.DENY.MISSING_CAPABILITY, POLICY.DENY_PREHASH_MISMATCH,
POLICY.DENY_CERTIFICATE_MISMATCH, POLICY.DENY_CHANNEL_EXPANSION, and
POLICY.REQUIRE_APPROVAL.SEMANTIC_DELTA_RISK.

When approval is required, the system may capture a pre-execution state artifact, canonicalize the artifact, compute a pre-execution hash or digest, and generate an approval request that includes an action descriptor or canonical action descriptor and the pre-execution hash or digest. An approval token, signed action authority certificate, or other authority artifact may be cryptographically bound to the action descriptor or canonical action descriptor and to the pre-execution hash or digest. Immediately before execution, the system may recapture a current pre-execution state artifact, compute a current pre-execution hash or digest, and suppress execution when the current value does not match the approved or certificate-bound value.

Canonicalization of a pre-execution state artifact may mask, ignore, normalize, or transform non-material dynamic content, including timestamps, advertisements, animations, session-specific banners, cursor position, transient notifications, randomized layout identifiers, dynamic rendering differences, layout-coordinate variations, or text-rendering differences. The canonicalized representation may be used to compute a state hash or state digest that remains stable across non-material presentation differences while preserving material state changes relevant to authorization, approval, execution, or replay.

Before execution, the system may validate integrity of a workflow package, tool definition, connector definition, action template, channel-binding record, policy bundle, package manifest, tool bundle, or execution environment by verifying a version-pinned hash, publisher identity attestation, build provenance identifier, package manifest, connector manifest, environment measurement, or tool bundle hash. When integrity validation fails, an execution gate may suppress execution and record an integrity violation record with cryptographic metadata.

Planning content, derivation nodes, retrieved evidence, screenshots, tool outputs, memory entries, user instructions, external documents, code snippets, API responses, or model outputs may be classified as trusted, untrusted, restricted, confidential, or secret-derived. When a proposed action is influenced by untrusted or restricted content, the policy engine, derivation-graph validator, execution gate, or certificate service may require additional approval, a narrower semantic-delta envelope, a restricted channel, a non-production environment class, a new signed authority artifact, or another verification condition before execution.

A secret broker may prevent raw secrets from entering model-visible context. Raw secrets may include passwords, API keys, access tokens, private keys, session cookies, refresh tokens, signing keys, or other protected values. The secret broker may provide an opaque handle, placeholder, or short-lived scoped credential to a tool-invocation or execution substrate while withholding the raw secret from prompts, model memory, graph memory, logs, ticket comments, exported reports, or other model-visible contexts. Secret access events may be recorded in provenance records without recording raw secret values, and tool outputs may be filtered, masked, digested, redacted, restricted, or quarantined before reentering model-visible context.

A workflow representation may support dual-plane or multi-plane execution. In some embodiments, workflow edges include operating-system-level input events, GUI operations, browser operations, mobile gestures, command-line actions, API invocations, connector invocations, scripts, software-development-kit calls, database operations, or observation-only verification steps. A policy engine, certificate service, execution gate, channel selector, or authority-plane component may authorize or suppress each edge based on a canonical action descriptor, policy snapshot, state digest, environment measurement, derivation-graph digest, semantic-delta envelope, capability manifest, channel-binding record, approval token, successor authority artifact, or other authority constraint.

A dynamic context retrieval and autonomous software generation subsystem may retrieve and compress context items under a resource or context-window budget. Retrieved context may include code repositories, documentation, policy libraries, test artifacts, issue trackers, logs, prior conversations, session memory, vector-database entries, knowledge-graph nodes, compliance rules, API signatures, schema extracts, user requirements, telemetry, or other context sources. Retrieval may include lexical retrieval, vector retrieval, knowledge-graph traversal, causal-memory relevance, recency scoring, trust scoring, policy scoring, conflict detection, ranking, filtering, or combinations thereof.

A compression or packing subsystem may compress candidate context items into structured units including summary units, schema extracts, API signature extracts, compliance rule extracts, code snippet units, constraint units, evidence units, or other compressed context units. A bounded context package may include selected units, excluded candidate units, a context header, a manifest, budget information, priority information, evidence pointers, confidence scores, and reasons for inclusion or exclusion. A reserved budget may be maintained for constraint units, schema extracts, API signature extracts, or other high-priority categories.

An autonomous software generation or artifact generation subsystem may generate or modify one or more application artifacts, including frontend user interfaces, backend services, API definitions, database schemas, migrations, authentication configuration, infrastructure-as-code templates, build scripts, test artifacts, deployment artifacts, operational runbooks, rollback packages, or recovery instructions. Generated artifacts may be validated using isolated execution environments, containers, virtual machines, micro-virtual machines, emulators, sandboxes, device farms, staging environments, or other validation substrates.

Programmatic execution may include invoking scripts, shell scripts, Python scripts, build scripts, command-line tools, compilers, linters, test runners, SDK calls, connectors to external services, plugins, extension APIs, application programming interfaces, database operations, or internal services. Programmatic verification may include verifying return codes, exit codes, structured outputs, logs, telemetry metrics, file diffs, configuration diffs, artifact digests, object-model state, API response codes, API response bodies, screenshots, or other machine-readable signals.

A telemetry subsystem may collect and normalize telemetry into machine-interpretable packet records. Telemetry may include logs, traces, metrics, test reports, exceptions, stack traces, resource usage, execution events, environment events, validation results, file diffs, API responses, or other observed results. A compliance evaluation subsystem may evaluate artifacts or telemetry against compliance rules, privacy rules, security rules, retention rules, encryption rules, authorization rules, or domain-specific regulatory rules.

A compliance evaluation subsystem may output a violation packet. A violation packet may include a rule identifier, evidence pointer or digest, severity, affected component identifier, affected artifact identifier, remediation hint, policy class, confidentiality class, or timestamp. A constraint derivation subsystem may derive one or more constraint objects from violation packets or telemetry. A constraint object may include a constraint identifier, constraint type, prohibited patterns, required patterns, replacement mappings, parameter overrides, retrieval weight updates, validation overrides, or other machine-interpretable corrective information.

Derived constraints may be injected into a subsequent bounded context package as constraint units, into a context header, into a manifest, into a policy graph, into a workflow graph, into an authority artifact, into a semantic-delta envelope, or into a verification plan. The system may iteratively regenerate, re-execute, re-validate, or refine artifacts until a convergence condition is satisfied, a stability condition is satisfied, a compliance condition is satisfied, a cycle limit is reached, or a termination condition occurs.

A causal memory subsystem may maintain associations among fault signatures, violation packets, context units, constraints, applied actions, execution results, outcomes, or prior sessions. Causal memory may update retrieval weights, generation parameters, remediation preferences, verifier thresholds, or constraint priorities based on observed outcomes. Weight updates may be bounded by step-size limits, clamping limits, repeated-outcome requirements, stability policies, tenant policies, or other safety controls.

A real-time update subsystem may receive update events through WebSockets, server-sent events, polling, queues, message buses, or other communication mechanisms. Update events may include new code commits, new documents, policy updates, telemetry updates, new tickets, new validation results, new deployment state, or updated domain data. In response, the system may refetch, rerank, repack, regenerate, revalidate, or update a bounded context package, generated artifact, workflow graph, or authority artifact.

An isolated validation environment may be spun up, deployed to, executed within, checked for compliance, used to collect results, torn down, or refreshed for iterative refinement. Validation may include functional checks, security checks, domain-specific compliance checks, HIPAA-related checks, PCI-related checks, GDPR-related checks, smoke tests, unit tests, integration tests, scanner checks, policy checks, or other validations. Results may feed back into telemetry normalization, violation packet generation, constraint derivation, causal memory, convergence control, or authority-plane reauthorization.

A deterministic agent computation platform may normalize heterogeneous computational artifacts into canonical component records. Heterogeneous artifacts may include code, user-interface artifacts, logs, documentation, application programming interface definitions, screenshots, accessibility trees, document object model structures, telemetry, mobile traces, database schemas, user messages, voice transcripts, image-derived features, or previously generated workflows. A canonical component record may include typed fields such as component_id, component_class, semantic_roles, input_specification, output_specification, preconditions, postconditions, constraints, dependencies, evidence_refs, environment_profile, source_digest, schema_version, canonical_hash, lineage_refs, and metadata.

A normalization subsystem may apply deterministic canonicalization rules, including stable field ordering, duplicate elimination, type normalization, schema normalization, reversible identifier mapping, nonmaterial field removal, source digest generation, conflict analysis, dependency sorting, enrichment, and canonical hashing. The resulting canonical component records may be stored in a canonical registry or component registry and may be consumed by a compiler, deterministic runtime, retrieval-memory subsystem, policy subsystem, mobile subsystem, application-construction subsystem, or authority-plane service.

A blueprint compiler may transform canonical component records and supporting evidence into a deterministic execution blueprint or execution graph. The blueprint may include graph nodes, graph edges, branch conditions, fallback actions, retry limits, environment-binding directives, verifier nodes, policy-check nodes, evidence references, output contracts, provenance references, component identifiers, schema versions, compiler-rule versions, and one or more hashes or signatures. The deterministic execution blueprint may be used as, or mapped to, a workflow segment, execution-graph edge, canonical action descriptor, channel-binding record, verifier sufficiency profile, or successor authority artifact described elsewhere herein.

A deterministic runtime and environment binder may validate a blueprint package, component hashes, evidence integrity, and environment integrity before execution. The runtime may check preconditions, select or attach an execution environment, route execution through one or more execution channels, canonicalize unstable outputs, verify postconditions, record provenance, and output normalized results. Execution channels may include user-interface channels, scripts, APIs, local operations, remote operations, mobile operations, browser operations, cloud channels, or hybrid channels.

An environment lineage subsystem may maintain a graph of environment instances and transitions. The graph may record template images, spawned environments, snapshots, clones, branches, migrations, promotions, rollbacks, archives, destroyed environments, parent environment identifiers, environment types, operating system or firmware versions, installed applications, connector configurations, network posture, storage posture, locale, time profile, attestation metadata, compliance tags, blueprint references, policy references, and provenance references. Such lineage may support environment measurement digests, environment-class routing, checkpoint portability, successor certificate issuance, rollback, replay, and forensic analysis.

A mobile-hybrid execution subsystem may support on-device, cloud-side, and hybrid execution of mobile workflows. The subsystem may capture mobile device state, screen state, view-tree state, orientation, network state, battery state, privacy state, permissions, sensor state, and application state. A gesture engine may generate taps, swipes, text entry, accessibility actions, application launches, permission checks, camera interactions, biometric prompts, geolocation interactions, or sensor-dependent flows. A privacy boundary may keep protected data on the device while permitting bounded evidence, redacted state descriptors, hashes, or verification packages to exit the device sandbox.

A retrieval and graph-memory conditioning subsystem may assemble evidence for compilation, planning, runtime, or verification. The subsystem may use lexical retrieval, vector retrieval, graph traversal, causal memory relevance, evidence ranking, evidence packaging, contradiction detection, graph-memory entities, compression, summarization, and bounded payload generation. The resulting bounded evidence package may include structured evidence rather than free-form prompt concatenation and may be consumed by a compiler, runtime, policy engine, verifier, authority plane, or replay service.

A policy-hooked execution graph may include action hooks, environment hooks, data hooks, retrieval hooks, memory hooks, mobile hooks, or other policy hooks. A policy graph may include policy objects, scopes, subjects, actions, constraints, and enforcement rules. A normalized policy outcome may include allow, block, modify, reroute, delay, escalate, require-approval, or another outcome. The policy outcome may be materialized as graph nodes or referenced records and may be bound into the authority-plane artifacts described elsewhere herein.

An architecture evolution subsystem may monitor replay mismatches, policy blocks, conflicts, faults, cost, latency, compliance failures, regression failures, or other drift signals. The subsystem may propose candidate mutations to schemas, compiler rules, runtime directives, routing policies, verification clauses, or environment-selection policies. Candidate variants may be tested in an isolated architecture sandbox using a regression suite, scored for determinism, latency, policy compliance, runtime cost, conflict rate, or artifact quality, and then promoted, rejected, staged, or rolled back while preserving lineage.

An application construction subsystem may convert high-level intent, tickets, issue descriptions, natural-language requests, design documents, API specifications, or form requirements into normalized requirements, component graphs, application artifacts, tests, deployment descriptors, rollback packages, and lineage links. Generated artifacts may include code modules, frontend user interfaces, backend services, APIs, database schemas, authentication configuration, infrastructure-as-code templates, tests, deployment manifests, and rollback runbooks. A deterministic test runtime may validate generated artifacts in isolated environments using defined postconditions, policy checks, and provenance records.

A workflow-conditioned user-interface layout subsystem may generate wireframes, user-interface definitions, JSON records, XML records, component trees, form schemas, mobile layouts, design-system component compositions, or other layouts from workflow graphs, roles, states, transitions, accessibility constraints, task phases, or required inputs. A CRUD or backend-binding subsystem may map user-interface elements to backend functions, service operations, database operations, endpoint descriptors, parameter lists, return schemas, and postconditions using semantic matching, parameter matching, permission matching, and validation matching. Binding records may store accepted, rejected, or review-required bindings and corresponding provenance hashes.

A secure local-agent bridge may enable cloud-side, remote, or supervisor processes to request local, device-local, on-premises, or private-network operations while preserving deterministic authorization, sandboxing, auditability, and containment. The bridge may expose endpoints or operations such as read_file, write_file, execute_command, capture_screenshot, inspect_window_state, list_processes, invoke_local_api, edit_configuration, or run_test. A local bridge manifest may define operation classes, command allowlists, file scopes, process scopes, screenshot scopes, network scopes, authentication requirements, resource limits, sandbox boundaries, audit requirements, and containment actions. A sandboxed executor, command and resource policy, audit logger, and watchdog or containment controller may cooperate to block, restart, downgrade, notify, or quarantine operations.

A confidence-weighted arbitration or specialized role supervision subsystem may assign source-analysis, GUI-exploration, execution, verification, provenance, policy, planning, or compliance roles to agents or model instances. The subsystem may receive normalized role outputs, canonical role descriptors, message-bus records, arbitration ballots, quorum thresholds, veto classes, tie-break rules, and confidence values. A selected branch or escalation outcome may identify a next action, replay, higher-assurance processing, or human review while preserving deterministic message formats and provenance references.

Environment-class routing may assign contemplated operations, blueprint nodes, workflow segments, or execution-graph edges to sandbox, staging, pre-production, production, forensic, replay, branch-isolated, observation-only, or other environment classes. Routing may depend on action class, policy outcome, confidence, quorum, data sensitivity, rollback availability, device restrictions, environment capability, verifier sufficiency, semantic-delta limits, and authority constraints. Promotion and demotion gates may evaluate policy allow or deny results, verification pass or fail results, production gates, reroute conditions, delay conditions, and rollback or recovery availability.

A fallback and recovery routing subsystem may select among regeneration, accessible template fallback, alternate model or rule-based generation, human review, manual approval, read-only containment, rollback, retry, remediation loop, or deferred execution. A fallback decision record may identify a trigger, affected component, selected path, confidence threshold, retry rule, human-review status, containment status, rollback reference, and provenance reference. The fallback decision record may be consumed by a blueprint compiler, deterministic runtime, authority-plane service, architecture evolution subsystem, or application construction subsystem.

The deterministic agent computation components described in this section may be combined with the authority-plane components described elsewhere herein. For example, canonical component records, blueprint packages, environment-lineage records, evidence blocks, arbitration records, policy outcomes, fallback decision records, binding records, local bridge manifests, mobile-state captures, retrieval-memory evidence, normalized outputs, and audit-ready packages may be hashed, referenced, embedded, verified, or bound into canonical action descriptors, signed action authority certificates, channel-binding records, continuity capsules, resume packages, semantic-delta envelopes, derivation graphs, checkpoint tokens, replay bundles, or successor authority artifacts.

The parent-architecture components described in this section may be combined with any authority-plane component described elsewhere herein. For example, code-analysis outputs, dependency graphs, workflow graphs, bounded context packages, policy outcomes, approval tokens, violation packets, constraint objects, telemetry packets, provenance records, or validation results may be bound into or referenced by a canonical action descriptor, signed action authority certificate, channel-binding record, verified-state checkpoint token, resume package, continuity capsule, replay bundle, evidence bundle, or successor authority artifact.

The embodiments in this section are illustrative and non-limiting. They may be implemented locally, remotely, in a cloud-hosted environment, on-premises, on a mobile device, in a browser, in a remote session, in a virtual machine, in a container, in a sandbox, in a micro-virtual machine, in a device farm, through a local agent bridge, through a secure connector, or in a hybrid deployment. They are intended to preserve support for parent-architecture features while integrating those features with the state-bound, policy-bound, derivation-bound, semantic-delta-bound, channel-bound, and replay-verifiable authority-plane mechanisms described herein.

### Authority-Plane Overview

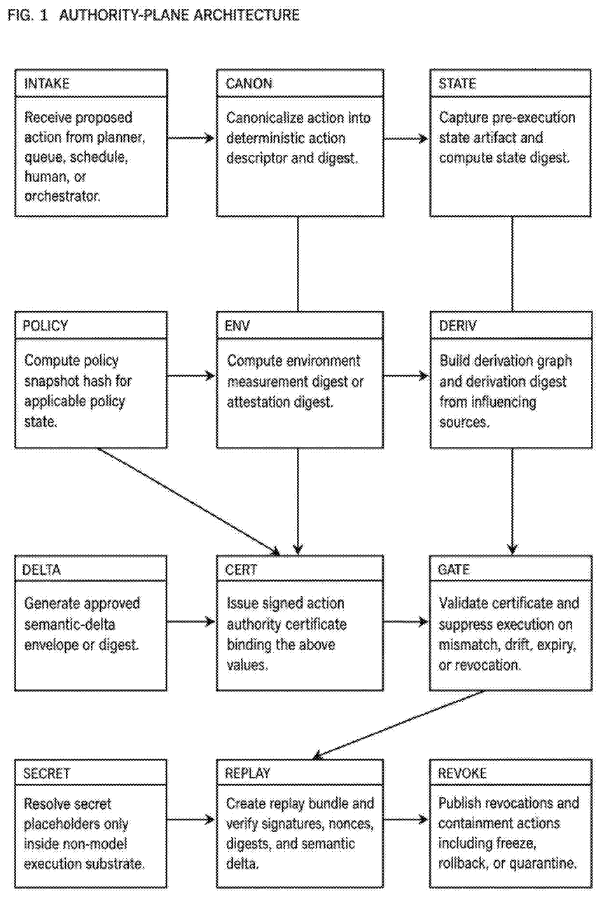

FIG. 1 illustrates an example of an authority-plane architecture 100 for controlling execution of a proposed action associated with an autonomous artificial intelligence system in accordance with aspects of the present disclosure. For example, the authority-plane architecture 100 may bind authority for the proposed action to a canonical action digest, a pre-execution state digest, a policy snapshot hash, an environment measurement digest, an approved semantic-delta envelope or a digest thereof, and a derivation-graph digest before the proposed action reaches an execution layer. In some implementations, the authority-plane architecture 100 may include an intake stage 110, a canonicalization stage 115, a state capture stage 120, a policy snapshot stage 125, an environment measurement stage 130, a derivation graph stage 135, a semantic-delta stage 140, a certificate issuance stage 145, an execution gate stage 150, a secret resolution stage 155, a replay-verification stage 160, and a revocation stage 165.

The intake stage 110 may receive the proposed action from a planner, queue, schedule, human, or orchestrator. The proposed action may be generated by a planner model, agent runtime, workflow compiler, user interface, schedule trigger, message queue, or human reviewer. The canonicalization stage 115 may canonicalize the proposed action into a canonical action descriptor and may compute the canonical action digest over a deterministic serialization of the canonical action descriptor. In some implementations, canonicalization may normalize action parameters, scope fields, target resource information, expected preconditions, expected postconditions, environment constraints, and other machine-readable fields so that non-material presentation differences do not alter the canonical action digest.

The state capture stage 120 may capture a pre-execution state artifact and compute the pre-execution state digest. The pre-execution state artifact may include structured API object state, file snapshots, document object model snapshots, accessibility tree snapshots, spreadsheet object-model state, configuration state, permission state, mobile device state, or other state information relevant to execution of the proposed action. The policy snapshot stage 125 may compute the policy snapshot hash for a policy state applicable to the proposed action. The policy state may include policies inherited from tenant, application, workflow, environment, or resource scopes.

The environment measurement stage 130 may compute the environment measurement digest or an attestation digest for an execution environment. For example, the environment measurement digest may represent one or more VM or container image identifiers, package manifests, connector manifests, browser extension lists, tool bundle hashes, hardware-attestation values, or other execution substrate measurements. The derivation graph stage 135 may build a derivation graph associated with the proposed action and may compute the derivation-graph digest over a canonical representation of the derivation graph. The derivation graph may link influencing sources and transformations, including user inputs, retrieved passages, screenshots, page text, emails, chats, tool outputs, prior model outputs, human edits, approval events, secret placeholders, or policy records.

The semantic-delta stage 140 may generate an approved semantic-delta envelope or a digest thereof. The approved semantic-delta envelope may represent permitted, forbidden, or bounded change semantics associated with the proposed action. For example, the approved semantic-delta envelope may include field-level rules, object-level rules, graph-level rules, tolerance values, forbidden classes of modifications, or compensating-response instructions. The certificate issuance stage 145 may issue a signed action authority certificate binding the above values, including the canonical action digest, the pre-execution state digest, the policy snapshot hash, the environment measurement digest, the approved semantic-delta envelope or a digest thereof, and the derivation-graph digest.

The execution gate stage 150 may validate the signed action authority certificate before execution of the proposed action. In some implementations, the execution gate stage 150 may perform certificate validation by validating at least one of a signature, a nonce, an expiration condition, a revocation status, a current pre-execution state digest, a current policy snapshot hash, a current environment measurement digest, or a current derivation-graph digest. The execution gate stage 150 may suppress execution when certificate validation fails, including when a mismatch, drift, expiry, or revocation is detected. When certificate validation succeeds, the proposed action may be permitted to execute, and an actual semantic delta associated with execution of the proposed action may be compared to the approved semantic-delta envelope.

The secret resolution stage 155 may resolve secret placeholders only inside a non-model execution substrate. In some implementations, a secret broker may expose placeholder references or opaque handles to a planner, orchestrator, or model while withholding raw secret values from model-visible context. The non-model execution substrate may include a signed process, secure enclave, container, browser automation harness, mobile sandbox, or other policy-approved runtime boundary. Restricted output handling rules may prevent secret-derived content from reentering model-visible context absent authorization.

The replay-verification stage 160 may create a replay bundle and verify signatures, nonces, digests, and semantic delta. The replay bundle may include the canonical action descriptor, the signed action authority certificate, one or more digests used for validation, provenance associated with execution of the proposed action, one or more semantic-delta envelopes, one or more derivation graph records or digests, one or more environment measurements, and one or more signature-verification artifacts. The revocation stage 165 may publish revocations and containment actions including freeze, rollback, or quarantine. In some implementations, revocation and containment actions may cancel queued executions, abort in-flight actions where safe, freeze an environment, snapshot a current environment for forensic analysis, quarantine modified resources, trigger compensating workflows, or otherwise initiate at least one containment action when the actual semantic delta exceeds the approved semantic-delta envelope.

In some embodiments, the authority-plane architecture is layered over one or more execution systems that may already provide environment provisioning, UI or API execution, perception-based verification, programmatic verification, and provenance capture. The authority plane may authorize a contemplated action before the action reaches an execution layer.

The architecture may include an action intake service, a canonicalization service, a state capture service, a policy snapshot service, an environment measurement service, a derivation graph service, a semantic-delta prediction service, a certificate issuance service, an execution gate, a delegated-authority service, a resume package service, a secret broker, a replay-verification service, and a revocation service.

The action intake service may receive proposed actions from a planner model, orchestrator, agent runtime, workflow compiler, user interface, schedule trigger, message queue, or human reviewer.

The canonicalization service may normalize the proposed action into a canonical action descriptor and may compute a canonical action digest over a deterministic serialization of the canonical action descriptor.

The state capture service may obtain one or more pre-execution state artifacts such as structured API object state, file snapshots, document object model snapshots, accessibility tree snapshots, spreadsheet object-model state, configuration state, permission state, or mobile device state, and may compute one or more pre-execution state digests.

The policy snapshot service may obtain or compute a canonical policy representation relevant to the proposed action and may compute a policy snapshot hash. The policy representation may include policies inherited from tenant, application, workflow, environment, or resource scopes.

The environment measurement service may compute or obtain one or more environment measurements such as VM or container image identifiers, package manifests, connector manifests, browser extension lists, tool bundle hashes, or hardware-attestation values, and may compute an environment measurement digest.

The derivation graph service may build a graph linking sources and transformations that influenced the proposed action. The service may compute a canonical derivation-graph digest and may also compute one or more risk indicators based on graph content or topology.

The semantic-delta prediction service may predict or specify an approved semantic-delta envelope for the proposed action. In some embodiments, the approved semantic-delta envelope is derived from policy, from a human approval, from a compiler rule, or from a prior known-good template for the action class.

The certificate issuance service may generate a signed action authority certificate over selected bound fields, may store issuance records, and may expose certificate identifiers to the execution gate and replay-verification service.

The execution gate may validate certificate fields and may suppress, delay, reroute, or escalate execution when validation fails or drift is detected.

The delegated-authority service may issue child authority artifacts subject to strict-narrowing rules and may record lineage linking parent and child certificates. In some embodiments, strict narrowing requires that a child authority artifact encode a strict subset of one or more authority dimensions encoded in the parent authority artifact, such as resource scope, action class, environment class, time window, semantic-delta envelope, privilege ceiling, or execution count.

The secret broker may resolve placeholder references to secrets only inside a non-model execution substrate and may record secret-use metadata without disclosing raw secret values to the model or to non-authorized outputs.

The replay-verification service may later reconstruct whether an execution remained within the approved bounds and may issue replay reports suitable for internal auditing, external attestation, or incident response.

### Canonical Action Descriptor Schema

In some embodiments, the canonical action descriptor includes fields for action_id, actor_id, tenant_id, session_id, action_class, target_resource_locator, parameter_map, scope_map, precondition_descriptors, postcondition_descriptors, semantic_delta_envelope_ref_or_inline, execution_channel, environment_constraints, derivation_ref_or_digest, policy_scope_ref_or_digest, issue_time, expiry_time, nonce, and metadata.

Action_class may distinguish, without limitation, read, write, create, delete, move, export, configure, schedule, delegate, deploy, approve, revoke, mobile_action, browser_action, spreadsheet_action, document_action, database_action, or connector_action classes.

Target_resource_locator may refer to one or more files, records, API objects, spreadsheet ranges, DOM nodes, access-control entries, configuration keys, mobile screens, device capabilities, or other addressable resources.

Parameter_map may be canonicalized such that semantically equivalent parameter sets produce the same canonical serialization. Non-material presentation differences such as key order, whitespace, or non-material aliases may be normalized out.

Scope_map may encode resource boundaries, tenant boundaries, environment boundaries, time boundaries, operation counts, data-classification boundaries, or other scope constraints applicable to the proposed action.

The canonical action digest may be computed over a canonical serialization of the canonical action descriptor after deterministic normalization of fields and after exclusion of fields designated as non-material for digest purposes.

Although claims may focus on selected bound fields, the specification is intended to support variants that bind fewer fields or additional fields depending on the risk profile of the action class.

### Action Authority Certificate Issuance and Validation

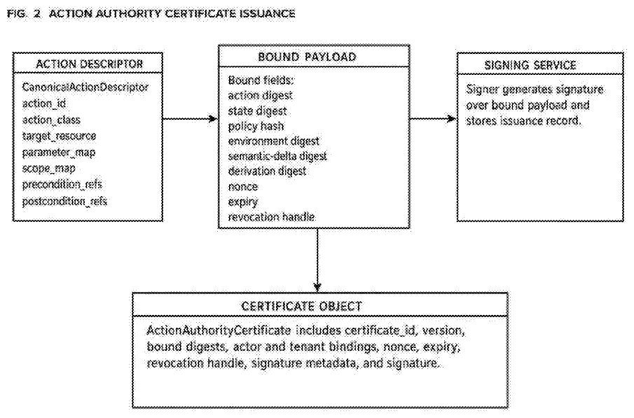

FIG. 2 illustrates an example of an action authority certificate issuance pipeline 200 for generating a signed action authority certificate bound to action-specific authority conditions in accordance with aspects of the present disclosure. For example, the action authority certificate issuance pipeline 200 can be configured to receive or form an action descriptor 210, construct a bound payload 220 from the action descriptor 210 and one or more authority bindings, process the bound payload 220 using a signing service 230, and output a certificate object 240. In some implementations, the action descriptor 210 can include a CanonicalActionDescriptor that represents a proposed action associated with an autonomous artificial intelligence system in normalized form, including one or more fields such as action_id, action_class, target_resource, parameter_map, scope_map, precondition_refs, and postcondition_refs. The action descriptor 210 may be deterministically serialized so that a canonical action digest can be computed over the canonical action descriptor and bound into later authority artifacts.

The bound payload 220 may include bound fields used to constrain execution of the proposed action before the proposed action is permitted to execute. For example, the bound payload 220 may include an action digest corresponding to the canonical action digest, a state digest corresponding to a pre-execution state digest, a policy hash corresponding to a policy snapshot hash, an environment digest corresponding to an environment measurement digest, a semantic-delta digest corresponding to an approved semantic-delta envelope or a digest thereof, and a derivation digest corresponding to a derivation-graph digest computed over a canonical representation of a derivation graph. In some implementations, the bound payload 220 can further include a nonce, an expiry, and a revocation handle so that the resulting signed action authority certificate can be validated for nonce non-reuse, an expiration condition, and revocation status before execution of the proposed action.

The signing service 230 may generate a signature over the bound payload 220 and may store an issuance record associated with the signature. In some implementations, the signing service 230 can correspond to or be included in a certificate issuance service configured to sign the signed action authority certificate using a hardware-backed signing secret, a tenant-local signing secret, or another signing topology. The issuance record may associate the signature with certificate identifiers, bound digest values, nonce-use data, revocation data, actor values, tenant values, session values, time values, signature metadata, or other values used by an execution gate, a replay-verification service, or a revocation service.

The certificate object 240 may include an ActionAuthorityCertificate generated from the bound payload 220 and the signature produced by the signing service 230. For example, the certificate object 240 may include certificate_id, version, bound digests, actor and tenant bindings, a nonce, an expiry, a revocation handle, signature metadata, and a signature. The certificate object 240 can provide a signed machine-verifiable artifact that grants authority to execute the proposed action or a workflow edge under specified binding conditions. In some implementations, the certificate object 240 may be provided to an execution gate for validating the signed action authority certificate before execution of the proposed action, suppressing execution when certificate validation fails, and permitting execution when certificate validation succeeds.

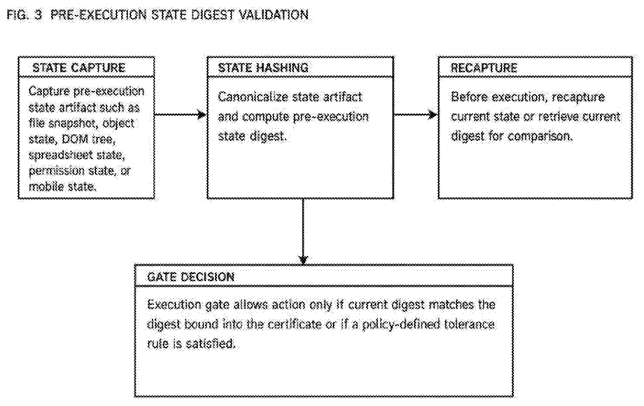

FIG. 3 illustrates an example of a pre-execution state capture and state-digest validation flow 300 for controlling execution of a proposed action associated with an autonomous artificial intelligence system in accordance with aspects of the present disclosure. For example, the pre-execution state capture and state-digest validation flow 300 may be configured to determine whether a current state matches a state bound into a signed action authority certificate before the proposed action is permitted to execute. In some implementations, the pre-execution state capture and state-digest validation flow 300 may include state capture 310, state hashing 320, recapture 330, and a gate decision 340.

State capture 310 may include capturing or receiving a pre-execution state artifact before execution of the proposed action. The pre-execution state artifact may include structured API object state, a file snapshot, a document object model snapshot, an accessibility tree snapshot, spreadsheet object-model state, configuration state, permission state, mobile device state, or other state information relevant to validation or replay. In some implementations, the pre-execution state artifact may represent a state of a resource, interface, object, file, workflow, permission configuration, or mobile device that is expected to exist when the proposed action is authorized.

State hashing 320 may include canonicalizing the pre-execution state artifact and computing a pre-execution state digest over a canonical representation of the pre-execution state artifact. The pre-execution state digest may be bound into the signed action authority certificate with one or more other values associated with the proposed action, including a canonical action digest, a policy snapshot hash, an environment measurement digest, an approved semantic-delta envelope or a digest thereof, and a derivation-graph digest. In this manner, the signed action authority certificate may grant authority to execute the proposed action under specified binding conditions.

Recapture 330 may occur before execution of the proposed action. During recapture 330, the system may recapture current state or retrieve a current pre-execution state digest for comparison against the pre-execution state digest bound into the signed action authority certificate. In some implementations, recapture 330 may be performed by an execution gate during certificate validation together with validation of at least one of a signature, a nonce, an expiration condition, a revocation status, a current policy snapshot hash, a current environment measurement digest, or a current derivation-graph digest.

The gate decision 340 may determine whether the execution gate allows the proposed action to proceed. The execution gate may allow the proposed action only if the current pre-execution state digest matches the pre-execution state digest bound into the signed action authority certificate or if a policy-defined tolerance rule is satisfied. The execution gate may suppress execution when certificate validation fails, including when a mismatch, drift, expiry, or revocation is detected. When certificate validation succeeds, the proposed action may be permitted to execute, and an actual semantic delta associated with execution of the proposed action may be compared to the approved semantic-delta envelope.

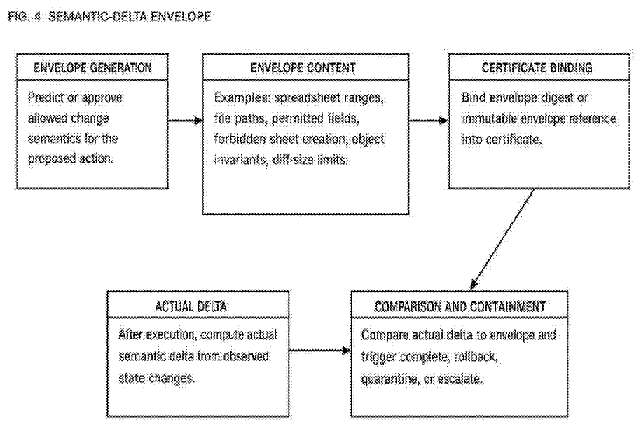

FIG. 4 illustrates an example of an approved semantic-delta envelope generation process and post-execution semantic-delta comparison process in accordance with aspects of the present disclosure. For example, the process may be configured to constrain execution of a proposed action associated with an autonomous artificial intelligence system by generating or obtaining an approved semantic-delta envelope before execution, binding the approved semantic-delta envelope or a digest thereof into a signed action authority certificate, computing an actual semantic delta after execution, and initiating a containment action when the actual semantic delta exceeds the approved semantic-delta envelope. In some implementations, the process may include envelope generation 410, envelope content 420, certificate binding 430, actual delta 440, and comparison and containment 450.

Envelope generation 410 may include predicting, computing, receiving, or approving allowed change semantics for the proposed action. The allowed change semantics may specify one or more permitted, forbidden, or bounded semantic changes associated with execution of the proposed action. In some implementations, envelope generation 410 may be performed by a semantic-delta prediction service, a policy orchestration service, an approval service, or another authority-plane component before the proposed action is permitted to reach an execution layer.

Envelope content 420 may include machine-readable content of the approved semantic-delta envelope. For example, envelope content 420 may include spreadsheet ranges, file paths, permitted fields, forbidden sheet creation rules, object invariants, diff-size limits, field-level rules, object-level rules, graph-level rules, tolerance values, forbidden classes of modifications, or compensating-response instructions. The envelope content 420 may thereby define a semantic-delta constraint that limits, permits, forbids, or bounds one or more semantic changes associated with the proposed action.

Certificate binding 430 may include binding an envelope digest or immutable envelope reference into the signed action authority certificate. In some implementations, the signed action authority certificate may also be bound to one or more of a canonical action digest, a pre-execution state digest, a policy snapshot hash, an environment measurement digest, and a derivation-graph digest. Binding the approved semantic-delta envelope or a digest thereof into the signed action authority certificate may permit an execution gate to validate authority for the proposed action before execution and to suppress execution when certificate validation fails.

Actual delta 440 may include computing an actual semantic delta from observed state changes after execution of the proposed action. The actual semantic delta may represent a semantic change to a file, spreadsheet, document object model tree, access-control list, record set, configuration object, mobile device state, database object, or other target resource. In some implementations, the actual semantic delta may be computed from a post-execution state artifact, a pre-execution state artifact, execution telemetry, provenance records, or other observed state changes.

Comparison and containment 450 may include comparing the actual semantic delta to the approved semantic-delta envelope and triggering a completion outcome, rollback, quarantine, escalation, or another containment action based on the comparison. When the actual semantic delta is within the approved semantic-delta envelope, execution may be completed or recorded as authorized. When the actual semantic delta exceeds the approved semantic-delta envelope, the system may initiate at least one containment action, including limiting, reversing, quarantining, freezing, canceling, aborting, snapshotting, rerouting, activating a compensating workflow, or otherwise controlling an execution or resource state.

In some embodiments, the action authority certificate includes certificate_id, certificate_version, canonical_action_digest, pre_execution_state_digest, policy_snapshot_hash, environment_measurement_digest, semantic_delta_digest_or_reference, derivation_graph_digest, actor_binding, tenant_binding, session_binding, expiry_time, nonce, revocation_handle, signature_metadata, and signature.

The signature may be generated using asymmetric or symmetric cryptographic techniques. Non-limiting examples include digital signatures, message-authentication codes, threshold signatures, delegated signatures, and hardware-backed signatures.

Certificate issuance may be conditioned on one or more approval events, policy checks, compiler checks, or validator checks. Such issuance conditions may be recorded in issuance metadata or lineage records even if not all issuance conditions are bound directly into the signed payload.

A certificate may be bound to a single action, a bounded set of actions, or a workflow edge, but the presently preferred embodiments emphasize per-action or per-edge authority to reduce ambiguity and replay risk.

The execution gate may require all bound fields to validate, or may allow a configurable subset to validate depending on action class. For example, a low-risk read may omit a semantic-delta envelope while a high-risk write may require one.

The certificate service may maintain revocation data and nonce-use data so that stale, duplicated, or replayed certificates are invalidated.

In some embodiments, certificate issuance is performed by a centralized service. In other embodiments, issuance is performed by a local trusted enclave, by a tenant-local signer, by a delegated orchestrator, or by another trusted signing authority.

### Approved Semantic-Delta Envelopes

The approved semantic-delta envelope may describe permitted or forbidden changes using any suitable representation. Non-limiting examples include field-level allow lists, field-level deny lists, range constraints, object-level invariants, graph-transform patterns, file-diff patterns, DOM-diff patterns, spreadsheet-range constraints, schema constraints, or state-machine constraints.

A semantic-delta envelope for a spreadsheet action may specify, by example, that only cells in a designated range may change, that formulas may be updated only in specific columns, that sheet creation is forbidden, and that hidden-sheet modifications are forbidden.

A semantic-delta envelope for a connector action may specify that only designated object fields may be updated, that destructive operations are forbidden, and that only objects already linked to the current workflow may be modified.

A semantic-delta envelope for a filesystem action may specify allowed directories, allowed file types, maximum line counts for diff hunks, forbidden secret-bearing patterns, and allowed metadata changes.

Before execution, an envelope predictor or policy service may generate a proposed semantic-delta envelope. After execution, a delta analyzer may compute an actual semantic delta and compare the actual semantic delta against the approved semantic-delta envelope.

If the actual semantic delta exceeds the approved semantic-delta envelope, the execution gate or a post-execution containment service may suppress completion, trigger rollback, quarantine outputs, generate a violation record, or require additional approval.

In some embodiments, the approved semantic-delta envelope or a digest thereof is included directly in the action authority certificate. In other embodiments, the certificate references an immutable stored envelope object.

### Derivation Graphs and Influence-Aware Authorization

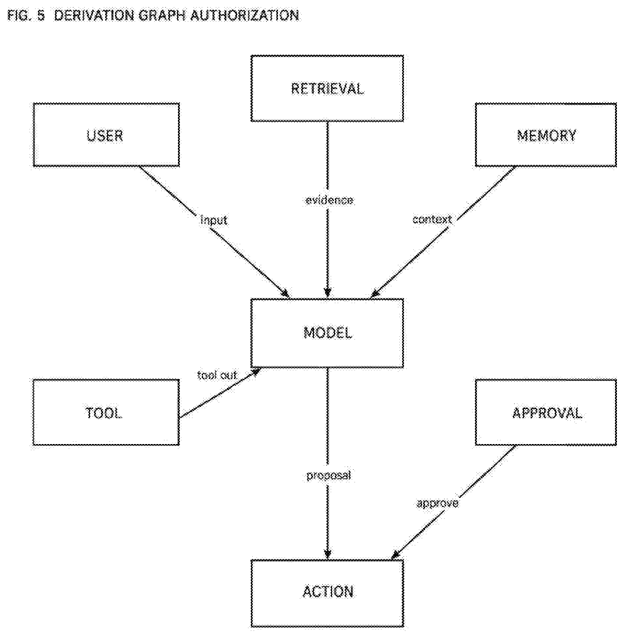

FIG. 5 illustrates an example of a derivation graph authorization arrangement configured to represent influence relationships for a proposed action associated with an autonomous artificial intelligence system. In some implementations, the derivation graph authorization arrangement may include a user 505, retrieval 510, memory 515, a model 520, a tool 525, approval 530, and an action 535. The user 505 may represent a source of user instructions or other user input that influences the model 520. The retrieval 510 may represent retrieved passages, documents, search results, connector responses, or other evidence that influences the model 520. The memory 515 may represent graph-memory entities, prior model outputs, stored workflow context, policy records, or other model-visible context that influences the model 520. The tool 525 may represent an application programming interface, script, connector, browser automation component, operating-system-level control, mobile device substrate, or other tool that produces output used by the model 520. The approval 530 may represent a human review event, policy approval event, approval-routing outcome, or other authorization event associated with the proposed action. The action 535 may represent the proposed action to be authorized, executed, suppressed, revalidated, or included in a signed action authority certificate.

In the illustrated example, the user 505 is coupled to the model 520 through an input 540. The input 540 may correspond to one or more user inputs, chats, messages, instructions, human edits, or other source nodes of the derivation graph. The retrieval 510 is coupled to the model 520 through evidence 545. The evidence 545 may correspond to retrieved passages, screenshots, page text, emails, documents, scanner outputs, software bill of materials records, telemetry records, or other evidence-bearing nodes that influence generation or review of the proposed action. The memory 515 is coupled to the model 520 through context 550. The context 550 may correspond to graph-memory entities, prior model outputs, policy records, workflow state, environment information, or other context that is available to the model 520 for generating or evaluating the proposed action.

The tool 525 is coupled to the model 520 through tool out 560. The tool out 560 may correspond to a tool output, connector response, execution result, retrieved object state, validation result, or other output generated by the tool 525 and supplied to the model 520. In some implementations, the tool out 560 may be represented as a tool-response node in the derivation graph and may include trust metadata or confidentiality metadata. For example, the trust metadata may indicate source type, trust level, verification status, origin, integrity status, or related information used in certificate validation, and the confidentiality metadata may indicate a data classification, secret-derived status, restricted-output status, authorized visibility, or handling requirement.

The model 520 is coupled to the action 535 through a proposal 565. The proposal 565 may represent a model generation operation, transformation operation, routing operation, ranking operation, or other edge by which the model 520 generates or selects the proposed action. The approval 530 is coupled to the action 535 through approve 570. The approve 570 may represent an approval operation, human review operation, policy approval operation, or require-approval outcome that influences whether the proposed action is authorized. In some implementations, the action 535 may be authorized only when the derivation graph indicates that required approval has been received and when the signed action authority certificate is valid for the current derivation graph.

The derivation graph authorization arrangement of FIG. 5 may be used to compute a derivation-graph digest over a canonical representation of node identities, node metadata, edge identities, and edge types. The canonical representation may include the user 505, the retrieval 510, the memory 515, the model 520, the tool 525, the approval 530, the action 535, and the influence edges corresponding to the input 540, the evidence 545, the context 550, the tool out 560, the proposal 565, and the approve 570. The derivation-graph digest may be bound into a signed action authority certificate together with one or more of a canonical action digest, a pre-execution state digest, a policy snapshot hash, an environment measurement digest, and an approved semantic-delta envelope or a digest thereof.

Authorization decisions may depend on the derivation graph shown in FIG. 5. For example, if the action 535 is a high-risk write action and is materially influenced by the evidence 545 or the tool out 560 having an untrusted trust_class or a restricted confidentiality_class, an execution gate may require stronger approval, a narrower approved semantic-delta envelope, a different environment measurement digest, revalidation, or issuance of a new signed action authority certificate. If the derivation graph materially changes after certificate issuance and before execution, such as by adding a new input source, changing the evidence 545, changing the context 550, replacing the tool out 560, or modifying the approve 570, the execution gate may invalidate or revalidate the signed action authority certificate before permitting execution of the action 535.

In some implementations, the derivation graph authorization arrangement may also support replay verification and incident response. The derivation graph, the derivation-graph digest, or both may be included in a replay bundle with the canonical action descriptor, the signed action authority certificate, one or more digests used for validation, and provenance associated with execution of the proposed action. Later verification may recompute the derivation-graph digest, validate one or more signatures, validate nonce distinctness, compare an actual semantic delta to the approved semantic-delta envelope, and determine how the user 505, the retrieval 510, the memory 515, the tool 525, and the approval 530 influenced the action 535.

The derivation graph may contain nodes representing one or more user inputs, retrieved passages, graph-memory entities, screenshots, page text, emails, chats, tool outputs, prior model outputs, human edits, approval events, secret placeholders, or policy records.

Edges may represent one or more of retrieval, summarization, extraction, transformation, ranking, routing, delegation, human review, model generation, tool invocation, or approval operations.

Each derivation node may include one or more metadata fields such as node_type, source_digest, trust_class, confidentiality_class, timestamp, origin_system, score, and restricted-output flag.

The derivation graph digest may be computed over a canonical representation of node identities, node metadata, edge identities, and edge types. In some embodiments, non-material fields may be omitted from the digest according to deterministic omission rules.

Authorization decisions may depend on the derivation graph. For example, if a high-risk write action is materially influenced by a node with an untrusted trust_class or a restricted confidentiality_class, the execution gate may require stronger approval, a narrower semantic-delta envelope, or a different environment measurement.

If the derivation graph materially changes after certificate issuance and before execution, such as by adding a new untrusted node or changing a transformation edge, the execution gate may invalidate or revalidate the certificate.

The derivation graph may also be included in replay bundles and incident-response bundles so that later reviewers can determine how a proposed action was influenced.

### Delegated Sub-Capability Chains

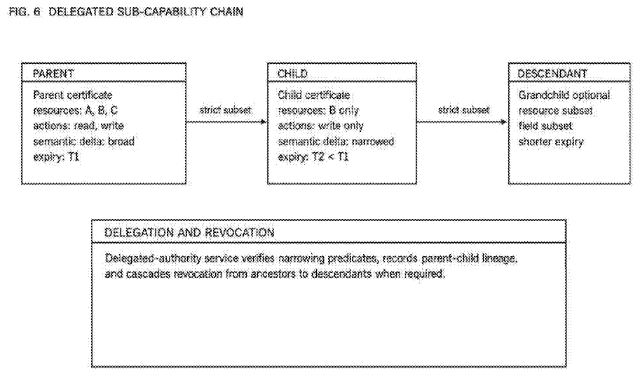

FIG. 6 illustrates an example of a delegated sub-capability chain in accordance with aspects of the present disclosure. For example, the delegated sub-capability chain may include a parent 610, a child 620, a descendant 630, and delegation and revocation 640. The parent 610 may represent a parent authority certificate defining one or more authority dimensions, such as a target-resource scope, an action class, an allowed semantic delta, an expiration window, a privilege ceiling, an execution count, an environment class, an actor binding, a tenant binding, or a policy constraint. In the illustrated example, the parent 610 includes parent certificate resources A, B, and C, actions including read and write, a broad semantic delta, and an expiry T1.

The child 620 may represent a delegated child authority certificate generated from the parent authority certificate of the parent 610. The child 620 may encode a strict subset of one or more authority dimensions encoded in the parent 610. For example, the child 620 may narrow the target-resource scope from resources A, B, and C to resource B only, may narrow the action class from read and write to write only, may narrow the allowed semantic delta relative to the parent 610, and may shorten the expiration window such that expiry T2 is less than expiry T1. In some implementations, the child 620 may include a parent_certificate_id field or a parent_digest field linking the child 620 to the parent 610, and a lineage record may record a narrowing proof used to justify issuance of the child 620.

The descendant 630 may represent a further delegated authority artifact derived directly or indirectly from the child 620. The descendant 630 may be optional and, where present, may encode a further strict subset of one or more authority dimensions encoded in the child 620. For example, the descendant 630 may include a grandchild optional resource subset, a field subset, a shorter expiry, or another narrowed scope permitted by a tenant policy, a workflow policy, or an action class policy. Delegation depth may be limited so that a tenant or workflow policy allows zero, one, or more delegation levels for different action classes.

Delegation and revocation 640 may represent operations performed by a delegated-authority service. The delegated-authority service may verify narrowing predicates before issuing the child 620 or the descendant 630, may record parent-child lineage, and may cascade revocation from ancestors to descendants when required. In some implementations, revocation of the parent 610 may invalidate the child 620 and the descendant 630, while the child 620 or the descendant 630 may also be independently revoked without revoking the parent 610. The delegated sub-capability chain of FIG. 6 may be used for sub-agent delegation, tool-specific worker delegation, connector-specific delegation, mobile-substrate delegation, or human-in-the-loop delegated execution variants.

A delegated sub-capability may be derived from a parent authority certificate by applying narrowing rules. Narrowing rules may reduce a target resource set, reduce a set of allowed actions, reduce a semantic-delta envelope, shorten an expiration window, add environment constraints, or add policy constraints.

The delegated-authority service may verify that a proposed child authority is a strict subset of the parent authority according to one or more deterministic narrowing predicates.

A child certificate may include a parent_certificate_id field or parent_digest field linking the child certificate to the parent certificate. A lineage record may also record the narrowing proof used to justify issuance of the child certificate.

Delegation depth may be limited. A tenant or workflow policy may allow zero, one, or more delegation levels. Different action classes may support different depth limits.

Revocation may cascade from a parent certificate to one or more descendant certificates. A descendant certificate may also be independently revoked without revoking the parent certificate.

The disclosure covers sub-agent delegation, tool-specific worker delegation, connector-specific delegation, mobile-substrate delegation, and human-in-the-loop delegated execution variants.

### Resume Packages and Drift-Aware Reauthorization

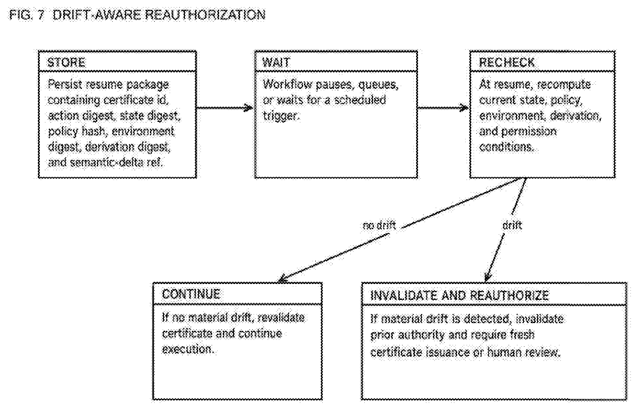

FIG. 7 illustrates an example of a drift-aware reauthorization process 710 for controlling resumed execution of a paused, queued, recurring, or scheduled workflow in accordance with aspects of the present disclosure. For example, the drift-aware reauthorization process 710 may be performed by a reauthorization service configured to determine whether prior authority for a proposed action remains valid after a workflow pause, queue interval, recurring interval, or scheduled activation. In some implementations, the drift-aware reauthorization process 710 may include a store step 720, a wait step 730, a recheck step 740, a continue step 750, and an invalidate and reauthorize step 760.

At the store step 720, the reauthorization service may persist a resume package containing authority-bound information for the workflow. The resume package may include a certificate id associated with a signed action authority certificate, a canonical action digest, a pre-execution state digest, a policy snapshot hash, an environment measurement digest, a derivation-graph digest, and an approved semantic-delta envelope reference or a digest thereof. In some implementations, the resume package may further include permission-state digests, connector manifests, revocation handles, nonce values, expiration values, or other metadata sufficient to determine whether prior authority remains valid at a later time.

At the wait step 730, the workflow pauses, queues, or waits for a scheduled trigger before execution is resumed or activated. For example, the workflow may be delayed by a policy orchestration service, held in a queue pending human approval, paused at an explicit approval checkpoint, or scheduled for later activation. During the wait step 730, one or more conditions that were present when the signed action authority certificate was issued may change, including state, policy, environment, derivation, permission, connector configuration, tool configuration, or other execution conditions.

At the recheck step 740, the reauthorization service may, at resume or scheduled activation, recompute one or more current values associated with the workflow. The current values may include a current pre-execution state digest, a current policy snapshot hash, a current environment measurement digest, a current derivation-graph digest, and one or more current permission conditions. The reauthorization service may compare the current values to corresponding values stored in the resume package or bound into the signed action authority certificate to determine whether material drift is present.

At the continue step 750, if no material drift is detected, the reauthorization service may revalidate the signed action authority certificate and continue execution of the workflow. Revalidation may include validating at least one of a signature, a nonce, an expiration condition, a revocation status, the current pre-execution state digest, the current policy snapshot hash, the current environment measurement digest, or the current derivation-graph digest. If the revalidation succeeds, an execution gate may permit execution of the proposed action under the previously granted authority.

At the invalidate and reauthorize step 760, if material drift is detected, the reauthorization service may invalidate prior authority and require fresh certificate issuance or human review before execution continues. Material drift may include policy drift, environment drift, derivation drift, state drift, permission drift, connector drift, or tool-configuration drift sufficient to affect whether the prior authority remains valid. In some implementations, the reauthorization service may encode drift reasons in structured records, suppress execution through the execution gate, route the workflow to a policy queue, request approval, issue a new signed action authority certificate, or initiate a containment action when validation fails.

A resume package may store certificate identifiers, canonical action digests, pre-execution state digests, policy snapshot hashes, environment measurement digests, derivation graph digests, semantic-delta envelope references, permission-state digests, connector manifests, and other data sufficient to determine whether prior authority remains valid.

Upon resume of a paused workflow, upon activation of a scheduled workflow, or upon firing of a recurring workflow, a reauthorization service may recompute one or more current digests and compare them to the resume package values.

If material drift is detected, such as state drift, policy drift, environment drift, derivation drift, permission drift, or connector drift, prior authority may be invalidated and a new certificate may be required.

Drift reasons may be encoded in structured records so that incident-response systems or human reviewers can determine why reauthorization was required.

The resume package may be stored locally, in encrypted remote storage, in a queue payload, in a workflow database row, or in another persistent structure, provided that integrity and confidentiality protections are preserved.

The same concepts apply to long-running streaming workflows and to workflows that are paused because of explicit human approval checkpoints.

### Secret Broker and Model-Context Firewall

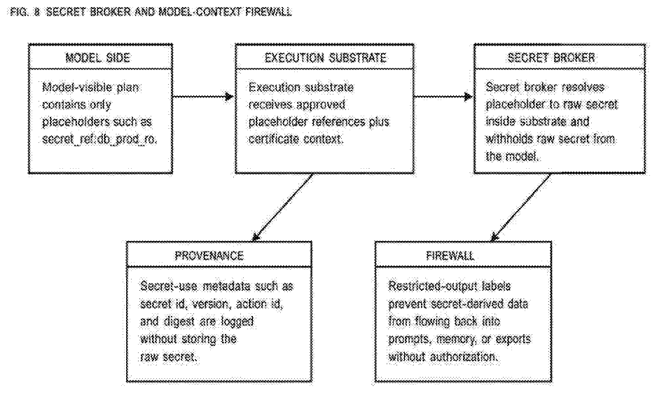

FIG. 8 illustrates an example of a secret broker and model-context firewall architecture in accordance with aspects of the present disclosure. In some implementations, the architecture may include a model side 810, an execution substrate 820, a secret broker 830, provenance 840, and a firewall 850. The model side 810 may be configured to maintain a model-visible plan that contains a placeholder for a secret rather than a raw secret value, such as an opaque handle or placeholder reference. The execution substrate 820 may be configured as a non-model execution substrate that receives approved placeholder references with certificate context for a proposed action.

The model side 810 may expose to an autonomous artificial intelligence system, planner, orchestrator, or model only information that is permitted to enter model-visible context. For example, the model-visible plan may identify a secret by a placeholder for a secret while withholding the raw secret value. In this manner, a proposed action may reference the placeholder for the secret rather than the raw secret value before the proposed action is passed toward execution.

The execution substrate 820 may receive the approved placeholder references and the certificate context and may provide a runtime boundary in which the proposed action is executed when certificate validation succeeds. In some implementations, the execution substrate 820 may include a signed process, a secure enclave, a container, a browser automation harness, a mobile sandbox, or another policy-approved runtime boundary. The execution substrate 820 may communicate with the secret broker 830 so that the secret broker 830 resolves the placeholder for the secret only inside the non-model execution substrate.

The secret broker 830 may be configured to resolve the placeholder for the secret to the raw secret value inside the execution substrate 820 and to withhold the raw secret value from the model. The secret broker 830 may expose placeholder references or opaque handles to the model side 810 while withholding the raw secret value from model-visible context. The secret broker 830 may also record secret-use metadata without disclosing or storing the raw secret value in model-visible context.

The provenance 840 may be generated based on the operation of the execution substrate 820 and may include secret-use metadata associated with use of the secret. In some implementations, the secret-use metadata may include a secret identifier, a version, an action identifier, an environment identifier, a broker identifier, a use timestamp, or a secret-use digest. The provenance 840 may support replay verification, evidence generation, or audit of the proposed action while avoiding storage of the raw secret value.

The firewall 850 may be configured as a model-context firewall that prevents raw secrets or restricted secret-derived outputs from being written into prompts, intermediate model messages, graph-memory records, evidence blocks, exported reports, memory, or export channels absent authorization. In some implementations, the firewall 850 applies a restricted-output label to secret-derived content resulting from an execution that consumed the secret. The restricted-output label may prevent the secret-derived content from entering model-visible context absent authorization and may persist until an authorized declassification or transformation step occurs.

The secret broker may expose placeholder references or opaque handles to the planner, orchestrator, or model while withholding the raw secret value from model-visible context.

At execution time, the secret broker may resolve a placeholder reference to a raw secret only inside an execution substrate such as a signed process, a secure enclave, a container, a browser automation harness, a mobile sandbox, or another policy-approved runtime boundary.

Secret-use metadata may be recorded without storing the secret itself. Non-limiting examples include secret identifier, broker identifier, use timestamp, action identifier, environment identifier, and secret-use digest or version.

The model-context firewall may prevent raw secrets or restricted secret-derived outputs from being written into prompts, intermediate model messages, graph-memory records, evidence blocks, or exported reports absent explicit authorization.

In some embodiments, the firewall applies dataflow tags or restricted-output flags to data produced by an action that consumed a secret. Such tags may persist until an authorized declassification or transformation step occurs.

The disclosure therefore covers not only storage of secrets but also containment of secret influence across model-visible and non-model-visible boundaries.

### Replay Verification, Revocation, and Attestation

FIG. 9 illustrates an example of a revocation and replay verification process 900 for an autonomous artificial intelligence system in accordance with aspects of the present disclosure. In some implementations, the process 900 may include a revocation operation 910, a containment operation 920, a replay bundle operation 930, and a replay verification operation 940. The revocation and replay verification process 900 may be used to invalidate a signed action authority certificate responsive to a revocation event, to trigger a containment action when validation fails or when an actual semantic delta exceeds an approved semantic-delta envelope, and to generate an audit record for determining whether execution of a proposed action remained within authorized bounds.

At the revocation operation 910, a revocation service may publish certificate revocations and descendant invalidations. For example, the revocation service may publish revocation information associated with a revocation handle stored in association with the signed action authority certificate. The revocation information may indicate that the signed action authority certificate is no longer valid, that one or more delegated child authority certificates are invalid, or that authority derived from a parent authority certificate is invalid. The revocation operation 910 may accordingly update a revocation status used when validating the signed action authority certificate before execution of the proposed action.

At the containment operation 920, an execution gate may halt queued actions, freeze environments, or trigger rollback where safe. In some implementations, the execution gate may suppress execution when certificate validation fails, when a current pre-execution state digest differs from the pre-execution state digest bound into the signed action authority certificate, or when the actual semantic delta exceeds the approved semantic-delta envelope. The containment operation 920 may include canceling queued executions, aborting in-flight actions where safe, freezing an environment, snapshotting a current environment for forensic analysis, quarantining modified resources, initiating rollback, or activating a compensating workflow.

At the replay bundle operation 930, a replay bundle may store a canonical action descriptor, the signed action authority certificate, one or more digests used for validation, one or more signatures, the approved semantic-delta envelope, and provenance associated with execution of the proposed action. In some implementations, the replay bundle may further include one or more state artifacts or state digests, one or more derivation graph records or derivation-graph digests, one or more environment measurements, one or more nonce records, and one or more signature-verification artifacts. The replay bundle operation 930 may provide data usable for near-real time verification, post hoc verification, incident-response verification, or verification by an external verifier acting on an exported replay bundle.

At the replay verification operation 940, a replay verifier may recompute one or more digests, validate one or more signatures, validate nonce distinctness, compare the actual semantic delta to the approved semantic-delta envelope, and issue an audit report. In some implementations, the replay verifier may recompute the canonical action digest, the pre-execution state digest, the policy snapshot hash, the environment measurement digest, or the derivation-graph digest from corresponding replay bundle content. The audit report may indicate whether the proposed action was authorized by the signed action authority certificate, whether the nonce use was valid, whether the revocation status permitted execution, and whether execution remained within the approved semantic-delta envelope.

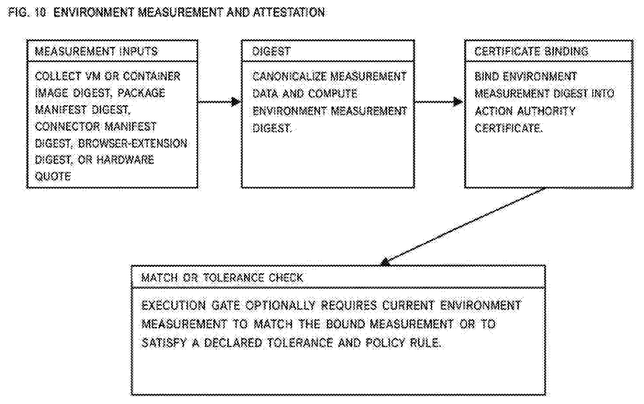

FIG. 10 illustrates an example of an environment measurement and attestation binding flow 1000 configured for binding an execution environment for a proposed action to a signed action authority certificate in accordance with aspects of the present disclosure. For example, the environment measurement and attestation binding flow 1000 may be configured for obtaining or computing an environment measurement digest associated with the execution environment for the proposed action, binding the environment measurement digest into the signed action authority certificate, and validating a current environment measurement digest before execution of the proposed action, in accordance with one or more implementations. In some implementations, the environment measurement and attestation binding flow 1000 may include measurement inputs 1010, a digest step 1020, a certificate binding step 1030, and a match or tolerance check 1040.

The measurement inputs 1010 may include one or more measurements collected from the execution environment. In some implementations, the measurement inputs 1010 may include a VM or container image digest, a package manifest digest, a connector manifest digest, a browser-extension digest, a hardware quote, or any combination thereof. The measurement inputs 1010 may represent environment-specific evidence used to characterize the execution environment in which the proposed action is to be executed.

The digest step 1020 may follow the measurement inputs 1010. At the digest step 1020, measurement data associated with the measurement inputs 1010 may be canonicalized and used to compute the environment measurement digest. The environment measurement digest may provide a deterministic representation of the measurement data for use in certificate issuance, certificate validation, replay verification, drift detection, or other authorization-plane processing.

The certificate binding step 1030 may follow the digest step 1020. At the certificate binding step 1030, the environment measurement digest may be bound into the signed action authority certificate.

The signed action authority certificate may also be bound to one or more other authorization values for the proposed action, including a canonical action digest, a pre-execution state digest, a policy snapshot hash, an approved semantic-delta envelope or a digest thereof, and a derivation-graph digest.

The match or tolerance check 1040 may follow the certificate binding step 1030 and may be performed before execution of the proposed action. At the match or tolerance check 1040, an execution gate may optionally require a current environment measurement to match a bound measurement in the signed action authority certificate or to satisfy a declared tolerance and policy rule. When the match or tolerance check 1040 fails, execution of the proposed action may be suppressed. When the match or tolerance check 1040 succeeds, the proposed action may be permitted to execute subject to other validation requirements of the signed action authority certificate.

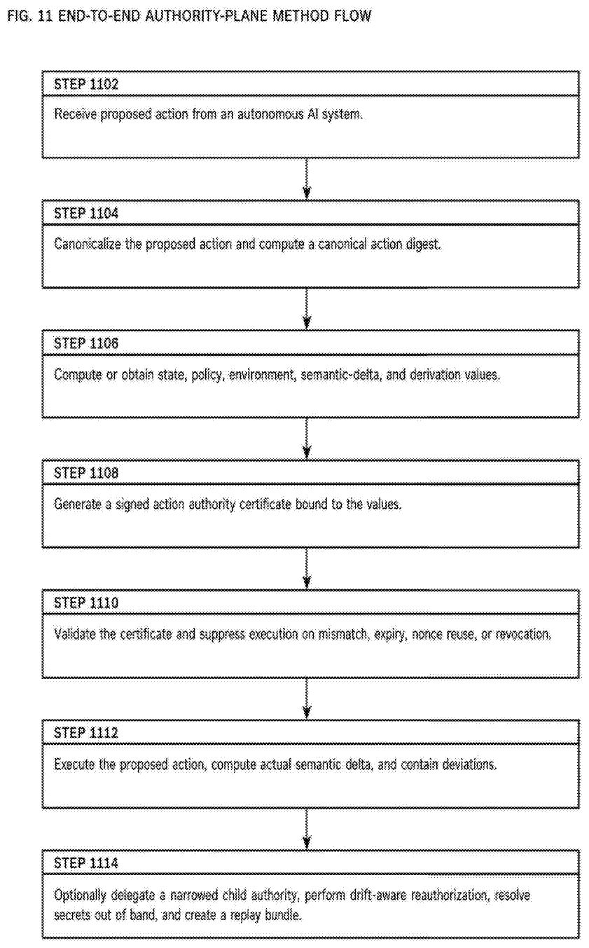

FIG. 11 illustrates an example of an end-to-end authority-plane method flow 1100 for controlling execution of a proposed action associated with an autonomous artificial intelligence system in accordance with aspects of the present disclosure. For example, the end-to-end authority-plane method flow 1100 may be configured to bind authority for the proposed action to a canonical action digest, a pre-execution state digest, a policy snapshot hash, an environment measurement digest, an approved semantic-delta envelope or a digest thereof, and a derivation-graph digest before the proposed action is executed, in accordance with one or more implementations. In some implementations, the end-to-end authority-plane method flow 1100 may include receiving the proposed action at step 1102, canonicalizing the proposed action and computing the canonical action digest at step 1104, computing or obtaining state, policy, environment, semantic-delta, and derivation values at step 1106, generating a signed action authority certificate at step 1108, validating the signed action authority certificate at step 1110, executing the proposed action and evaluating execution effects at step 1112, and optionally performing delegated-authority, drift-aware reauthorization, secret-resolution, and replay-verification operations at step 1114.

At step 1102, the method may include receiving the proposed action from the autonomous artificial intelligence system. The proposed action may be generated by a planner model, orchestrator, agent runtime, workflow compiler, user interface, schedule trigger, message queue, human reviewer, or another source associated with the autonomous artificial intelligence system. The proposed action may identify an action class, a target-resource scope, one or more parameters, one or more expected preconditions, one or more expected postconditions, an execution environment, or other information used to determine whether execution of the proposed action is authorized.

At step 1104, the method may include canonicalizing the proposed action into a canonical action descriptor and computing the canonical action digest over a deterministic serialization of the canonical action descriptor. In some implementations, canonicalizing the proposed action may normalize action parameters, scope fields, target resource information, expected preconditions, expected postconditions, environment constraints, and other machine-readable fields so that non-material presentation differences do not alter the canonical action digest. The canonical action digest may provide a stable value that can be bound into the signed action authority certificate and recomputed during certificate validation or replay-verifying.

At step 1106, the method may include obtaining or computing values associated with state, policy, environment, semantic-delta, and derivation. For example, the method may obtain or compute the pre-execution state digest associated with the pre-execution state artifact, the policy snapshot hash associated with the policy state applicable to the proposed action, the environment measurement digest associated with the execution environment for the proposed action, the approved semantic-delta envelope associated with the proposed action, and the derivation-graph digest over a canonical representation of the derivation graph. In some implementations, the derivation graph may represent influencing sources and transformations associated with the proposed action, and the approved semantic-delta envelope may specify one or more permitted, forbidden, or bounded semantic changes associated with execution of the proposed action.

At step 1108, the method may include generating the signed action authority certificate bound to at least the canonical action digest, the pre-execution state digest, the policy snapshot hash, the environment measurement digest, the approved semantic-delta envelope or a digest thereof, and the derivation-graph digest. In some implementations, the signed action authority certificate may further include or be associated with a signature, a nonce, an expiration condition, a revocation status or revocation handle, actor and tenant bindings, session bindings, signature metadata, or issuance metadata. The signed action authority certificate may thereby provide a machine-verifiable artifact that grants authority to execute the proposed action under specified binding conditions.

At step 1110, the method may include validating the signed action authority certificate before execution of the proposed action and suppressing execution of the proposed action when certificate validation fails. In some implementations, validating the signed action authority certificate may include validating at least one of the signature, the nonce, the expiration condition, the revocation status, a current pre-execution state digest, a current policy snapshot hash, a current environment measurement digest, or a current derivation-graph digest. The method may suppress execution when a mismatch, expiry, nonce reuse, revocation, material drift, or another validation failure is detected, and may allow execution to proceed when certificate validation succeeds.

At step 1112, the method may include executing the proposed action when certificate validation succeeds, computing an actual semantic delta associated with execution of the proposed action, comparing the actual semantic delta to the approved semantic-delta envelope, and initiating at least one containment action when the actual semantic delta exceeds the approved semantic-delta envelope. In some implementations, the containment action may include limiting, reversing, quarantining, freezing, canceling, aborting, snapshotting, rerouting, initiating rollback, activating a compensating workflow, or otherwise controlling an execution or resource state.

At step 1114, the method may optionally include generating a delegated child authority certificate from a parent authority certificate, performing drift-aware reauthorization for a paused, queued, recurring, or scheduled workflow, resolving a secret by a secret broker out of band, and generating a replay bundle. In some implementations, the delegated child authority certificate may encode a strict subset of one or more authority dimensions encoded in the parent authority certificate, including one or more of the target-resource scope, the action class, the allowed semantic delta, or the expiration window. The drift-aware reauthorization may include storing a resume package and, upon resume or scheduled activation, recomputing one or more current digests and invalidating the signed action authority certificate when material drift is detected. The secret broker may resolve a placeholder for the secret only inside a non-model execution substrate, and a restricted-output label may prevent secret-derived content from entering model-visible context absent authorization. The replay bundle may include at least the canonical action descriptor, the signed action authority certificate, one or more digests used for validation, and provenance associated with execution of the proposed action, and may support replay-verifying by recomputing at least one digest, validating at least one signature, validating nonce non-reuse, and comparing the actual semantic delta to the approved semantic-delta envelope.

A replay bundle may include a canonical action descriptor, one or more authority certificates, one or more state artifacts or state digests, one or more semantic-delta envelopes, one or more derivation graph records or digests, one or more environment measurements, one or more provenance records, and one or more signatures or signature-verification artifacts.

A replay-verification service may recompute one or more digests, verify one or more signatures, validate nonce uniqueness, compare actual semantic deltas to approved semantic-delta envelopes, and emit a replay report indicating whether execution remained within authorized bounds.

The replay-verification service may operate in near-real time, post hoc, or in incident-response mode. It may be used internally or by an external verifier acting on an exported replay bundle.

Revocation and containment operations may include canceling queued executions, aborting in-flight actions where safe, freezing an environment, snapshotting a current environment for forensic analysis, quarantining modified resources, or triggering compensating workflows.

Optional environment attestation may be incorporated by including a hardware quote, image hash, package manifest digest, browser-extension manifest digest, or other environment measurement in the certificate and replay bundle.

### Checkpoint Tokens, Verified-State Recovery, and Compensating Actions

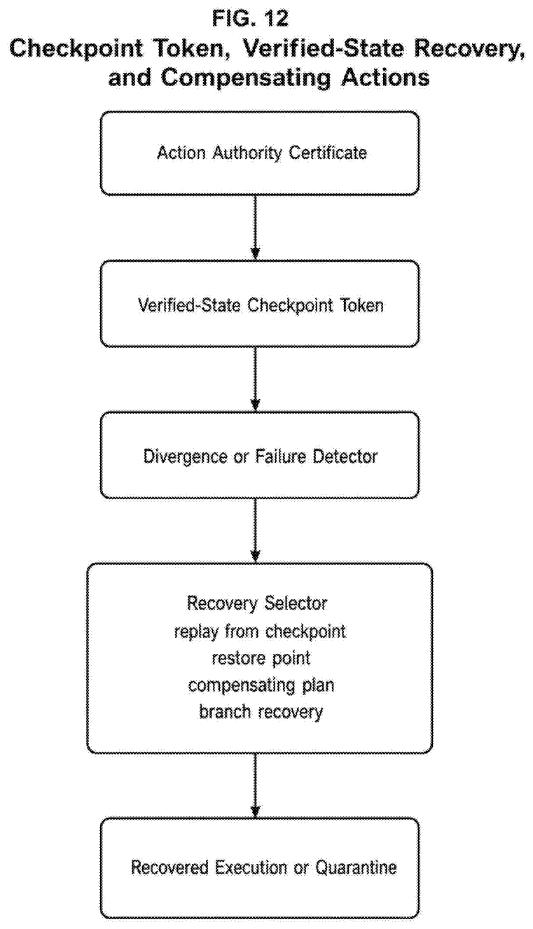

FIG. 12 illustrates an example of a method 1200 for checkpoint-token issuance, verified-state recovery, and compensating actions in accordance with aspects of the present disclosure. For example, the method 1200 may be configured to bind recovery semantics to verified state and controlled authority so that an autonomous artificial intelligence system may resume execution, activate a compensating-action plan, or enter quarantine responsive to a divergence event or a failure event. In some implementations, the method 1200 may include an action authority certificate 1210, which may be a signed action authority certificate bound to one or more of a canonical action digest, a pre-execution state digest, a policy snapshot hash, an environment measurement digest, an approved semantic-delta envelope or a digest thereof, and a derivation-graph digest. The action authority certificate 1210 may provide an authority anchor from which a verified-state checkpoint token 1220 is generated after one or more verification conditions are satisfied, including precondition satisfaction, postcondition satisfaction, semantic-delta compliance, policy compliance, derivation-graph acceptability, environment-measurement validity, ticket-state consistency, or operator approval.

The verified-state checkpoint token 1220 may reference or incorporate a checkpoint identifier, a certificate identifier, a state digest, an environment digest, a policy hash, a derivation digest, a permitted replay scope, a signature, or an integrity digest. The verified-state checkpoint token 1220 may be evaluated by a divergence or failure detector 1230, which may detect a divergence event or a failure event based on checkpoint mismatches, semantic-delta anomalies, execution telemetry, policy-queue outcomes, digest mismatches, or other verification failures. Responsive to detection by the divergence or failure detector 1230, a recovery selector 1240 may select among replay from checkpoint, restore point, compensating plan, and branch recovery. In a replay from checkpoint mode, execution may resume from the verified-state checkpoint token 1220 using one or more bound digests. In a restore point mode, a prior state artifact may be restored before replay of a later branch. In a compensating plan mode, a compensating-action plan may execute one or more reversal actions, corrective actions, neutralizing actions, rollback actions, quarantine actions, or other operations that reduce, reverse, or control the effect of one or more already-executed operations. In a branch recovery mode, an alternate branch may be activated after failure analysis or from a pre-approved recovery alternative. The recovery selector 1240 may output recovered execution or quarantine 1250, such that execution continues within authorized bounds when recovery succeeds or a containment action is initiated when recovery is not permitted, when validation fails, or when the actual semantic delta exceeds the approved semantic-delta envelope.

In some embodiments, the control-plane architecture issues a verified-state checkpoint token after an intermediate state has satisfied one or more verification conditions. The verification conditions may include one or more of precondition satisfaction, postcondition satisfaction, semantic-delta compliance, policy compliance, derivation-graph acceptability, environment-measurement validity, ticket-state consistency, or operator approval. A checkpoint token may reference or incorporate a checkpoint identifier, a prior certificate identifier, a pre-execution or post-execution state digest, an environment digest, a policy hash, a derivation digest, a permitted replay scope, and a signature or integrity digest. The checkpoint token may therefore serve as a resumable authority anchor for a later replay or recovery operation rather than merely as a generic log marker.

A recovery subsystem may maintain a VerifiedStateRecord, a RecoveryBranchDescriptor, a RestorePointArtifact, and a CompensatingActionPlan. The VerifiedStateRecord may identify the last state that was both observed and accepted. The RecoveryBranchDescriptor may identify a branch from which replay may resume. The RestorePointArtifact may reference a snapshot, state serialization, object-model capture, file-system checkpoint, mobile sandbox snapshot, or remote-session state capture. The CompensatingActionPlan may define one or more reversal actions, corrective actions, or neutralizing actions that reduce, reverse, or quarantine the effect of one or more already-executed operations.

Recovery may proceed in several modes. In a replay-from-checkpoint mode, the system resumes deterministic execution from the last verified state using the checkpoint token and one or more bound digests. In a restore-and-replay mode, the system first restores a prior state artifact and then replays a later branch under modified policy, environment, or derivation conditions. In a compensating-action mode, the system does not necessarily restore an old state directly but instead executes one or more compensating operations that neutralize an already-applied change. In a branch-recovery mode, the system activates an alternate branch that was compiled in advance or synthesized responsively after failure analysis.

Checkpoint creation and recovery may be channel specific. In a browser or document workflow, a checkpoint may include DOM-state digests, document object-model digests, spreadsheet range digests, file digests, connector object identifiers, or rendered-screen digests. In an API or connector workflow, a checkpoint may include response digests, object-model snapshots, transaction identifiers, or lease identifiers. In a mobile workflow, a checkpoint may include mobile accessibility trees, screenshot digests, permission-state digests, app route identifiers, or on-device sandbox snapshot identifiers. In a remote-session workflow, a checkpoint may include control ownership state, cursor or focus state, active-window identifiers, and a digest of one or more displayed interface artifacts.

To preserve robustness against competitor substitutions, recovery is not limited to a single snapshot technology or a single storage medium. Some embodiments use VM snapshots, container snapshots, or storage-layer snapshots. Some embodiments store semantic restore records instead of byte-identical snapshots. Some embodiments derive compensating plans from workflow metadata, graph-fusion outputs, root-cause rankings, or ITSM ticket state. Other embodiments maintain an ordered undo or recovery stack, a journal of reversible actions, or a branch catalog of pre-approved recovery alternatives. All such variants may still implement checkpoint-based or compensating recovery when they bind recovery semantics to verified state and controlled authority.

### Graph Fusion of Source-Derived and Gui-Derived Workflows

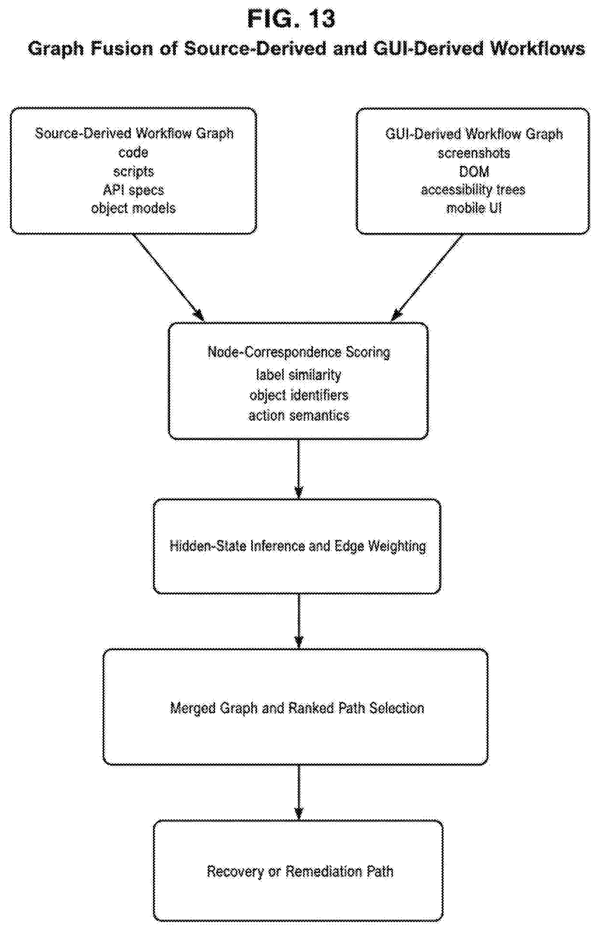

FIG. 13 illustrates an example of a graph-fusion service configured to construct a source-derived workflow graph 1310 and a GUI-derived workflow graph 1320, compute node-correspondence scoring 1330 and edge weights for candidate correspondences between workflow graphs, and select a ranked path from a merged graph in accordance with aspects of the present disclosure. For example, FIG. 13 may represent an embodiment in which graph-fusion outputs are used for planning, recovery, retrospective explanation, root-cause hypothesis generation, checkpoint-recovery branch choice, or selection of a recovery or remediation path 1360. In some implementations, the source-derived workflow graph 1310 may be constructed from one or more source artifacts, including code, scripts, API specs, object models, configuration files, interface definitions, or test assets. The GUI-derived workflow graph 1320 may be constructed from one or more interface observations, including screenshots, DOM structures, accessibility trees, mobile UI trees, click traces, gesture traces, or recorded human sessions.

The source-derived workflow graph 1310 and the GUI-derived workflow graph 1320 may be provided as independent graph inputs to the node-correspondence scoring 1330. The source-derived workflow graph 1310 may identify workflow nodes and transitions predicted or observed from source-side artifacts, while the GUI-derived workflow graph 1320 may identify workflow nodes and transitions predicted or observed from user-interface-side artifacts. By receiving both graph inputs, the node-correspondence scoring 1330 may evaluate candidate correspondences between source nodes and GUI nodes before the system forms a merged representation of the workflow.

The node-correspondence scoring 1330 may compare candidate source nodes and GUI nodes using one or more features. As shown, the features may include label similarity, object identifiers, and action semantics. In some implementations, the node-correspondence scoring 1330 may additionally or alternatively use object-model identifiers, field names, role attributes, observed effect patterns, verifier observations, provenance proximity, or other supported evidence for determining node-correspondence scores. The node-correspondence scoring 1330 may generate a FusionCandidateSet or a CorrespondenceScoreRecord that identifies potential mappings between source nodes and GUI nodes and stores feature-level contributions used to justify a mapping.

The hidden-state inference and edge weighting 1340 may receive the candidate correspondences and infer relationships that are absent, collapsed, or incompletely represented in one of the source-derived workflow graph 1310 or the GUI-derived workflow graph 1320. Hidden-state inference may propose a latent page, modal dialog, permission prompt, asynchronous state, connector side effect, or intermediate transformation inferred from incomplete evidence. Edge weights may be assigned using one or more of control-flow confidence, data-flow confidence, temporal proximity, modality consistency, environment compatibility, or prior replay success. In this manner, the hidden-state inference and edge weighting 1340 may produce evidence usable to distinguish plausible workflow transitions from lower-confidence transitions.

The merged graph and ranked path selection 1350 may generate a merged graph derived from the candidate correspondences, hidden-state hypotheses, and edge weights. Ranked path selection may select one or more plausible paths across the merged graph according to weighted path scores, policy constraints, checkpoint availability, semantic-delta compatibility, or confidence derived from verifier feedback. The merged graph and ranked path selection 1350 may output a RankedPathSet containing one or more candidate remediation or execution paths used by a supervisor, root-cause engine, or policy orchestrator.

The recovery or remediation path 1360 may be selected from the RankedPathSet and may be used to recover from a failure condition, remediate a detected issue, or explain a mismatch between source-side evidence and GUI-side evidence. For example, when a source-derived plan predicts an API-side update while GUI-derived observations show a modal confirmation path, the merged graph may indicate that a hidden confirmation state exists between source and GUI modalities. As another example, when a GUI-derived path suggests a successful action but source-derived state shows missing data mutation, the merged graph may indicate a latent rollback or transaction-failure state. The recovery or remediation path 1360 may in turn feed into root-cause hypotheses, checkpoint mismatches, policy-queue outcomes, or a selected remediation action.

In some embodiments, the system builds a source-derived workflow graph from one or more source artifacts such as code, scripts, configuration files, interface definitions, object models, or test assets and independently builds a GUI-derived workflow graph from one or more interface observations such as screenshots, accessibility trees, DOM structures, mobile UI trees, click traces, gesture traces, or recorded human sessions. A graph-fusion subsystem then produces a merged workflow graph using node-correspondence scoring, edge weighting, hidden-state inference, and ranked path selection.

Node-correspondence scoring may compare candidate source nodes and GUI nodes using one or more of label similarity, action semantics, object-model identifiers, field names, role attributes, observed effect patterns, verifier observations, or provenance proximity. Edge weights may be assigned using one or more of control-flow confidence, data-flow confidence, temporal proximity, modality consistency, environment compatibility, or prior replay success. Hidden-state inference may propose latent intermediate states or omitted transitions when one graph contains evidence of a transition that is absent or collapsed in the other graph. Ranked path selection may then choose one or more plausible paths across the merged graph according to weighted path scores, policy constraints, checkpoint availability, semantic-delta compatibility, or confidence derived from verifier feedback.

The graph-fusion subsystem may output a FusionCandidateSet, a CorrespondenceScoreRecord, a HiddenStateHypothesis record, and a RankedPathSet. A FusionCandidateSet may identify potential mappings between source nodes and GUI nodes. A CorrespondenceScoreRecord may store feature-level contributions used to justify a mapping. A HiddenStateHypothesis may identify a latent page, modal dialog, permission prompt, asynchronous state, connector side effect, or intermediate transformation inferred from incomplete evidence. A RankedPathSet may contain one or more candidate remediation or execution paths used by a supervisor, root-cause engine, or policy orchestrator.

The graph-fusion logic may be used for planning, recovery, or retrospective explanation. For example, if a source-derived plan predicts an API-side update while the GUI-derived observations show a modal confirmation path, the fused graph may reveal that a hidden confirmation state exists between the source and GUI modalities. Likewise, if a GUI-derived path suggests a successful action but source-derived state shows missing data mutation, the fused graph may reveal a latent rollback or transaction-failure state. These fusion outputs may feed directly into ranked root-cause hypothesis generation, checkpoint-recovery branch choice, or delegated sub-capability issuance.

### Ranked Root-Cause Hypothesis Generation

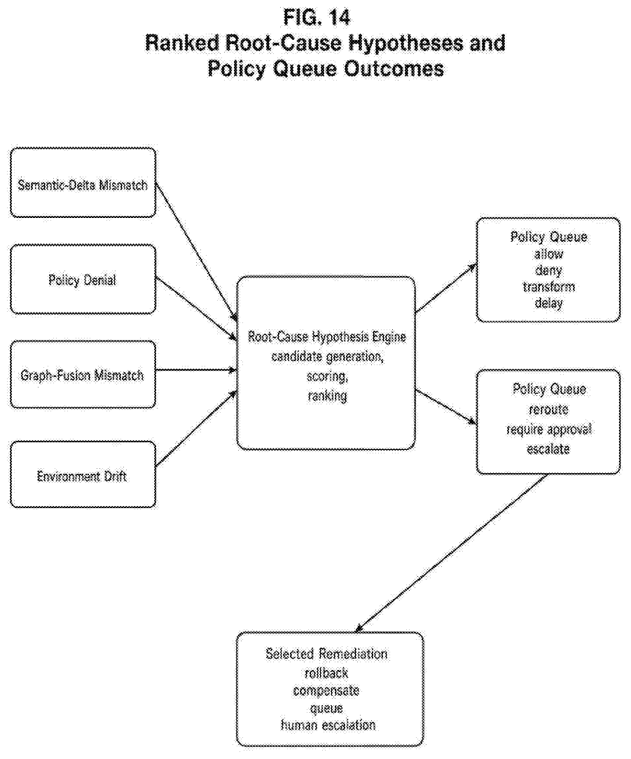

FIG. 14 illustrates an example of ranked root-cause hypotheses and policy queue outcomes in accordance with aspects of the present disclosure. For example, FIG. 14 may illustrate a root-cause hypothesis engine 1450 configured for candidate generation, scoring, and ranking based on failure signals received from a semantic-delta mismatch 1410, a policy denial 1420, a graph-fusion mismatch 1430, and environment drift 1440. In some implementations, the semantic-delta mismatch 1410 may identify that an actual semantic delta associated with execution of a proposed action exceeds an approved semantic-delta envelope or otherwise differs from an expected state change. The policy denial 1420 may identify that a policy orchestration service, a policy snapshot, or a policy queue state prevents or restricts execution of a contemplated action. The graph-fusion mismatch 1430 may identify a disagreement between source-derived workflow evidence and GUI-derived workflow evidence, such as a hidden state, omitted transition, or modality inconsistency produced by graph-fusion logic. The environment drift 1440 may identify that a current environment measurement, execution environment, connector state, credential state, or environment class differs from a state or class used for authority validation. The root-cause hypothesis engine 1450 may generate a plurality of root-cause hypotheses for a failure condition, score the plurality of root-cause hypotheses based on at least one of semantic-delta anomalies, graph-fusion outputs, execution telemetry, checkpoint mismatches, or policy-queue outcomes, and rank the plurality of root-cause hypotheses for remediation selection. In some implementations, a ranked hypothesis output from the root-cause hypothesis engine 1450 may be provided to a policy queue 1460 configured to produce one or more outcomes selected from allow, deny, transform, or delay. The allow outcome may permit execution under applicable authority constraints, the deny outcome may suppress execution, the transform outcome may modify a contemplated action before execution, and the delay outcome may hold the contemplated action until a checkpoint token, credential refresh, policy refresh, or human approval arrives. In some implementations, the ranked hypothesis output may additionally or alternatively be provided to a policy queue 1470 configured to produce one or more outcomes selected from reroute, require approval, or escalate. The reroute outcome may move execution between execution classes, the require approval outcome may cause the contemplated action to await approval prerequisites, and the escalate outcome may direct the failure condition to a higher-priority queue, an ITSM object, a case-management object, or a human operator. As shown, the policy queue 1470 may feed a selected remediation 1480. The selected remediation 1480 may include rollback, compensate, queue, or human escalation, and may be selected according to the ranking produced by the root-cause hypothesis engine 1450 and the policy-queue outcomes produced by the policy queue 1460 or the policy queue 1470.

In some embodiments, a root-cause engine receives failure signals including semantic-delta mismatches, verifier failures, policy denials, derivation-graph anomalies, environment-drift events, graph-fusion mismatches, connector errors, ticket-state conflicts, or remote-session ownership conflicts. The engine generates two or more candidate root-cause hypotheses, scores the hypotheses, and ranks them for remediation selection, rollback selection, or escalation. Candidate hypotheses may identify one or more of stale state, hidden GUI state, incorrect policy snapshot, derivation contamination, credential scope mismatch, environment mismatch, network latency, missing prerequisite action, conflicting ticket ownership, or malformed source-derived workflow assumptions.

Hypothesis scoring may use one or more of evidence coverage, contradiction count, path consistency, prior remediation success, modality agreement, environment class, checkpoint availability, or policy criticality. Some embodiments use weighted scoring functions. Some embodiments use pairwise ranking. Some embodiments use verifier-confirmed elimination rules. Some embodiments attach explanation digests or evidence bundles so later replay or audit can validate why a remediation was selected. The ranked hypotheses may then feed a remediation selector that chooses rollback, compensating action, policy queue insertion, delegated sub-capability issuance, human escalation, or production denial.

The root-cause engine may be tightly coupled to the graph-fusion subsystem. For example, a hidden-state hypothesis from graph fusion may become a first root-cause candidate, while a policy mismatch may become a second candidate, and a stale checkpoint token may become a third candidate. The ranking logic may then choose the hidden-state explanation if it best accounts for the observed GUI path and semantic-delta anomaly, while suppressing lower-ranked explanations. This ranked-causality pipeline is intended to provide a narrower and more technically grounded disclosure than a generic error-classification module.

### Action-Level Policy Orchestration, Approval Queues, and Environment-Class Routing

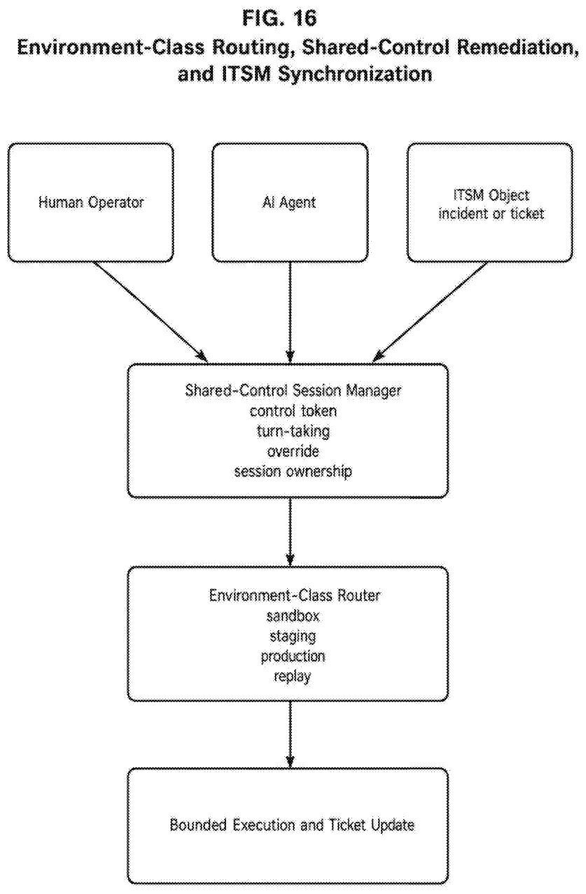

FIG. 16 illustrates an example of an environment-class routing, shared-control remediation, and ITSM synchronization architecture 1600 in accordance with aspects of the present disclosure. For example, the architecture 1600 may be configured to coordinate a shared-control session between a human operator 1610 and an AI Agent 1620, bind the shared-control session to an ITSM Object incident or ticket 1630, route a contemplated action through an Environment-Class Router 1650, and perform Bounded Execution and Ticket Update 1660 under authority, policy, and ticket-lifecycle constraints. In some implementations, the human operator 1610, the AI Agent 1620, and the ITSM Object incident or ticket 1630 may provide control, action, approval, status, or lifecycle inputs to a Shared-Control Session Manager 1640.

The human operator 1610 may represent an operator, approver, administrator, analyst, or other user participating in a local or remote session. The AI Agent 1620 may represent an autonomous artificial intelligence system, supervised AI agent, execution agent, verification agent, provenance agent, ticket-synchronization agent, or other agent participating in shared-control remediation. The ITSM Object incident or ticket 1630 may represent a ticket, incident, case, problem, request, escalation record, or other ITSM or case-management object associated with execution events, evidence records, remediation records, or lifecycle state. The ITSM Object incident or ticket 1630 may have a lifecycle state selected from create, queue, assign, escalate, contain, validate, remediate, verify, reopen, close, SLA-breach, or policy-breach states.

The Shared-Control Session Manager 1640 may receive or maintain session inputs from the human operator 1610, the AI Agent 1620, and the ITSM Object incident or ticket 1630. In some implementations, the Shared-Control Session Manager 1640 may establish a shared-control session between the human operator 1610 and the AI Agent 1620 using a control token, turn-taking, an override, session ownership, or a scoped action certificate that constrains a portion of a local or remote session under agent control. For example, the Shared-Control Session Manager 1640 may use the control token to identify which participant may act during a session interval, use turn-taking to sequence control between the human operator 1610 and the AI Agent 1620, use the override to allow the human operator 1610 to pause, reroute, rollback, or otherwise interrupt agent control, and use session ownership to determine whether a local or remote session, window, application, UI region, action class, or transition is under human control, agent control, observer-only mode, or approval-required control.

The Shared-Control Session Manager 1640 may provide a controlled action, control-state record, shared-control session state, or ticket-bound execution request to the Environment-Class Router 1650. The Environment-Class Router 1650 may apply an environment-class routing rule to route the contemplated action to a sandbox class, a staging class, a production class, a replay class, or another authorized environment class. In some implementations, the Environment-Class Router 1650 may produce a transform, delay, reroute, queue, require-approval, require-credential-refresh, require-checkpoint, require-fusion-analysis, or require-human-shared-control outcome based on an action class, a risk class, an environment class request, a semantic-delta envelope, a ticket or case reference, a derivation-graph mutation, a semantic-delta classification, a digest mismatch, a policy snapshot, a checkpoint state, or a root-cause hypothesis.

The Environment-Class Router 1650 may route a contemplated production action to a sandbox class or replay class when hidden-state uncertainty, stale derivation influence, environment drift, or another failure signal indicates that direct execution is to be restricted. Conversely, the Environment-Class Router 1650 may promote a previously sandboxed action to the production class when checkpoint state, the semantic-delta envelope, the policy snapshot, and a derivation digest remain valid. The staging class may be used to validate an action before the action is permitted to affect a production environment, and the replay class may be used to replay-verify a proposed action, recompute at least one digest, validate at least one signature, validate a nonce as being non-reused, or compare an actual semantic delta to an approved semantic-delta envelope.

The Bounded Execution and Ticket Update 1660 may perform the routed action under a signed authority artifact, signed action authority certificate, scoped action certificate, just-in-time scoped credential, scoped execution token, semantic-delta constraint, or other authority-plane constraint. In some implementations, the Bounded Execution and Ticket Update 1660 may suppress execution when validation fails, execute the proposed action when validation succeeds, compute an actual semantic delta associated with execution of the proposed action, compare the actual semantic delta to an approved semantic-delta envelope, and initiate a containment action when the actual semantic delta exceeds the approved semantic-delta envelope. The Bounded Execution and Ticket Update 1660 may also synchronize one or more execution events, evidence records, remediation records, replay bundles, checkpoint token references, semantic-delta reports, or ticket comments with the ITSM Object incident or ticket 1630 so that ticketing logic participates in deterministic control of the shared-control remediation workflow.

In some embodiments, an action-level policy orchestration service receives contemplated actions and produces one or more outcomes selected from allow, deny, transform, delay, reroute, queue, require-approval, require-credential-refresh, require-checkpoint, require-fusion-analysis, or require-human-shared-control outcomes. Each contemplated action may be represented by a canonical action descriptor, an action class, a risk class, an environment class request, an optional semantic-delta envelope, an optional ticket or case reference, and one or more evidence or derivation references. The policy service may therefore operate on structured machine-readable action records rather than free-form prompts.

A queue subsystem may maintain one or more ApprovalQueueRecords or PolicyQueueRecords. A queue record may identify a contemplated action, a queue state, a queue priority, a waiting condition, a timeout, a maximum dwell time, an escalation path, and one or more approval or policy prerequisites. Queue states may include pending, delayed, blocked, transformed, rerouted, escalated, expired, approved, executed, or canceled. Queue priority may depend on action class, policy criticality, ticket severity, root-cause ranking, or drift proximity. Queue orchestration may therefore defer execution without losing deterministic lineage.

Transform and reroute outcomes may modify a contemplated action before execution. A transform outcome may narrow parameters, redact or mask arguments, substitute a lower-risk connector path, require additional verifier steps, or replace a direct production action with a sandbox-safe variant. A reroute outcome may move execution between browser, desktop, API, connector, command-line, mobile, sandbox, staging, pre-production, production, replay, or forensic classes. A delay outcome may hold the action in a queue until a checkpoint token, credential refresh, policy refresh, or human approval arrives. In some embodiments, one or more transform, delay, reroute, or queue outcomes are selected responsive to a derivation-graph mutation, a semantic-delta classification, an environment-class routing rule, or a digest mismatch detected before execution.

Environment-class routing may be policy driven and root-cause aware. A contemplated production action may be rerouted to a sandbox or replay environment if a ranked root-cause hypothesis indicates hidden-state uncertainty or stale derivation influence. Conversely, a previously sandboxed action may be promoted to production if checkpoint state, semantic-delta envelope, policy snapshot, and derivation digest all remain valid. The policy service therefore cooperates with the authority-plane certificate machinery and the checkpoint-recovery machinery.

### Jit Scoped Credentials, Secret Redaction, and Itsm-Bound Execution

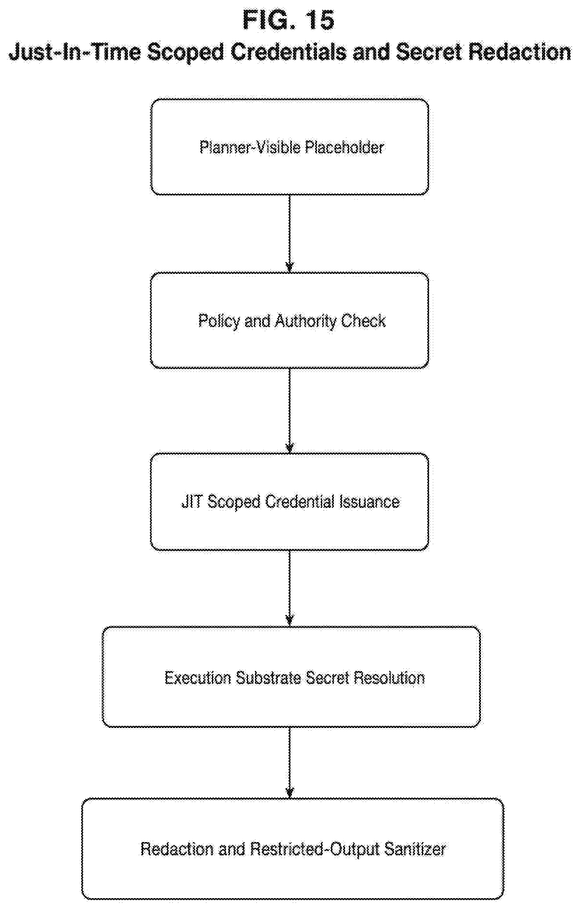

FIG. 15 illustrates an example of a just-in-time scoped credential issuance and secret-redaction pipeline 1500 in accordance with aspects of the present disclosure. For example, the pipeline 1500 may be configured to issue a just-in-time scoped credential or scoped execution token bound to a signed authority artifact and to resolve the just-in-time scoped credential or scoped execution token only inside a non-model execution substrate while masking or redacting secret-derived output before storing the secret-derived output in memory, logs, prompts, or ticket comments. In some implementations, the pipeline 1500 may include a planner-visible placeholder 1510, a policy and authority check 1520, a JIT scoped credential issuance 1530, an execution substrate secret resolution 1540, and a redaction and restricted-output sanitizer 1550.

The planner-visible placeholder 1510 may be configured to represent a secret, credential, or other restricted value without exposing a raw secret value to model-visible context. In some implementations, a planner-visible action record may carry placeholder handles, opaque handles, or a secret placeholder reference so that a planner, orchestrator, autonomous artificial intelligence system, or model can refer to a required credential without receiving the credential itself. The planner-visible placeholder 1510 may accordingly allow a proposed action to be planned or reviewed while withholding raw secret values from prompts, intermediate model messages, memory, graph-memory records, evidence blocks, exported reports, logs, ticket comments, or other model-visible context.

The policy and authority check 1520 may be performed after the planner-visible placeholder 1510 is received or identified. The policy and authority check 1520 may determine whether the proposed action, the requested credential scope, and the requested execution context satisfy applicable policy and authority conditions before credential materialization. In some implementations, the policy and authority check 1520 may evaluate a signed authority artifact, a certificate identifier, a resource scope, an action class, an expiration time, a nonce, a semantic-delta envelope, an environment class, a remote-session identifier, an ITSM ticket identifier, a revocation status, or a queue timeout. The policy and authority check 1520 may suppress or withhold credential issuance when the applicable policy or authority conditions are not satisfied.

The JIT scoped credential issuance 1530 may occur when the policy and authority check 1520 succeeds. The JIT scoped credential issuance 1530 may issue a just-in-time scoped credential or scoped execution token that is limited by time, scope, action, target, environment, privilege, semantic-delta constraint, or policy condition. In some implementations, the just-in-time scoped credential or scoped execution token may be bound to the signed authority artifact so that the credential is tied to action-specific authority and may be invalidated when drift, revocation, or queue timeout occurs. The JIT scoped credential issuance 1530 may be implemented by a credential service that produces credentials narrower than baseline automation credentials.

The execution substrate secret resolution 1540 may be performed after the JIT scoped credential issuance 1530 and may resolve the just-in-time scoped credential, scoped execution token, placeholder handle, opaque handle, or secret placeholder reference only inside a non-model execution substrate. The non-model execution substrate may include a signed process, secure enclave, container, browser automation harness, mobile sandbox, connector boundary, or other policy-approved runtime boundary outside model-visible context. In some implementations, a secret broker may resolve the placeholder to a raw secret value inside the non-model execution substrate while withholding the raw secret value from the planner, orchestrator, autonomous artificial intelligence system, or model. The execution substrate secret resolution 1540 may also generate secret-use metadata, such as a secret identifier, broker identifier, use timestamp, action identifier, environment identifier, version, or secret-use digest, without disclosing or storing the raw secret value in model-visible context.

The redaction and restricted-output sanitizer 1550 may receive output or provenance associated with an execution that consumed a secret and may prevent secret values or secret-derived restricted content from entering model-visible context absent authorization. In some implementations, the redaction and restricted-output sanitizer 1550 may mask, remove, digest, restrict, or quarantine secret-derived output before the secret-derived output is stored in memory, logs, prompts, ticket comments, evidence records, exported reports, or ITSM comments. The redaction and restricted-output sanitizer 1550 may apply a restricted-output label, dataflow tag, or restricted-output flag to content derived from execution that consumed the secret. The restricted-output label may persist until an authorized declassification or transformation step occurs, thereby containing secret influence across model-visible and non-model-visible boundaries.

In some embodiments, a credential service issues just-in-time scoped credentials or scoped execution tokens only after policy and authority checks succeed. A just-in-time token may be bound to one or more of a certificate identifier, a resource scope, an action class, an expiration time, a nonce, a semantic-delta envelope, an environment class, a remote-session identifier, or an ITSM ticket identifier. The token may be materialized only inside an execution substrate or connector boundary that is outside model-visible context. This differs from generic secret vault usage because the token is tied to action-specific authority and may be invalidated when drift, revocation, or queue timeout occurs.

Secret redaction may occur at several layers. A planner-visible action record may carry only placeholder handles. An execution substrate may resolve the handles to JIT credentials. A provenance system may store only digests, opaque handles, or masked forms. A post-execution output sanitizer may prevent secret values or secret-derived restricted content from entering memory, prompt context, human-readable logs, or ticket comments unless an explicit policy permits release. In some embodiments, a redaction pipeline stores field-level lineage so that any output containing secret-derived values may be automatically masked, removed, or quarantined.

ITSM integration may also be first class. An ITSM object may represent a ticket, incident, problem, request, case, or escalation record with lifecycle fields including create, update, assign, reassign, queue, escalate, pause, close, reopen, breach, or satisfaction states. In some embodiments, contemplated actions may be bound to ITSM object states so that execution cannot proceed unless a ticket is in a required state. In other embodiments, policy or root-cause results may automatically update the ITSM object, create a child remediation task, or attach a replay bundle, checkpoint token reference, or semantic-delta report. This allows ticketing logic to participate in deterministic control rather than acting merely as an external side effect.

### Shared-Control Remediation and Specialized Supervisor-Coordinated Agents

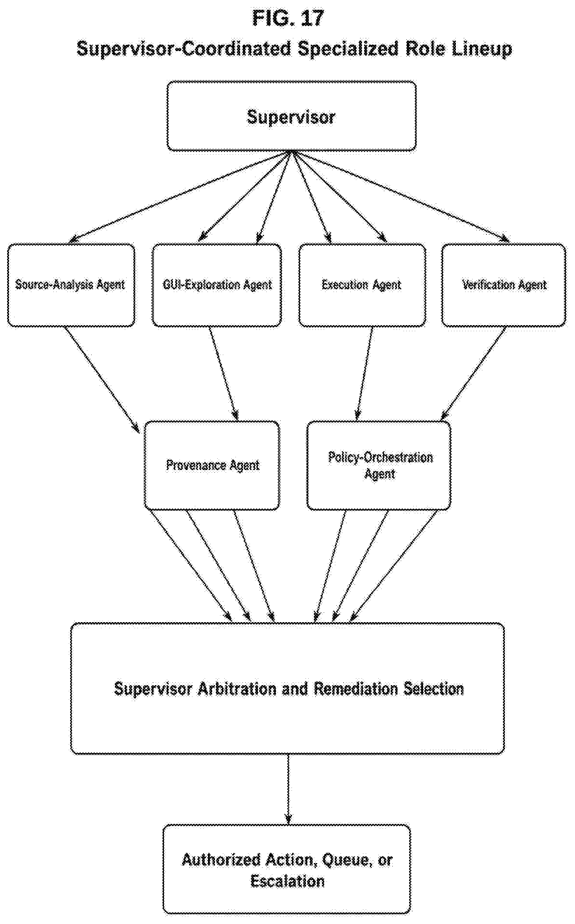

FIG. 17 illustrates an example of a supervisor-coordinated specialized role lineup 1700 in accordance with aspects of the present disclosure. For example, the supervisor-coordinated specialized role lineup 1700 may be configured to coordinate a proposed action associated with an autonomous artificial intelligence system using specialized agents that generate, verify, preserve, and route evidence before the proposed action is authorized, queued, or escalated. In some implementations, the supervisor-coordinated specialized role lineup 1700 may include a Supervisor 1710, a Source-Analysis Agent 1720, a GUI-Exploration Agent 1730, an Execution Agent 1740, a Verification Agent 1750, a Provenance Agent 1760, a Policy-Orchestration Agent 1770, Supervisor Arbitration and Remediation Selection 1780, and an Authorized Action, Queue, or Escalation 1790.

The Supervisor 1710 may be configured to coordinate the Source-Analysis Agent 1720, the GUI-Exploration Agent 1730, the Execution Agent 1740, the Verification Agent 1750, the Provenance Agent 1760, and the Policy-Orchestration Agent 1770. As shown, the Supervisor 1710 may provide control, assignment, invocation, scoring, ballot, or arbitration inputs to one or more of the specialized agents. In some implementations, the Supervisor 1710 may receive a proposed action, assign role-specific analysis to the specialized agents, and evaluate role outputs before permitting execution, requiring additional verification, invoking graph-fusion, invoking a root-cause engine, or selecting a remediation action.

The Source-Analysis Agent 1720 may derive source-side workflow structure from code, scripts, configuration, object-model evidence, dependency manifests, schema definitions, tests, build artifacts, symbolic traces, or documentation. The GUI-Exploration Agent 1730 may derive GUI-side workflow structure from screenshots, accessibility trees, DOM structures, mobile UI trees, click traces, gesture traces, recorded human sessions, or live remote-session observations. Outputs from the Source-Analysis Agent 1720 and the GUI-Exploration Agent 1730 may be provided to the Provenance Agent 1760 so that source-side evidence and GUI-side evidence are recorded as part of a shared lineage graph, replay bundle, or evidence digest set.

The Execution Agent 1740 may carry out candidate actions under authority control. In some implementations, the Execution Agent 1740 may execute the proposed action only after a signed action authority certificate, scoped action certificate, just-in-time scoped credential, scoped execution token, semantic-delta constraint, or other authority-plane constraint has been validated. The Verification Agent 1750 may assess semantic-delta compliance, expected-state satisfaction, precondition results, postcondition results, checkpoint state, verifier sufficiency, or containment conditions associated with the proposed action. As shown, the Execution Agent 1740 and the Verification Agent 1750 may provide outputs to the Policy-Orchestration Agent 1770 for policy-governed routing or decisioning.

The Provenance Agent 1760 may maintain lineage, replay bundles, evidence digests, control-transition provenance, channel annotations, certificate identifiers, checkpoint token identifiers, or switch lineage for the proposed action. The Policy-Orchestration Agent 1770 may produce one or more outcomes selected from allow, deny, transform, delay, reroute, queue, require-approval, require-credential-refresh, require-checkpoint, require-fusion-analysis, or require-human-shared-control outcomes. In some implementations, the Policy-Orchestration Agent 1770 may apply action-level, edge-level, segment-level, or workflow-level policy to determine whether a contemplated action is to proceed, be transformed into a lower-risk surrogate, be routed to a sandbox class, staging class, pre-production class, production class, replay class, or forensic class, or be placed into a policy queue.

The Supervisor Arbitration and Remediation Selection 1780 may receive role outputs from the Provenance Agent 1760 and the Policy-Orchestration Agent 1770. In some implementations, the Supervisor Arbitration and Remediation Selection 1780 may combine source-side workflow structure, GUI-side workflow structure, execution telemetry, semantic-delta results, expected-state results, evidence digests, policy outcomes, checkpoint mismatches, graph-fusion outputs, or root-cause hypotheses to select a remediation action. The Supervisor Arbitration and Remediation Selection 1780 may select rollback, compensating action, queue insertion, delegated sub-capability issuance, human escalation, production denial, or another containment action according to the received role outputs and applicable authority-plane constraints.

The Authorized Action, Queue, or Escalation 1790 may represent an output of the Supervisor Arbitration and Remediation Selection 1780. For example, the Authorized Action, Queue, or Escalation 1790 may include execution of an authorized action when validation succeeds, placement of the proposed action into an ApprovalQueueRecord or PolicyQueueRecord when additional prerequisites remain unsatisfied, or escalation to a higher-priority queue, ITSM object, case-management object, or human operator when policy, verification, provenance, or authority conditions require intervention. In this manner, the supervisor-coordinated specialized role lineup 1700 may coordinate specialized agent outputs while maintaining replayable provenance, policy-governed execution, and bounded remediation selection.

In some embodiments, the system supports shared-control remediation for a local or remote session. A shared-control session may include a human operator, a supervised AI agent, and optionally one or more specialized sub-agents. Control may be exchanged using one or more of a control token, a turn-taking schedule, a cursor or focus lock, a session-ownership flag, or a scoped action certificate. A remote-session takeover may therefore be constrained so that the AI agent only controls specified windows, applications, UI regions, or action classes while the human operator retains override power for excluded areas or higher-risk transitions.

A supervisor may coordinate a specialized role lineup that includes a source-analysis agent, a GUI-exploration agent, an execution agent, a verification agent, a provenance agent, and optionally a policy-orchestration agent, a root-cause agent, or a ticket-synchronization agent. The source-analysis agent may derive source-side workflow structure from code, scripts, configuration, or object-model evidence. The GUI-exploration agent may derive GUI-side workflow structure from screenshots, accessibility trees, DOM structures, mobile UI trees, or live remote-session observations. The execution agent may carry out candidate actions under authority control. The verification agent may assess semantic-delta compliance and expected-state satisfaction. The provenance agent may maintain lineage, replay bundles, and evidence digests. The supervisor may arbitrate among the role outputs or may invoke the root-cause engine or graph-fusion subsystem before allowing execution.

Shared-control embodiments may include operator overrides, forced pause, force-rollback, force-reroute, acknowledgement-required turns, co-sign requirements, or observer-only modes. Competitor variants that rename shared control as co-pilot mode, assisted session mode, handoff mode, collaborative remediation, or guided takeover may still implement the disclosed architecture when they enforce bounded agent control, maintain provenance of control transitions, and tie the permitted control scope to structured authority and session state.

### Input Modalities, Output Modalities, and Execution Channels

Input modalities contemplated by the authority plane include user instructions, scheduled triggers, queue messages, screenshots, page text, documents, chats, emails, connector responses, API responses, database rows, mobile-state captures, model messages, tool outputs, policy objects, and combinations thereof.

Output modalities contemplated by the authority plane include certificates, semantic-delta envelopes, derivation records, replay bundles, revocation notices, containment instructions, rollback actions, approval prompts, policy decisions, and audit reports.

The authority plane is channel-agnostic and may govern browser actions, operating-system-level input actions, application programming interface calls, connector invocations, script execution, mobile gestures, or any mixture thereof.

### Tri-Modal Artifact-Aware Channel Selection, Mid-Workflow Failover, and Shared Provenance Continuity

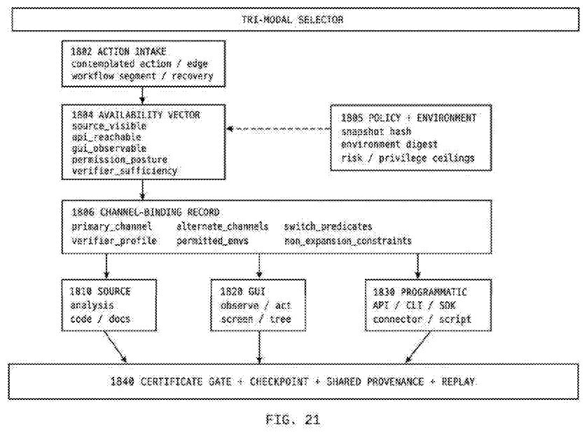

FIG. 21 illustrates an example of a tri-modal selector 2100 for artifact-aware channel selection under certificate-bound control in accordance with aspects of the present disclosure. For example, the tri-modal selector 2100 can be configured to select a source-analysis channel, a GUI-observation or GUI-action channel, or a programmatic execution channel for a contemplated action, workflow segment, recovery branch, or execution-graph edge while preserving certificate gating, checkpointing, shared provenance, and replayability. In some implementations, the tri-modal selector 2100 can include an action intake 2102, an availability vector 2104, a policy and environment input 2105, a channel-binding record 2106, a source channel 2110, a GUI channel 2120, a programmatic channel 2130, and a certificate gate, checkpoint, shared provenance, and replay stage 2140.

The action intake 2102 can be configured to receive a contemplated action, an edge workflow segment, or a recovery branch associated with an autonomous artificial intelligence system. In some implementations, the action intake 2102 can provide the contemplated action, edge workflow segment, or recovery branch to the availability vector 2104 so that the tri-modal selector 2100 can determine which channel or channels are available for analysis, observation, execution, verification, or recovery. The availability vector 2104 can include source_visible, api_reachable, gui_observable, permission_posture, and verifier_sufficiency fields. The source_visible field can indicate whether source code, documentation, configuration, object models, or other source-side artifacts are available for deriving or verifying the contemplated action. The api_reachable field can indicate whether an API, CLI, SDK, connector, script, or other programmatic substrate is reachable. The gui_observable field can indicate whether a rendered screen, DOM structure, accessibility tree, mobile UI tree, or other GUI evidence is available for observation or action. The permission posture field can indicate whether available credentials, delegated authority, scoped execution tokens, or policy permissions permit use of a channel. The verifier_sufficiency field can indicate whether evidence available through a channel is sufficient to satisfy required precondition, postcondition, semantic-delta, policy, or replay checks.

The policy and environment input 2105 can be configured to provide a snapshot hash, an environment digest, and risk or privilege ceilings to the availability vector 2104. In some implementations, the snapshot hash can correspond to a policy snapshot hash associated with a policy state applicable to the contemplated action, and the environment digest can correspond to an environment measurement digest associated with an execution environment for the contemplated action. The risk or privilege ceilings can constrain whether a particular channel can be used, whether a channel can be used for observation but not execution, whether execution is to occur in a sandbox class, staging class, pre-production class, production class, replay class, or forensic class, or whether approval, transformation, delay, reroute, or queue processing is required.

The channel-binding record 2106 can be generated based on the availability vector 2104 and the policy and environment input 2105. The channel-binding record 2106 can encode a primary_channel, alternate_channels, switch_predicates, verifier_profile, permitted_envs, and non_expansion_constraints. In some implementations, the primary_channel can identify a selected channel for the contemplated action, workflow segment, or recovery branch, and the alternate_channels can identify one or more bounded alternate channels that can be used when a switch predicate is satisfied. The switch_predicates can include drift, policy change, permission loss, API unavailability, selector confidence drop, verifier insufficiency, GUI ambiguity, layout change, rate limit, timeout, environment-class change, partial action failure, irreversible side-effect proximity, or human override. The verifier_profile can identify evidence, observations, or checks required for the selected channel to be considered adequate for authorization, execution, verification, or replay. The permitted_envs can identify one or more permitted environment classes, and the non_expansion_constraints can prevent a successor channel or successor certificate from enlarging resource scope, privilege ceiling, environment class, semantic-delta ceiling, execution count, or side-effect budget absent fresh approval or higher-authority authorization.

The source channel 2110 can be configured for analysis of code, documentation, scripts, configuration, dependency manifests, schema definitions, tests, build artifacts, object models, symbolic traces, or other source-side artifacts. The GUI channel 2120 can be configured to observe or act on a screen, GUI tree, DOM snapshot, accessibility tree, rendered application region, mobile UI tree, or local or remote session observation. The programmatic channel 2130 can be configured to perform or support API, CLI, SDK, connector, or script operations. In some implementations, the channel-binding record 2106 can route a first portion of a workflow to one of the source channel 2110, the GUI channel 2120, or the programmatic channel 2130, and can route another portion of the workflow to another channel for verification, confirmation, or execution under the same authority-controlled workflow.

The certificate gate, checkpoint, shared provenance, and replay stage 2140 can receive outputs from the source channel 2110, the GUI channel 2120, and the programmatic channel 2130. In some implementations, the stage 2140 can validate a signed action authority certificate or other signed authority artifact before execution, can issue or validate a verified-state checkpoint token, can record shared provenance across source-analysis steps, GUI-observation or GUI-action steps, and programmatic execution steps, and can support replay verification. The stage 2140 can suppress execution when certificate validation fails, when the current policy snapshot hash or current environment measurement digest does not match authority-bound values, when the actual semantic delta exceeds an approved semantic-delta envelope, or when a channel switch would violate the non_expansion_constraints encoded in the channel-binding record 2106. In this manner, the tri-modal selector 2100 can enable mixed-channel workflows while maintaining authorization fidelity, policy-governed channel selection, checkpoint continuity, and replayable cross-channel provenance.

In some embodiments, the authority plane includes an artifact-aware channel selector that operates on contemplated actions, workflow segments, recovery branches, or execution-graph edges and that chooses among at least a source-analysis channel, a GUI-observation or GUI-action channel, and a programmatic execution channel. The selector may output a primary channel and zero or more bounded alternate channels. The source-analysis channel may derive action structure or expected state transitions from source code, scripts, configuration, dependency manifests, schema definitions, tests, build artifacts, object models, symbolic traces, or documentation. The GUI channel may derive action structure or state structure from screenshots, DOM snapshots, accessibility trees, rendered application regions, live browser state, mobile UI trees, or local or remote session observations. The programmatic channel may carry out application programming interface calls, connector invocations, CLI commands, scripts, SDK calls, database operations, or other machine-addressable operations.

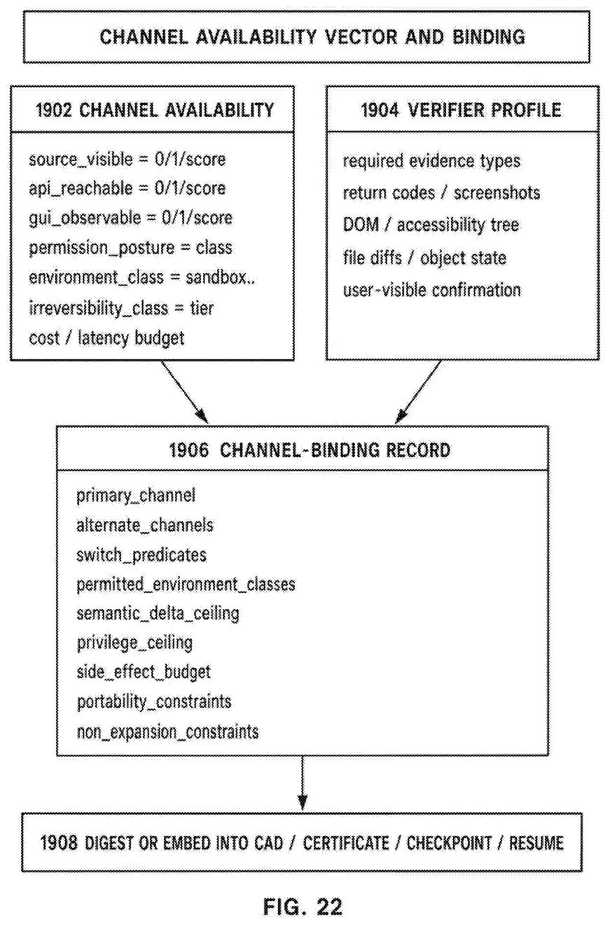

FIG. 22 illustrates an example channel availability vector and binding arrangement for generating a channel-binding record in accordance with aspects of the present disclosure. For example, the arrangement can be configured to evaluate available execution or analysis channels for a contemplated action, workflow segment, recovery branch, or graph edge associated with an autonomous artificial intelligence system and to bind resulting channel constraints into authority-controlled artifacts. In some implementations, the arrangement may include a channel availability 2202, a verifier profile 2204, a channel-binding record 2206, and a digest or embed into CAD/certificate/checkpoint/resume 2208.

The channel availability 2202 can be configured to represent whether, and under what constraints, one or more execution or analysis channels are available for the contemplated action, workflow segment, recovery branch, or graph edge. In some implementations, the channel availability 2202 may include source_visible, api_reachable, and gui_observable fields that indicate, respectively, whether source-side artifacts are available, whether an API, connector, CLI, SDK, script, or other programmatic substrate is reachable, and whether a rendered screen, DOM structure, accessibility tree, mobile UI tree, or other GUI evidence is observable. The channel availability 2202 may further include a permission posture field indicating a permission class, an environment_class field indicating a sandbox class, staging class, pre-production class, production class, replay class, forensic class, or other environment class, an irreversibility_class field indicating an irreversibility tier, and a cost or latency budget.

The verifier profile 2204 can be configured to specify evidence, observations, or checks required for a channel to be considered adequate for authorization, execution, verification, or replay. In some implementations, the verifier profile 2204 may identify required evidence types including return codes, screenshots, DOM or accessibility-tree evidence, file diffs, object state, and user-visible confirmation. The verifier profile 2204 may be used to determine that a selected channel is sufficient to satisfy required precondition, postcondition, semantic-delta, policy, or replay checks before the proposed action is executed or before execution is allowed to continue through a successor channel.

The channel availability 2202 and the verifier profile 2204 can provide inputs to the channel-binding record 2206. In some implementations, the channel-binding record 2206 can identify a primary_channel and one or more alternate_channels for the contemplated action, workflow segment, recovery branch, or graph edge. The channel-binding record 2206 can also encode switch_predicates that indicate conditions under which execution, observation, verification, or recovery may migrate from one channel to another. The switch_predicates may include drift, policy change, permission loss, API unavailability, selector confidence drop, verifier insufficiency, GUI ambiguity, layout change, rate limit, timeout, environment-class change, partial action failure, irreversible side-effect proximity, or human override.

The channel-binding record 2206 may further encode permitted_environment_classes, a semantic_delta_ceiling, a privilege_ceiling, a side_effect_budget, portability_constraints, and non_expansion_constraints. The permitted_environment_classes can constrain use of a channel to one or more authorized environment classes. The semantic_delta_ceiling can constrain the magnitude or class of a permitted actual semantic delta relative to an approved semantic-delta envelope. The privilege_ceiling and the side_effect_budget can prevent a selected or successor channel from exceeding authorized privilege or side-effect limits. The portability_constraints can indicate whether state carried from one channel to another is nonportable, partially portable, fully portable, or approval-required portable. The non_expansion_constraints can prevent a successor channel or successor certificate from enlarging resource scope, privilege ceiling, environment class, semantic-delta ceiling, execution count, or side-effect budget absent fresh approval or higher-authority authorization.

The digest or embed into CAD/certificate/checkpoint/resume 2208 can be configured to bind the channel-binding record 2206, or a digest thereof, into one or more authority-controlled artifacts. In some implementations, the channel-binding record 2206 can be deterministically serialized and embedded into a canonical action descriptor, a signed action authority certificate, a verified-state checkpoint token, a resume package, or combinations thereof. Binding the channel-binding record 2206 in this manner can allow validation of the signed action authority certificate before execution, suppression of execution when channel constraints are not satisfied, and replay verification that cross-channel execution remained within approved semantic bounds.

In some implementations, the arrangement of FIG. 22 can support mixed-channel workflows in which a source-analysis channel, a GUI-observation or GUI-action channel, and a programmatic execution channel are used for different portions of a workflow under common authority control. For example, a first channel may be selected as the primary_channel when the channel availability 2202 and the verifier profile 2204 indicate sufficient evidence and permission, while an alternate channel may be used only when a switch_predicate is satisfied and the non_expansion_constraints remain satisfied. In this manner, the channel availability 2202, the verifier profile 2204, the channel-binding record 2206, and the digest or embed into CAD/certificate/checkpoint/resume 2208 can preserve authorization fidelity, checkpoint continuity, and replayable cross-channel provenance.

The selector may compute a channel availability vector comprising source-visibility indicators, API or connector reachability indicators, GUI observability indicators, permission indicators, environment-class indicators, verifier-sufficiency indicators, latency or cost indicators, irreversibility indicators, and policy indicators. Each indicator may be binary, categorical, ordinal, scored, thresholded, rule-derived, or combinations thereof. The selector may also compute a channel suitability vector and a switchability vector. A switchability vector may encode whether a contemplated action or workflow segment can lawfully and safely migrate from one channel to another without re-planning, only with reauthorization, or not at all.

A source-visibility indicator may represent whether source code, object definitions, dependency manifests, schema definitions, test artifacts, build artifacts, documentation, or symbolic traces are available and trustworthy enough to derive or verify a contemplated action. A GUI observability indicator may represent whether sufficient rendered evidence exists to localize a target state, confirm a proposed effect, or perform postcondition validation. An API or connector reachability indicator may represent whether an API, connector, CLI, SDK, or script substrate exists and whether credentials, endpoint policy, or environment routing permit use of that substrate.

In some embodiments, the selector does not merely prefer programmatic execution whenever an API exists. Rather, the selector may require verifier sufficiency for a selected channel. For example, a direct API may be available for changing a resource, but the API may not expose a state variable needed to prove that a user-visible downstream effect occurred. In such a case, the selector may require a GUI-observation step before or after the API step. Conversely, GUI execution may be demoted or blocked when policy requires atomicity, row-level audit detail, restricted side-effect envelopes, restricted credential exposure, or machine-verifiable return codes that a programmatic channel can supply more reliably. Likewise, a source-analysis channel may be required before either GUI or programmatic execution when symbolic evidence is needed to derive bounded preconditions, postconditions, or hidden-state hypotheses.

The selector may serialize its decision into a channel-binding record. The channel-binding record may include a primary channel identifier, one or more alternate channel identifiers, one or more switch predicates, a verifier sufficiency profile, one or more required evidence types, a permitted environment-class set, a side-effect budget, a semantic-delta ceiling, a privilege ceiling, one or more portability constraints, and one or more non-expansion constraints. In some embodiments, the channel-binding record or a digest thereof is bound into the canonical action descriptor, the action authority certificate, the resume package, the checkpoint token, or combinations thereof.

A switch predicate may include detection of drift, policy change, permission loss, API unavailability, selector confidence drop, verifier insufficiency, GUI ambiguity, layout change, rate limit, timeout, environment-class change, partial action failure, irreversible side-effect proximity, or human override. A switch predicate may also require issuance of a successor certificate before any subsequent action is released. In some embodiments, switch_predicates are represented as deterministic rules. In other embodiments, switch_predicates are represented as machine-readable predicates evaluated by a verifier or policy engine. In still other embodiments, switch_predicates may be learned, scored, or ranked subject to a certificate-bound acceptability threshold.

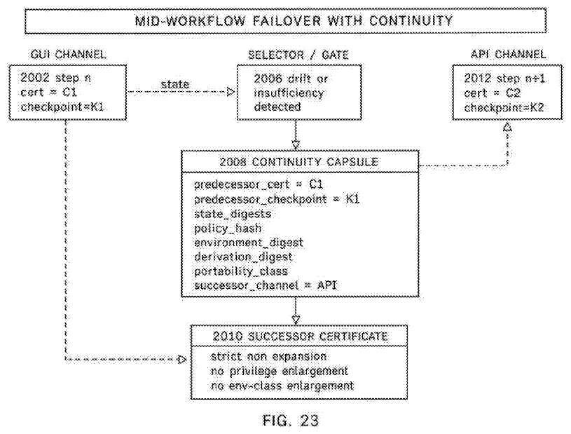

FIG. 23 illustrates an example of a mid-workflow failover sequence 2300 with continuity in accordance with aspects of the present disclosure. For example, the mid-workflow failover sequence 2300 may be configured to migrate execution from a GUI channel to an API channel when drift, verifier insufficiency, or another switch predicate is detected while preserving checkpoint continuity, authorization fidelity, and replayable provenance. In some implementations, the mid-workflow failover sequence 2300 may include a step n 2302, a drift or insufficiency detected step 2306, a continuity capsule 2308, a successor certificate 2310, and a step n+1 2312.

The step n 2302 can be associated with execution in the GUI channel. In some implementations, the step n 2302 can be performed under a certificate C1 and can be associated with a checkpoint K1. The certificate C1 may correspond to a predecessor certificate or other predecessor authority artifact for the current workflow segment, and the checkpoint K1 may correspond to a verified-state checkpoint token or checkpoint identifier for a state reached before failover. State from the step n 2302 can be provided to a selector or gate that evaluates whether execution may continue in the current channel or is to be migrated to a different channel.

The drift or insufficiency detected step 2306 can be associated with a selector or gate configured to detect a condition that supports mid-workflow failover. In some implementations, the drift or insufficiency detected step 2306 may detect drift, policy change, permission loss, API unavailability, selector confidence drop, verifier insufficiency, GUI ambiguity, layout change, rate limit, timeout, environment-class change, partial action failure, irreversible side-effect proximity, human override, or another switch predicate. Responsive to detection of drift or insufficiency, the selector or gate can initiate creation of the continuity capsule 2308 before execution is continued in the API channel.

The continuity capsule 2308 can be a machine-readable package generated when execution is resumed, migrated, rerouted, or otherwise continued across a channel boundary. In some implementations, the continuity capsule 2308 can include a predecessor_cert field identifying the certificate C1, a predecessor_checkpoint field identifying the checkpoint K1, state_digests, a policy_hash, an environment_digest, a derivation_digest, a portability_class, and a successor_channel field identifying the API channel. The state_digests can represent one or more pre-switch or post-switch states. The policy_hash can represent a policy snapshot hash applicable to the workflow segment, the environment_digest can represent an environment measurement digest associated with an execution environment, and the derivation_digest can represent a derivation-graph digest associated with the proposed action or workflow segment. The portability_class can indicate whether the verified state can be carried from the GUI channel to the API channel without semantic loss, within a bounded equivalence band, or only after approval.

The successor certificate 2310 can be generated based on the continuity capsule 2308 and can constrain continued execution after failover. In some implementations, the successor certificate 2310 can enforce strict non-expansion, no privilege enlargement, and no environment-class enlargement relative to the certificate C1 unless fresh approval or higher-authority authorization is obtained. The successor certificate 2310 can thereby prevent a successor channel or successor certificate from enlarging resource scope, privilege ceiling, environment class, semantic-delta ceiling, execution count, or side-effect budget absent authorization.

The step n+1 2312 can be associated with execution in the API channel after issuance or validation of the successor certificate 2310. In some implementations, the step n+1 2312 can be performed under a certificate C2 and can be associated with a checkpoint K2. The certificate C2 may correspond to the successor certificate 2310, and the checkpoint K2 may correspond to a later verified-state checkpoint token or checkpoint identifier. In this manner, the mid-workflow failover sequence 2300 can continue execution in a different channel while linking the certificate C1, the checkpoint K1, the continuity capsule 2308, the certificate C2, and the checkpoint K2 for later replay verification and provenance continuity.

Mid-workflow failover may be performed only under continuity control. In some embodiments, when a switch predicate is satisfied, the system creates a continuity capsule that links a predecessor certificate identifier, a verified-state checkpoint token identifier, one or more pre-switch and post-switch state digests, a policy snapshot hash, an environment measurement digest, a derivation-graph digest, one or more unresolved obligations, and a proposed successor channel. The continuity capsule may also include a portability score or portability class that indicates whether the verified state can be carried from one channel to another without semantic loss, within a bounded equivalence band, or only after approval.

Successor-certificate issuance may enforce strict non-expansion. In some embodiments, a successor certificate generated after a channel switch cannot enlarge resource scope, privilege ceiling, environment class, semantic-delta ceiling, execution count, or side-effect budget relative to the predecessor certificate unless a fresh approval or higher-authority certificate is obtained. This constraint hardens failover against disguised privilege escalation and prevents a system from using a low-risk observation channel to bootstrap into an unauthorized high-impact programmatic channel. In some embodiments, the predecessor certificate is suspended, retired, or marked as consumed once the successor certificate becomes active.

A checkpoint token may be channel-neutral or channel-scoped. A channel-neutral checkpoint token may authorize resume in a different channel if a verifier determines that the carried-forward state is semantically equivalent or within a permitted equivalence band. A channel-scoped checkpoint token may require resume in the same channel unless a continuity capsule and successor certificate are issued. In some embodiments, checkpoint tokens include a state-portability class selected from nonportable, partially portable, fully portable, or approval-required portable. In some embodiments, the portability class is itself bound into the successor certificate or continuity capsule.

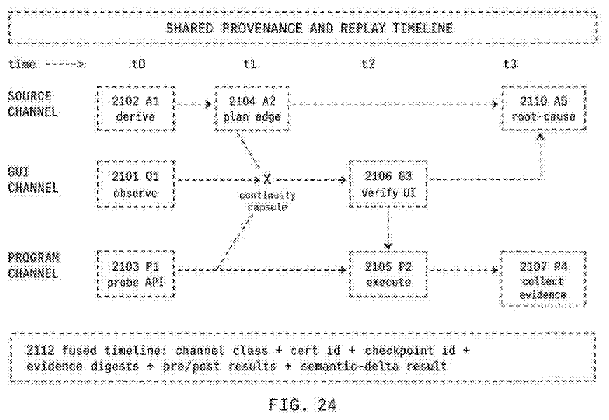

FIG. 24 illustrates an example of a shared provenance and replay timeline configured to preserve replayable cross-channel provenance across a source channel, a GUI channel, and a programmatic channel in accordance with aspects of the present disclosure. For example, FIG. 24 may represent an embodiment in which source-derived, GUI-derived, and programmatic steps are recorded in a fused timeline and replay graph so that later replay verification can determine whether execution remained within approved semantic bounds and did not expand scope, privilege, environment class, or side-effect budget without reauthorization. In some implementations, the shared provenance and replay timeline may include an A1 derive step 2402 in the source channel, an A2 plan edge step 2404 in the source channel, an A5 root-cause step 2410 in the source channel, an O1 observe step 2401 in the GUI channel, a G3 verify UI step 2406 in the GUI channel, a P1 probe API step 2403 in the programmatic channel, a P2 execute step 2405 in the programmatic channel, a P4 collect evidence step 2407 in the programmatic channel, and a fused timeline 2412.

The A1 derive step 2402 may represent a source-analysis-channel operation that derives action structure, expected state transitions, preconditions, postconditions, or workflow edges from source artifacts, scripts, configuration, dependency manifests, schema definitions, tests, build artifacts, object models, symbolic traces, or documentation. The A2 plan edge step 2404 may represent a planned workflow edge generated from the derived source-side information. As shown, the A1 derive step 2402 can provide source-channel evidence to the A2 plan edge step 2404, and the A2 plan edge step 2404 can be associated with a later source-channel relationship to the A5 root-cause step 2410. In some implementations, the A2 plan edge step 2404 may be bound, directly or indirectly, to a channel-binding record, a signed action authority certificate, a verified-state checkpoint token, or a successor certificate so that the planned edge remains subject to one or more switch_predicates, a verifier sufficiency profile, a permitted environment-class set, a semantic-delta ceiling, a side-effect budget, a privilege ceiling, or one or more non-expansion constraints.

The O1 observe step 2401 may represent a GUI-observation or GUI-action channel operation that observes a rendered screen, DOM structure, accessibility tree, mobile UI tree, local session state, remote session state, or other GUI evidence. The G3 verify UI step 2406 may represent a verification operation that confirms a user-visible state, a postcondition, an absence of an error condition, or another GUI-derived verification result. As shown, the O1 observe step 2401 can feed a continuity capsule, and the continuity capsule can feed the G3 verify UI step 2406. The G3 verify UI step 2406 may further provide verification evidence to the P2 execute step 2405 and may provide cross-channel evidence toward the A5 root-cause step 2410. In this manner, the GUI channel may contribute evidence used to verify programmatic execution, explain a graph-fusion mismatch, or support root-cause hypotheses.

The P1 probe API step 2403 may represent a programmatic execution channel operation that probes an API, connector, CLI, SDK, script, database operation, or other machine-addressable substrate before execution. The P2 execute step 2405 may represent a programmatic operation executed under certificate-bound control, and the P4 collect evidence step 2407 may represent collection of evidence records, execution telemetry, response digests, object state, file diffs, return codes, or other replay-verification material. As shown, the P1 probe API step 2403 can provide programmatic-channel evidence to the P2 execute step 2405, and the P2 execute step 2405 can provide execution results to the P4 collect evidence step 2407. The P2 execute step 2405 may also receive verification input from the G 3 verify UI step 2406 so that execution and verification can be correlated across channels.

The continuity capsule shown at the cross-channel intersection may link source-channel, GUI-channel, and programmatic-channel evidence during migration, rerouting, recovery, or replay. In some implementations, the continuity capsule may link a predecessor certificate identifier, a verified-state checkpoint token identifier, one or more state digests, a policy snapshot hash, an environment measurement digest, a derivation-graph digest, one or more unresolved obligations, and a proposed successor channel. The continuity capsule may also include a portability score or portability class indicating whether a verified state can be carried from one channel to another without semantic loss, within a bounded equivalence band, or only after approval. By linking the A2 plan edge step 2404, the O1 observe step 2401, and the P1 probe API step 2403 to the continuity capsule, the system can preserve replayability and authorization fidelity when execution crosses channel boundaries.

The A5 root-cause step 2410 may represent a source-channel root-cause operation that receives provenance or verification evidence from the A2 plan edge step 2404 and the G3 verify UI step 2406. In some implementations, the A5 root-cause step 2410 may generate or support root-cause hypotheses based on semantic-delta anomalies, graph-fusion outputs, execution telemetry, checkpoint mismatches, policy-queue outcomes, environment drift, verifier failures, or channel inconsistencies. The A5 root-cause step 2410 may use the fused cross-channel timeline to explain whether a failure condition resulted from stale state, hidden GUI state, an incorrect policy snapshot, derivation contamination, credential scope mismatch, an environment mismatch, a missing prerequisite action, or another supported failure signal.

The fused timeline 2412 may be a machine-readable lineage record that stores, for one or more recorded steps, a channel class, a certificate identifier, a checkpoint identifier, evidence digests, pre-execution and post-execution results, and a semantic-delta result. The fused timeline 2412 may be used by a replay subsystem to recompute one or more digests, validate one or more signatures, validate nonce distinctness, compare an actual semantic delta to an approved semantic-delta envelope, and reconstruct lineage among a proposed action, an authority artifact, an execution result, and an evidence bundle. Accordingly, the shared provenance and replay timeline of FIG. 24 can permit after-the-fact verification of mixed-channel workflows without losing audit continuity across source-analysis, GUI-observation or GUI-action, and programmatic execution channels.

Shared provenance may be preserved across channel switches. The provenance subsystem may maintain a fused timeline or lineage graph in which each step is annotated with a channel class, certificate identifier, checkpoint token identifier, evidence digest set, precondition result, postcondition result, semantic-delta result, verifier identity, and switch lineage where applicable. The replay subsystem may then verify a workflow that began with source analysis, continued with programmatic execution, and ended with GUI confirmation, or any other cross-channel combination, without losing audit continuity.

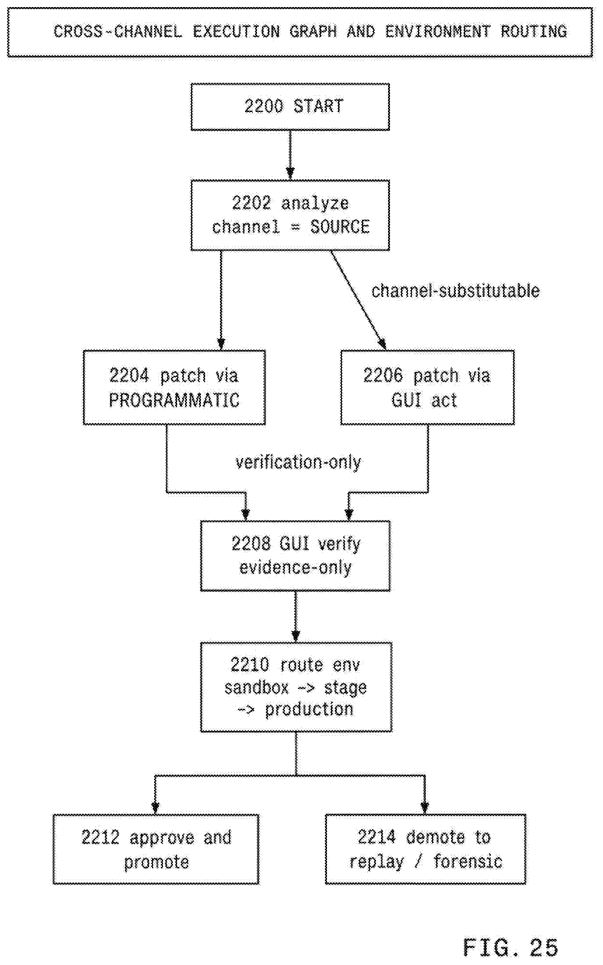

FIG. 25 illustrates an example of a cross-channel execution graph and environment routing flow 2500 for coordinating channel-substitutable execution, verification-only evidence collection, and environment-class promotion paths in accordance with aspects of the present disclosure. For example, the cross-channel execution graph and environment routing flow 2500 may be configured for routing a proposed action associated with an autonomous artificial intelligence system through a source-analysis channel, a programmatic execution channel, and a GUI-observation or GUI-action channel while preserving policy-governed channel selection, verifier sufficiency, and replayable cross-channel provenance. In some implementations, the flow 2500 may begin at a start step 2501 and proceed to an analyze channel=SOURCE step 2502, in which source-side artifacts may be analyzed to derive a patch sequence, expected preconditions, expected postconditions, or an execution-graph edge for the proposed action.

The analyze channel=SOURCE step 2502 may route the proposed action to a patch via PROGRAMMATIC step 2504 or to a patch via GUI act step 2506. The path from the analyze channel =SOURCE step 2502 to the patch via GUI act step 2506 may represent a channel-substitutable edge when more than one lawful channel can achieve substantially the same semantic effect subject to switch predicates, verifier requirements, permitted environment classes, and non-expansion constraints. The patch via PROGRAMMATIC step 2504 may perform or support an API, CLI, SDK, connector, script, database operation, or other machine-addressable operation under a signed authority artifact. The patch via GUI act step 2506 may perform or support a screen, GUI tree, DOM snapshot, accessibility tree, rendered application region, mobile UI tree, or local or remote session operation when GUI-based action is permitted by policy and authority state.

The patch via PROGRAMMATIC step 2504 and the patch via GUI act step 2506 may feed a GUI verify evidence-only step 2508. The GUI verify evidence-only step 2508 may represent a verification-only edge that uses GUI-derived evidence for confirmation, without allowing the GUI channel to perform an underlying state-changing act for that edge. In some implementations, the GUI verify evidence-only step 2508 may confirm user-visible completion, absence of an error banner, satisfaction of a postcondition, or another verifier-sufficiency condition and may produce evidence digests or other evidence records for an evidence bundle, a fused timeline, or a replay bundle.

The GUI verify evidence-only step 2508 may provide verification results to a route environment sandbox->stage->production step 2510. The route environment sandbox->stage->production step 2510 may apply an environment-class routing rule that routes execution or validation from a sandbox class to a staging class and then to a production class, or to another permitted environment class, according to policy, risk, authority state, and semantic-delta classification. In some implementations, a policy orchestration service may produce allow, deny, transform, delay, reroute, queue, or require-approval outcomes before permitting promotion to a higher environment class.

The route environment sandbox->stage->production step 2510 may result in an approve and promote step 2512 or a demote to replay/forensic step 2514. The approve and promote step 2512 may occur after a verifier, policy engine, or human approver confirms that a semantic-delta envelope remains within an approved bound and that any required signed authority artifact remains valid. The demote to replay/forensic step 2514 may occur when drift, elevated risk, verifier insufficiency, a digest mismatch, a semantic-delta classification, or another switch predicate indicates that continued promotion is to be suppressed. In this manner, the flow 2500 can permit mixed-channel workflows while constraining execution by environment class, authority state, verifier evidence, and replayable provenance.

In some embodiments, the source-analysis channel, GUI channel, and programmatic channel each emit partial workflow structures that are aligned into a shared cross-channel execution graph. The shared graph may include channel-substitutable edges, channel-exclusive edges, evidence-only edges, and verification-only edges. A channel-substitutable edge may identify more than one lawful channel by which substantially the same semantic effect can be achieved, together with conditions under which substitution is allowed. A verification-only edge may require a channel solely for confirmation, without allowing that channel to perform the underlying state-changing act.

The controller may therefore plan mixed-channel workflows at edge granularity. By way of example, a source-analysis channel may derive a patch sequence and expected preconditions, a programmatic channel may apply the patch or perform a bulk operation under a scoped credential, and a GUI channel may confirm user-visible completion or absence of an error banner. In another example, a GUI channel may discover a hidden state not exposed by documentation, a source-analysis channel may refine the expected transition logic, and a programmatic channel may execute a bounded corrective action. In still another example, a programmatic channel may gather structured telemetry, a source-analysis channel may determine a safe modification envelope, and a GUI channel may confirm that a controlled user-facing effect occurred.

Environment-class routing may be integrated into channel selection and failover. A contemplated action may be first simulated in a sandbox or staging environment through one channel and then promoted to a different channel in a higher environment class only after a verifier, policy engine, or human approver confirms that the semantic-delta envelope remains within an approved bound. In some embodiments, the same action identifier persists across simulation and promotion. In other embodiments, the promotion receives a distinct successor certificate linked by the continuity capsule. In some embodiments, demotion from a production-class channel to a forensic, replay, or observation-only class may occur automatically when a switch predicate indicates drift or elevated risk.

Policy outcomes may operate at action, edge, segment, or workflow scope. The policy engine may permit one channel, deny another, require split-phase execution, require dual execution in which one channel acts and another verifies, transform a contemplated action into a lower-risk surrogate, route a step into an approval queue, or downgrade an environment class. As a non-limiting example, a destructive programmatic action may be blocked in production while a read-only API observation plus GUI evidence collection remains allowed. As another non-limiting example, a GUI-only act may be blocked until source analysis supplies a bounded semantic-delta envelope that the verifier can enforce after execution.

Alternative embodiments may use deterministic rules, a scored policy, a learned selector, a table-driven finite-state machine, a constrained optimization routine, or a hierarchical supervisor to compute the channel decision. In some embodiments, the supervisor receives scores or ballots from specialized agents including a source-analysis agent, a GUI-exploration agent, an execution agent, a verification agent, and a provenance or policy agent. In other embodiments, a single controller computes the decision without exposing agent identity. The disclosure therefore is not limited to any particular control topology.

Competitor implementations may rename the channels as operator mode, coder mode, tool mode, browser mode, connector mode, RPA mode, compiler mode, remote procedure mode, object-model mode, or other names. Competitors may also hide channel selection inside an orchestrator, represent the channel-binding record as metadata in a task object, or treat a GUI observation step as a service call. The disclosure encompasses such variations where a system computes a bounded channel decision, binds channel constraints to authorization state, preserves continuity across a channel switch, and maintains replayable cross-channel provenance.

In some embodiments, channel selection occurs per action. In some embodiments, channel selection occurs per workflow segment. In some embodiments, channel selection occurs per graph edge, per object class, per environment class, per data sensitivity tier, per risk class, per target application, or per remediation phase. Some embodiments may omit one of the three primary channels, may include additional channels such as direct database mutation or human-cosigned operation, or may treat a no-op observation path as a separate verification channel. The disclosure is therefore not limited to exactly three channels even though tri-modal embodiments are expressly contemplated.

The disclosed architecture improves robustness over systems that merely prefer an API whenever available or merely alternate between GUI and scripting ad hoc. By binding channel selection, switch predicates, verifier sufficiency, checkpoint portability, continuity capsules, and non-expansion constraints into authority-controlled artifacts, the system constrains cross-channel automation in a way that remains auditable, replayable, and policy-governed even when execution migrates mid-workflow.

### Cybersecurity Vulnerability Knowledge Model and Exposure Graph

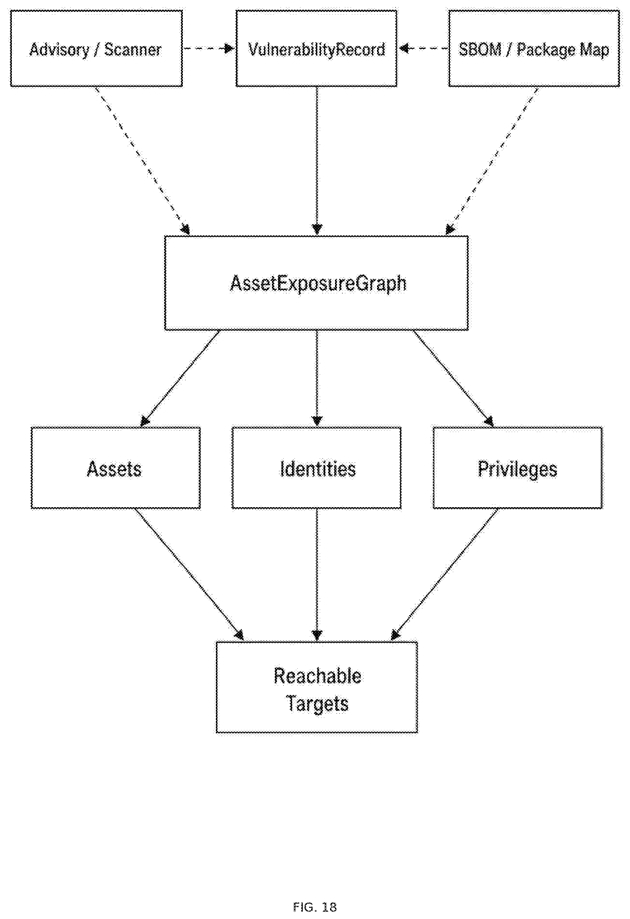

FIG. 18 illustrates an example of a vulnerability exposure graph block diagram configured for constructing an AssetExposureGraph 1840 from vulnerability data and software package context in accordance with aspects of the present disclosure. In some implementations, an advisory/scanner 1810 may provide vulnerability data from one or more advisory sources, scanner outputs, telemetry records, or internal findings. The vulnerability data may be normalized into a VulnerabilityRecord 1820. An SBOM/Package Map 1830 may provide software bill of materials records, package mappings, component fingerprints, version ranges, or vulnerable component information associated with assets in an environment. The VulnerabilityRecord 1820 and the SBOM/Package Map 1830 may be used to construct the AssetExposureGraph 1840, which links assets 1850, identities 1860, privileges 1870, and reachable targets 1880 for exposure-path computation.

In some implementations, the advisory/scanner 1810 may communicate vulnerability observations to the VulnerabilityRecord 1820 and may also provide exposure evidence to the AssetExposureGraph 1840. The VulnerabilityRecord 1820 may include one or more of an advisory identifier, a component fingerprint, a software bill of materials mapping, a version range, exploit-precondition data, exposure evidence digests, a remediation state, a patch state, an environment binding, a confidentiality class, or a confidence score. The SBOM/Package Map 1830 may be associated with the VulnerabilityRecord 1820 to identify vulnerable components and may also be associated with the AssetExposureGraph 1840 to identify packages, services, or dependencies that affect reachability or exposure.

In some implementations, the AssetExposureGraph 1840 may store nodes or edges that link the assets 1850, the identities 1860, the privileges 1870, and the reachable targets 1880. The assets 1850 may include hosts, virtual machines, containers, browser workspaces, mobile devices, application instances, storage buckets, queues, secret scopes, databases, or other execution targets. The identities 1860 may include accounts, roles, credentials, or connector permissions that can affect whether a vulnerable component or asset is reachable. The privileges 1870 may encode role inheritance, delegated authority, credential use, trust relationships, or other authority relationships that affect exposure.

In some implementations, the AssetExposureGraph 1840 may be traversed to compute one or more exposure paths across two or more of the assets 1850, the identities 1860, the privileges 1870, credentials, network segments, trust boundaries, connector permissions, reachable services, or the reachable targets 1880. The reachable targets 1880 may represent services, assets, data objects, or other protected targets that are reachable through an exposure path. The exposure paths may be scored and ranked according to at least exploitability confidence and remediation priority, and the ranking may be used to select a defensive action associated with at least one ranked exposure path.

In some implementations, information derived from the AssetExposureGraph 1840 may be bound into authority-plane processing for the defensive action. For example, a signed authority artifact may constrain execution of the defensive action, policy and risk may route the defensive action to a non-production validation environment or an authorized target environment, and execution may occur under a semantic-delta constraint. Evidence generated from the advisory/scanner 1810, the VulnerabilityRecord 1820, the SBOM/Package Map 1830, or the AssetExposureGraph 1840 may be included in an evidence bundle, a proof-of-exposure bundle, a patch-effect verification record, a containment simulation record, or a remediation selection record.

In some embodiments, the authority plane is extended with a defensive cybersecurity knowledge layer that stores machine-interpretable vulnerability, asset, privilege, identity, configuration, and remediation records. A VulnerabilityRecord may include one or more of an advisory identifier, a component fingerprint, a software bill of materials mapping, a version range, exploit preconditions, exposure evidence digests, a remediation state, a patch state, an environment binding, a confidentiality class, and a confidence score. The advisory identifier may reference a public vulnerability identifier, a vendor advisory identifier, an internal finding identifier, or another normalized record key. The knowledge layer may be implemented using a property graph, relational tables, adjacency lists, a hypergraph, document records, or another structure that preserves deterministic serialization for hashing and replay.

In some embodiments, the cybersecurity knowledge layer stores an AssetExposureGraph that links assets, services, packages, identities, roles, credentials, privileges, network segments, trust boundaries, connector endpoints, tickets, and remediation objects. An asset may be a host, virtual machine, container, browser workspace, mobile device, application instance, storage bucket, queue, secret scope, database, or another execution target. An edge may encode installation, reachability, dependency, trust, credential use, role inheritance, delegated authority, communication, patch lineage, or remediation lineage. The graph may further include environment measurements, package manifests, browser-extension manifests, connector manifests, and state digests from the existing authority-plane pipeline so that defensive cyber analysis is tied to the same deterministic provenance substrate as non-cyber execution.

In some embodiments, the system generates a containment simulation record before executing or recommending a containment action. The containment simulation record may identify a proposed containment action, one or more affected assets, identities, credentials, services, network segments, tickets, or data objects, a predicted semantic delta, a predicted exposure-path reduction, a predicted operational impact, a rollback or compensating-action option, and one or more policy constraints that limit execution of the proposed containment action. The containment simulation record may be generated in a non-production validation environment, replay environment, synthetic twin, or other bounded environment and may be included in an evidence bundle, replay bundle, ITSM object, case-management object, or remediation selection record.

In some embodiments, a remediation selection record stores information used to select among two or more candidate remediation actions. The remediation selection record may include identifiers of candidate remediations, associated ranked exposure paths, root-cause hypotheses, exploitability-confidence values, remediation-priority values, remediation-cost values, patch-availability values, expected-fix efficacy values, predicted semantic deltas, policy outcomes, required credentials, approval prerequisites, and reasons for selecting or rejecting each candidate remediation. The remediation selection record may be bound to a signed authority artifact or included in an evidence bundle for later replay verification or audit.

In some embodiments, remediation priority is computed from one or more of exploitability confidence, blast-radius estimate, environment criticality, protected-target sensitivity, patch availability, remediation cost, evidence completeness, ticket severity, policy criticality, or service-level timing requirements. The remediation priority may be used to rank exposure paths, select a defensive action, assign a queue priority, or determine whether execution should be routed to a sandbox, staging environment, production environment, replay environment, or human-review queue.

### Defensive Exposure-Path Analysis, Root-Cause Ranking, and Remediation Selection

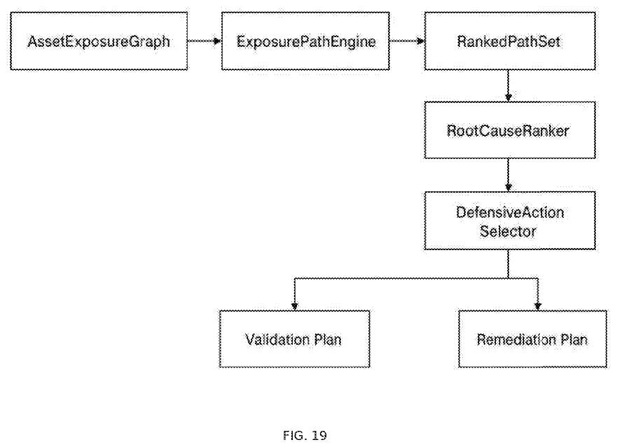

FIG. 19 illustrates an example of a vulnerability remediation flowchart 1900 configured for selecting bounded defensive responses based on exposure-path analysis in accordance with aspects of the present disclosure. In some implementations, the vulnerability remediation flowchart 1900 may include an AssetExposureGraph 1910, an ExposurePathEngine 1920, a RankedPathSet 1930, a RootCauseRanker 1940, a DefensiveAction Selector 1950, a Validation Plan 1960, and a Remediation Plan 1970. The vulnerability remediation flowchart 1900 may be used after vulnerability data has been normalized into one or more VulnerabilityRecords and after the AssetExposureGraph 1910 has been constructed to link one or more assets, identities, privileges, environment measurements, vulnerable components, and reachable targets.

The AssetExposureGraph 1910 may provide graph data representing relationships among assets, identities, roles, privileges, credentials, network segments, trust boundaries, connector permissions, reachable services, vulnerable components, and reachable targets. The ExposurePathEngine 1920 may receive the AssetExposureGraph 1910 and compute one or more exposure paths through the AssetExposureGraph 1910. For example, an exposure path may begin from an entry condition, such as an exposed service, a compromised token, a misconfigured identity, a stale package, an over-broad connector permission, or a vulnerable browser extension, and may terminate at a protected target, such as a privileged API, an administrative credential scope, a regulated data set, or a production deployment surface.

The ExposurePathEngine 1920 may output the RankedPathSet 1930. The RankedPathSet 1930 may include one or more exposure paths scored and ranked according to exploitability confidence, remediation priority, blast-radius estimate, required privileges, environment criticality, remediation cost, patch availability, evidence completeness, or combinations thereof. In some implementations, the RankedPathSet 1930 may preserve evidence associated with the one or more exposure paths, such that a proof-of-exposure bundle, a patch-effect verification record, a containment simulation record, or a remediation selection record can be generated without producing reusable executable exploit code, reusable exploit payloads, or unrestricted exploit scripts configured for reuse outside a non-production validation environment.

The RootCauseRanker 1940 may receive the RankedPathSet 1930 and generate a plurality of root-cause hypotheses for a failure condition or vulnerability condition represented by the one or more exposure paths. The RootCauseRanker 1940 may score the plurality of root-cause hypotheses based on semantic-delta anomalies, graph-fusion outputs, execution telemetry, checkpoint mismatches, policy-queue outcomes, reachability paths, vulnerability records, replay bundles, evidence coverage, contradiction scores, path consistency scores, prior frequency scores, expected-fix efficacy scores, recommended remediation classes, or combinations thereof. The RootCauseRanker 1940 may rank the plurality of root-cause hypotheses and provide the ranking to the DefensiveAction Selector 1950.

The DefensiveAction Selector 1950 may select a defensive action associated with at least one ranked exposure path and at least one ranked root-cause hypothesis. The defensive action may be constrained by a signed authority artifact, policy and risk, a semantic-delta constraint, an approved semantic-delta envelope, a derivation-graph digest, or a policy orchestration service. In some implementations, the defensive action may be routed to a non-production validation environment or an authorized target environment according to policy and risk. The defensive action may use a just-in-time scoped credential or scoped execution token bound to the signed authority artifact, and the just-in-time scoped credential or scoped execution token may be resolved only inside a non-model execution substrate.

The DefensiveAction Selector 1950 may output the Validation Plan 1960, the Remediation Plan 1970, or both. The Validation Plan 1960 may define actions for confirming exposure, validating patch effect, simulating containment, executing replay verification, or generating an evidence bundle before or after execution of the defensive action. The Remediation Plan 1970 may define bounded defensive artifacts, such as containment plans, patch-effect verification plans, credential-rotation plans, permission-narrowing plans, rollback plans, queue-priority updates, human-review requests, or ticket updates. In some implementations, execution events, evidence records, or remediation records associated with the Validation Plan 1960 or the Remediation Plan 1970 may be synchronized with an ITSM or case-management object having a lifecycle state selected from create, queue, assign, escalate, contain, validate, remediate, verify, reopen, close, SLA-breach, or policy-breach states.

In some embodiments, a defensive exposure-path engine computes one or more reachable paths through the AssetExposureGraph. A path may begin from an entry condition such as an exposed service, a compromised token, a misconfigured identity, a stale package, an over-broad connector permission, or a vulnerable browser extension, and may terminate at a protected target such as a privileged API, an administrative credential scope, a regulated data set, or a production deployment surface. The path engine may incorporate identity states, role assignments, network reachability, privilege requirements, trust boundaries, policy constraints, and semantic-delta risk. Path scoring may use one or more of exploitability confidence, blast-radius estimate, required privileges, environment criticality, remediation cost, patch availability, or evidence completeness.

In some embodiments, a ranked root-cause engine consumes execution telemetry, vulnerability records, graph-fusion results, replay bundles, reachability paths, checkpoint mismatches, semantic-delta anomalies, and policy-queue outcomes to generate a plurality of competing root-cause hypotheses. A RootCauseHypothesisRecord may include a hypothesis identifier, an evidence coverage score, a contradiction score, a path consistency score, a prior frequency score, an expected-fix efficacy score, and a recommended remediation class. Hypotheses may be ranked using symbolic rules, heuristic weighting, probabilistic scoring, graph algorithms, machine-learning models, or hybrid approaches. The highest-ranked hypothesis may be used to determine a containment action, a patch validation sequence, a checkpoint recovery branch, a ticket escalation, or a delegated remediation certificate.

In some embodiments, the defensive exposure-path engine does not output a generic offensive action plan. Instead, it produces one or more bounded defensive artifacts selected from containment plans, validation plans, patch-effect verification plans, credential-rotation plans, permission-narrowing plans, rollback plans, queue-priority updates, or human-review requests. The output may be encoded as a constrained action plan that is still subject to the signed action authority certificate, the approved semantic-delta envelope, the derivation-graph digest, and the policy orchestration service already described herein.

### Authorized Cyber Validation Sandboxes and Patch-Effect Verification

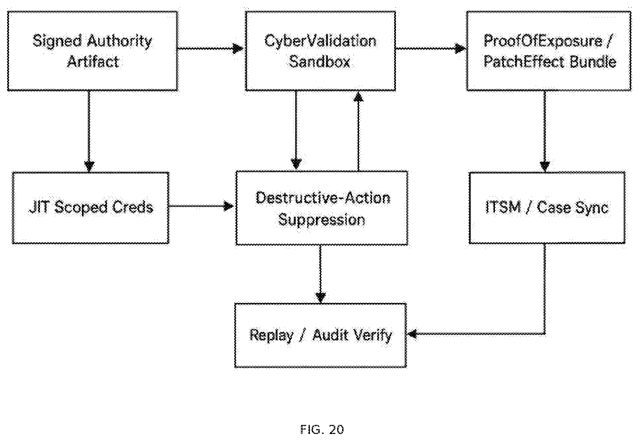

FIG. 20 illustrates an example of a cyber validation sandbox and patch-effect verification flow 2000 for validating a defensive action under certificate-bound control in accordance with aspects of the present disclosure. For example, the cyber validation sandbox and patch-effect verification flow 2000 may be configured to route a defensive action to a non-production validation environment, generate evidence associated with bounded exposure confirmation or patch-effect verification, synchronize the evidence with an ITSM or case-management object, and support replay or audit verification. In some implementations, the cyber validation sandbox and patch-effect verification flow 2000 may include a Signed Authority Artifact 2010, a CyberValidation Sandbox 2020, a ProofOfExposure/PatchEffect Bundle 2030, JIT Scoped Creds 2040, Destructive-Action Suppression 2050, ITSM/Case Sync 2060, and Replay/Audit Verify 2070.

The Signed Authority Artifact 2010 may constrain execution of the defensive action before the defensive action is allowed to operate in the Cyber Validation Sandbox 2020. The Signed Authority Artifact 2010 may bind one or more digests, policy values, scope values, actor values, time values, semantic-delta constraints, revocation values, or other execution constraints to the defensive action. The Signed Authority Artifact 2010 may provide authority to the Cyber Validation Sandbox 2020 and may also provide a credential-binding basis for the JIT Scoped Creds 2040. In some implementations, the defensive action is routed according to policy and risk such that potentially risky cyber-validation activities are performed in the Cyber Validation Sandbox 2020 rather than in a live production environment.

The Cyber Validation Sandbox 2020 may provide a non-production validation environment for bounded exploitability confirmation, containment simulation, patch-effect verification, or other defensive validation. The CyberValidation Sandbox 2020 may be instantiated from a snapshot, clone, synthetic twin, emulated service stack, replay environment, scrubbed replica, digital twin, instrumented container stack, or provider-managed validation lab. The CyberValidation Sandbox 2020 may receive synthetic credentials, reduced privileges, token placeholders, constrained network routes, synthetic or de-identified data, environment-specific policy bundles, or a validation target profile identifying an asset class, package state, advisory state, privilege state, or permitted validation modalities.

The JIT Scoped Creds 2040 may be issued for use in connection with the Cyber Validation Sandbox 2020, a patch-effect verification action, a ticket-bound containment action, or another bounded defensive task. In some implementations, the JIT Scoped Creds 2040 may include or be implemented as a just-in-time scoped credential or scoped execution token bound to the Signed Authority Artifact 2010. The JIT Scoped Creds 2040 may be resolved only inside a non-model execution substrate and may be limited by a scope identifier, an environment class, a privilege ceiling, an expiration, a revocation handle, a secret placeholder reference, or one or more permitted actions.

The Destructive-Action Suppression 2050 may receive constraints from the Cyber Validation Sandbox 2020 and may also receive authority or credential constraints associated with the JIT Scoped Creds 2040. The Destructive-Action Suppression 2050 may suppress destructive actions by policy, by capability scope, by environment class, or by semantic-delta limits. In some implementations, the Destructive-Action Suppression 2050 feeds control information back to the Cyber Validation Sandbox 2020 so that validation probes, transformations, and patch-effect actions remain within permitted modalities and maximum privilege ceilings. The Destructive-Action Suppression 2050 may further provide suppression events, policy outcomes, semantic-delta observations, or execution telemetry to the Replay/Audit Verify 2070.

The ProofOfExposure/PatchEffect Bundle 2030 may be generated by or from execution in the Cyber Validation Sandbox 2020. The ProofOfExposure/PatchEffect Bundle 2030 may include a proof-of-exposure bundle, a patch-effect verification record, a containment simulation record, a remediation selection record, an ExposureEvidenceBundle, or another evidence bundle associated with the defensive action. In some implementations, the ProofOfExposure/PatchEffect Bundle 2030 may include evidence digests, telemetry pointers, response codes, state diffs, screenshots, structured logs, before-and-after environment measurements, package versions, policy states, reachability paths, semantic deltas, exposure scores, provenance information, or validation results. The ProofOfExposure/PatchEffect Bundle 2030 may exclude reusable executable exploit code, reusable exploit payloads, or unrestricted exploit scripts configured for reuse outside the non-production validation environment.

The ITSM/Case Sync 2060 may receive the ProofOfExposure/PatchEffect Bundle 2030 and synchronize one or more execution events, evidence records, remediation records, validation runs, proof-of-exposure reviews, remediation plans, rollback actions, or patch verification results with an ITSM or case-management object. The ITSM or case-management object may have a lifecycle state selected from create, queue, assign, escalate, contain, validate, remediate, verify, reopen, close, SLA-breach, or policy-breach states. Synchronization performed by the ITSM/Case Sync 2060 may be one-way or two-way and may be mediated through connectors, APIs, queues, spreadsheets, documents, chat channels, or other interfaces.

The Replay/Audit Verify 2070 may receive verification inputs from the Destructive-Action Suppression 2050 and the ITSM/Case Sync 2060. In some implementations, the Replay/Audit Verify 2070 may use the Signed Authority Artifact 2010, one or more digests, proof-of-exposure information, patch-effect information, suppression events, lifecycle-state information, provenance information, and signature-verification artifacts to verify that the defensive action remained within the signed authority, applicable policy, environment constraints, and semantic-delta constraint. The Replay/Audit Verify 2070 may support after-the-fact verification, audit review, rollback analysis, compensating-action selection, queue escalation, or generation of a revised remediation plan when a path remains reachable, a privilege ceiling is exceeded, or policy or state drift is detected.

In some embodiments, potentially risky cyber-validation activities are routed to a dedicated non-production validation environment rather than to a live production environment. A Cyber ValidationSandbox may be instantiated from a snapshot, clone, synthetic twin, emulated service stack, replay environment, or scrubbed replica. The sandbox may receive synthetic credentials, reduced privileges, token placeholders, constrained network routes, synthetic or de-identified data, and environment-specific policy bundles. A validation target profile may identify the asset class, package state, advisory state, privilege state, and permitted validation modalities. Destructive actions may be suppressed by policy, by capability scope, by environment class, or by semantic-delta limits.

In some embodiments, the system performs bounded exploitability confirmation rather than unrestricted exploit development. A ProofOfExposurePlan may include a verification objective, one or more environment preconditions, one or more allowed probes or transformations, a maximum privilege ceiling, a destructive-action prohibition, and one or more evidence outputs. Execution may produce an ExposureEvidenceBundle containing evidence digests, telemetry pointers, response codes, state diffs, screenshots, structured logs, or other artifacts sufficient to support remediation without materializing reusable executable exploit code, reusable exploit payloads, or unrestricted exploit scripts configured for reuse outside the non-production validation environment. The proof bundle may be associated with a ticket, a policy queue item, a root-cause hypothesis, and a replay bundle for later audit.

In some embodiments, the system performs patch-effect verification after a remediation action or proposed remediation action. A PatchEffect VerificationRecord may compare pre-remediation and post-remediation environment measurements, package versions, policy states, reachability paths, semantic deltas, and exposure scores. If a path remains reachable, if a privilege ceiling is exceeded, or if a policy or state drift is detected, the system may trigger rollback, compensating actions, queue escalation, a new checkpoint token, or a revised remediation plan. Patch-effect verification may be performed in a sandbox first and later in a bounded production mode using a narrower certificate and a narrower semantic-delta envelope.

### Jit Cyber Credentials, Itsm and Case Synchronization, and Competitor Variations

In some embodiments, cybersecurity workflows use just-in-time scoped credentials that are narrower than baseline automation credentials. A JITCyberCredentialRecord may include a scope identifier, a certificate binding, an environment class, a privilege ceiling, an expiration, a revocation handle, a secret placeholder reference, and one or more permitted actions. The JIT credential may be issued only for a cyber validation sandbox, for a patch-effect verification action, for a ticket-bound containment action, or for another bounded defensive task. Secret values may still be resolved only inside a non-model execution substrate, and any secret-derived output may be masked, digested, or restricted before reentering memory, prompts, logs, or ITSM comments.

In some embodiments, the authority plane synchronizes cybersecurity-specific lifecycle objects with ITSM or case-management systems. A lifecycle object may represent one or more of an incident, ticket, problem, change request, advisory review, validation run, proof-of-exposure review, remediation plan, rollback action, or patch verification result. The lifecycle object may include states such as create, queue, assign, escalate, contain, validate, remediate, verify, reopen, close, SLA-breach, or policy-breach. Synchronization may be one-way or two-way and may be mediated through connectors, APIs, queues, spreadsheets, documents, chat channels, or other interfaces.

A competitor may substitute a vendor advisory service, an internal red-team knowledge base, a software bill of materials repository, an EDR or scanner output, a configuration-risk registry, or another vulnerability feed for a public vulnerability database while preserving the same normalized VulnerabilityRecord and AssetExposureGraph concepts. A competitor may encode reachability analysis as a graph traversal, symbolic solver result, probabilistic risk lattice, rule engine, or machine-learning ranking model while still performing the same defensive exposure-path selection. A competitor may implement the cyber validation environment using a cloned host, a digital twin, an emulator, an instrumented container stack, a replay substrate, or a provider-managed validation lab. These and analogous substitutions remain within the scope of the disclosure when they preserve the machine-interpretable defensive artifacts, bounded execution semantics, and provenance-linked validation pipeline described herein.

### Cybersecurity Use Cases

In one non-limiting use case, a browser-oriented enterprise agent receives evidence that a package installed in a production web application is subject to a high-severity advisory. The system normalizes the advisory into a VulnerabilityRecord, links the record to package manifests, environment measurements, identities, and reachable connector permissions, and computes ranked exposure paths. A defensive certificate is issued for a sandboxed patch-effect verification action. The system applies the candidate patch in a non-production validation environment, recomputes reachability, and packages an ExposureEvidenceBundle and PatchEffectVerificationRecord for change approval.

In another non-limiting use case, an internal service account is discovered to have broader privileges than required and to retain reachability to a sensitive target through a vulnerable connector chain. The system constructs a root-cause ranking showing that excessive delegated permissions are the most probable cause of the exposure path, issues a narrowed credential and a remediation certificate, validates the narrower permissions in a replay or staging environment, and then synchronizes the resulting remediation plan and evidence bundle to an ITSM ticket.

In another non-limiting use case, a mobile or remote-session remediation workflow identifies a vulnerable client component, clones a validation environment, and performs bounded proof-of-exposure confirmation without releasing unrestricted exploit artifacts. The resulting evidence bundle is attached to a case record, and any subsequent production action remains constrained by a semantic-delta envelope, a policy queue, checkpoint recovery rules, and rollback or compensating actions.

### Alternatives and Variations

An implementation may encode the authority artifact as JSON, CBOR, database rows, protocol buffers, or another machine-readable format. The disclosure therefore is not limited to any particular encoding.

An implementation may omit one bound field for low-risk actions while retaining other bound fields. The disclosure preserves support for certificates that bind fewer or more fields depending on risk and policy.

An implementation may use a single signing service, distributed signers, threshold signers, or enclave-backed signers. The disclosure is not limited to any one signing topology.

An implementation may represent the semantic-delta envelope as field rules, graph rules, diff rules, or state-machine rules. The disclosure preserves all such variants.

An implementation may represent derivation influence using an acyclic graph, cyclic graph, lineage list, weighted influence map, or compressed digest tree. The disclosure is not limited to a single graph structure.

An implementation may perform delegated execution through sub-agents, tools, workers, connector-specific processes, or mobile-side executors. The disclosure covers each such delegated narrowing arrangement.

An implementation may store resume packages locally, remotely, in queues, in databases, or inside workflow manifests. The disclosure is not limited to any one persistence substrate.

An implementation may resolve secrets inside a local trusted process, a container, an enclave, a browser harness, a mobile sandbox, or a remote trusted service. The disclosure covers each such out-of-band secret-resolution arrangement.

### Non-Limiting Use Cases

In one non-limiting use case, an AI spreadsheet agent proposes a set of cell and formula edits. The system canonicalizes the proposal, computes a spreadsheet-range semantic-delta envelope, binds the envelope into an action authority certificate together with a workbook-state digest, and suppresses completion if the actual edits exceed the approved range or modify forbidden sheets.

In another non-limiting use case, a browser agent proposes to update records through a CRM connector. A derivation graph shows that an external email and a retrieved document influenced the update. Because the graph contains an untrusted source and the action class is a write, the execution gate requires a narrower semantic-delta envelope and an updated certificate before allowing execution.

In another non-limiting use case, a parent orchestration agent delegates a limited data-export task to a child connector agent. The child certificate is issued only for a strict subset of fields and records, and revocation of the parent certificate immediately invalidates the child certificate.

In another non-limiting use case, a scheduled nightly workflow resumes after a policy update and a connector-version change. Resume-time drift detection invalidates the prior certificate and blocks execution until a new certificate is issued.

In another non-limiting use case, a code-deployment workflow uses secret placeholders for cloud credentials. The secret broker resolves the placeholders only inside a deployment substrate, and restricted output labels prevent secret-derived values from entering model memory or external reports.

In another non-limiting use case, an incident-response team receives a replay bundle and verifies that an executed action matched the certificate-bound state, policy, environment, derivation, and semantic-delta constraints.

These examples are illustrative and do not limit the claims.

In one non-limiting use case, a browser-based remediation branch fails after a modal dialog appears that was not present in the source-derived plan. The graph-fusion subsystem infers a hidden confirmation state, the root-cause engine ranks hidden-state mismatch above stale policy as the most likely cause, and the recovery subsystem resumes from a last verified checkpoint token while the policy queue delays promotion to production until the hidden-state branch is verified.

In another non-limiting use case, a remote support session is shared between a human operator and an AI agent. The AI agent receives a scoped action certificate and a JIT credential for a specific configuration task, performs only allowed actions in a sandbox or staging class, updates an associated incident ticket, and relinquishes control when the human operator asserts an override or when a queue timeout expires.

In another non-limiting use case, a document or spreadsheet remediation is proposed using both source-derived workflow evidence and GUI-derived observations. The graph-fusion subsystem ranks candidate paths, the policy orchestrator transforms one contemplated production action into a lower-risk staging action, and the checkpoint subsystem stores a verified-state token so later scheduled continuation can reauthorize only if state, policy, environment, and derivation digests still match.

### Interpretations

The headings used herein are for convenience only and do not limit the scope of the disclosure or claims.

Unless otherwise stated, including, includes, comprising, and comprises are open-ended terms that do not exclude additional elements or steps.

The term or is inclusive unless the context clearly indicates otherwise. The terms “a” and “an” generally mean one or more unless the context clearly indicates otherwise.

Examples, thresholds, rule sets, schemas, digest algorithms, signature schemes, transport formats, and deployment choices described herein are non-limiting. Equivalent structures and alternate implementations may be used.

Steps may be performed in different orders, in parallel, iteratively, or with intermediate steps unless expressly required by the claims.

Nothing in the detailed description should be read as surrendering subject matter not expressly disclaimed. The disclosure is intended to support claim amendments, continuations, divisionals, and continuation-in-part filings consistent with applicable law.

What is claimed is:

1. A computer-implemented method comprising:
receiving a proposed action associated with an autonomous artificial intelligence system;
canonicalizing the proposed action into a canonical action descriptor; computing a canonical action digest over a deterministic serialization of the canonical action descriptor;
obtaining or computing a pre-execution state digest associated with a pre-execution state artifact;
obtaining or computing a policy snapshot hash associated with a policy state applicable to the proposed action;
obtaining or computing an environment measurement digest associated with an execution environment for the proposed action;
obtaining or computing an approved semantic-delta envelope associated with the proposed action;
constructing a derivation graph associated with the proposed action and computing a derivation-graph digest over a canonical representation of the derivation graph;
generating a signed action authority certificate bound to at least the canonical action digest, the pre-execution state digest, the policy snapshot hash, the environment measurement digest, the approved semantic-delta envelope or a digest thereof, and the derivation-graph digest;
validating the signed action authority certificate before execution of the proposed action;
suppressing execution of the proposed action when certificate validation fails; executing the proposed action when certificate validation succeeds; computing an actual semantic delta associated with execution of the proposed action;
comparing the actual semantic delta to the approved semantic-delta envelope; and
initiating at least one containment action when the actual semantic delta exceeds the approved semantic-delta envelope.

2. The method of claim 1, wherein validating the signed action authority certificate comprises validating a signature, validating nonce uniqueness, validating an expiration condition, validating a revocation status, recomputing a current pre-execution state digest, recomputing a current policy snapshot hash, recomputing a current environment measurement digest, recomputing a current derivation-graph digest, comparing the recomputed values to corresponding certificate-bound values, and suppressing execution when any required comparison fails.

3. The method of claim 1, wherein at least one node of the derivation graph includes trust metadata or confidentiality metadata and wherein validating the signed action authority certificate depends on the trust metadata or confidentiality metadata.

4. The method of claim 1, further comprising:
generating a delegated child authority certificate from a parent authority certificate,
wherein the delegated child authority certificate encodes a strict subset of one or more authority dimensions encoded in the parent authority certificate, including one or more of a target-resource scope, an action class, an allowed semantic delta, or an expiration window.

5. The method of claim 1, further comprising:
storing a resume package for a paused, queued, recurring, or scheduled workflow and, upon resume or scheduled activation, recomputing one or more current digests and invalidating the signed action authority certificate when material drift is detected.

6. The method of claim 1, wherein the proposed action references a placeholder for a secret rather than a raw secret value and wherein a secret broker resolves the placeholder only inside a non-model execution substrate that is outside model-visible context.

7. The method of claim 6, further comprising:
applying a restricted-output label to content derived from an execution that consumed the secret; and
preventing the restricted-output-labeled content from entering model-visible context absent authorization.

8. The method of claim 1, further comprising:
generating a cryptographic provenance record comprising at least the canonical action descriptor, the signed action authority certificate, one or more validation results, one or more digests used for validation, provenance associated with execution of the proposed action, the actual semantic delta, and a signature or integrity digest over the cryptographic provenance record; and
replay-verifying the proposed action by:
recomputing at least one digest,
validating at least one signature,
validating nonce uniqueness, and
comparing the actual semantic delta to the approved semantic-delta envelope.

9. The method of claim 1, further comprising:
generating a verified-state checkpoint token after one or more verification conditions are satisfied; and
responsive to a divergence event, failure event, drift event, or channel-switch predicate, generating a continuity capsule linking a predecessor authority artifact, the verified-state checkpoint token, one or more state digests, a policy snapshot hash, an environment measurement digest, a derivation-graph digest, and a successor authority artifact.

10. The method of claim 1, wherein a policy orchestration service produces one or more outcomes selected from allow, deny, transform, delay, reroute, queue, or require-approval outcomes for the proposed action, generates or evaluates a channel-binding record identifying a primary channel, one or more alternate channels, one or more switch_predicates, a verifier sufficiency profile, a permitted environment-class set, and one or more non-expansion constraints, and routes the proposed action to one of a sandbox class, a staging class, a pre-production class, a production class, a replay class, or a forensic class.

11. A system comprising:
one or more processors; and
memory storing instructions that, when executed by the one or more processors, cause the system to:
receive a proposed action associated with an autonomous artificial intelligence system;
canonicalize the proposed action into a canonical action descriptor;
compute a canonical action digest;
compute or obtain a pre-execution state digest, a policy snapshot hash, an environment measurement digest, and a derivation-graph digest;
generate or obtain an approved semantic-delta envelope;
issue a signed action authority certificate bound to the canonical action digest, the pre-execution state digest, the policy snapshot hash, the environment measurement digest, the approved semantic-delta envelope or a digest thereof, and the derivation-graph digest; validate the signed action authority certificate before permitting execution of the proposed action;
compare an actual semantic delta resulting from execution of the proposed action to the approved semantic-delta envelope; and
trigger a containment action when validation fails or when the actual semantic delta exceeds the approved semantic-delta envelope.

12. The system of claim 11, wherein:
the signed action authority certificate further binds an agent identity, a human sponsor identifier, a tenant identifier, a role class, or a delegation-lineage identifier, and wherein validation of the signed action authority certificate comprises verifying that the bound identity or lineage remains authorized for the proposed action.

13. The system of claim 11, wherein the system further comprises:
an execution gate configured to suppress execution when a current pre-execution state digest differs from the pre-execution state digest bound into the signed action authority certificate and to initiate rollback, quarantine, or a compensating workflow when the actual semantic delta exceeds the approved semantic-delta envelope.

14. The system of claim 11, wherein the system further comprises:
a delegated-authority service configured to issue a delegated child authority certificate only when the delegated child authority certificate encodes a strict subset of one or more authority dimensions encoded in a parent authority certificate.

15. The system of claim 11, wherein the system further comprises:
a reauthorization service configured to invalidate a stored certificate for a paused or scheduled workflow when one or more of policy drift, environment drift, derivation drift, state drift, or permission drift is detected.

16. The system of claim 11, wherein the system further comprises:
a root-cause service configured to generate a plurality of root-cause hypotheses for a failure condition, score the plurality of root-cause hypotheses based on at least one of semantic-delta anomalies, graph-fusion outputs, execution telemetry, checkpoint mismatches, or policy-queue outcomes, rank the plurality of root-cause hypotheses, and select a remediation action according to the ranking.

17. The system of claim 11, wherein the system further comprises:
a graph-fusion service configured to construct a source-derived workflow graph and a GUI-derived workflow graph, compute node-correspondence scores and edge weights for candidate correspondences between the workflow graphs, and select a ranked path from a merged graph derived from the candidate correspondences.

18. The system of claim 11, wherein the system further comprises:
a shared-control remediation service configured to establish a shared-control session between a human operator and an AI agent using a control token or scoped action certificate that constrains a portion of a local or remote session under agent control.

19. The system of claim 11, wherein the system is configured to issue a successor authority certificate after a channel switch and to prevent the successor authority certificate from enlarging resource scope, privilege ceiling, environment class, semantic-delta ceiling, execution count, or side-effect budget relative to a predecessor authority certificate absent fresh approval or higher-authority authorization.

20. A non-transitory computer-readable medium storing instructions that, when executed by one or more processors, cause a system to perform the method comprising:
receiving a proposed action associated with an autonomous artificial intelligence system;
canonicalizing the proposed action into a canonical action descriptor; computing a canonical action digest over a deterministic serialization of the canonical action descriptor;
obtaining or computing a pre-execution state digest associated with a pre-execution state artifact;
obtaining or computing a policy snapshot hash associated with a policy state applicable to the proposed action;
obtaining or computing an environment measurement digest associated with an execution environment for the proposed action;
obtaining or computing an approved semantic-delta envelope associated with the proposed action;
constructing a derivation graph associated with the proposed action and computing a derivation-graph digest over a canonical representation of the derivation graph;
generating a signed action authority certificate bound to at least the canonical action digest, the pre-execution state digest, the policy snapshot hash, the environment measurement digest, the approved semantic-delta envelope or a digest thereof, and the derivation-graph digest;
validating the signed action authority certificate before execution of the proposed action;
suppressing execution of the proposed action when certificate validation fails; executing the proposed action when certificate validation succeeds; computing an actual semantic delta associated with execution of the proposed action;
comparing the actual semantic delta to the approved semantic-delta envelope; and
initiating at least one containment action when the actual semantic delta exceeds the approved semantic-delta envelope.

21. The non-transitory computer-readable medium of claim 20, wherein the instructions further cause the system to store a revocation handle in association with the signed action authority certificate and to invalidate the signed action authority certificate responsive to a revocation event.

22. The non-transitory computer-readable medium of claim 20, wherein the instructions further cause the system to package a paused or scheduled workflow into a resume package and to invalidate prior authority when material drift is detected before resumed execution.

23. The non-transitory computer-readable medium of claim 20, wherein the instructions further cause the system to resolve a secret placeholder reference only inside a non-model execution substrate that is outside model-visible context and to prevent secret-derived content from reentering model-visible context absent authorization.

24. A computer-implemented method comprising:
receiving a contemplated action, workflow segment, recovery branch, or execution-graph edge associated with an autonomous artificial intelligence system;
computing a channel availability vector for at least two channels selected from a source-analysis channel, a GUI-observation or GUI-action channel, a programmatic execution channel, a browser channel, an operating-system channel, a command-line channel, an application programming interface channel, a connector channel, or a mobile-device channel;
generating a channel-binding record identifying a primary channel, one or more alternate channels, one or more switch_predicates, a verifier sufficiency profile, a permitted environment-class set, and one or more non-expansion constraints;
binding the channel-binding record or a digest thereof into a signed authority artifact;
validating the signed authority artifact before releasing execution through the primary channel;
detecting drift, verifier insufficiency, policy change, permission loss, channel unavailability, GUI ambiguity, layout change, rate limit, timeout, partial action failure, irreversible side-effect proximity, or human override;
responsive to the detecting, generating a continuity capsule linking a predecessor authority artifact, a verified-state checkpoint token, one or more state digests, a policy snapshot hash, an environment measurement digest, a derivation-graph digest, and a successor authority artifact; and
continuing execution through a successor channel only when the successor authority artifact satisfies the one or more non-expansion constraints,
wherein the one or more non-expansion constraints prevent enlargement of resource scope, privilege ceiling, environment class, semantic-delta ceiling, execution count, or side-effect budget absent fresh approval or higher-authority authorization.

25. The method of claim 24, wherein the channel availability vector comprises one or more of a source-visibility indicator, an API or connector reachability indicator, a GUI observability indicator, a permission indicator, an environment-class indicator, a verifier-sufficiency indicator, a latency or cost indicator, an irreversibility indicator, or a risk indicator.

26. The method of claim 24, wherein the verifier sufficiency profile requires evidence selected from return codes, object-model states, screenshots, document object model evidence, accessibility-tree evidence, log entries, file diffs, user-visible confirmations, database state, ticket state, configuration state, or mobile device state.

27. The method of claim 24, wherein the execution-graph edge is a channel-substitutable edge for which more than one channel is authorized to achieve substantially the same semantic effect subject to the channel-binding record.

28. The method of claim 24, wherein the successor authority artifact cannot enlarge resource scope, privilege ceiling, environment class, semantic-delta ceiling, execution count, or side-effect budget relative to the predecessor authority artifact absent fresh approval or higher-authority authorization.

29. The method of claim 24, further comprising generating a fused provenance timeline that records source-analysis steps, GUI-observation or GUI-action steps, and programmatic execution steps in a shared lineage graph and permits replay verification that cross-channel execution remained within approved semantic bounds.

30. The method of claim 24, further comprising routing execution from a sandbox class to a staging class or production class only after a verifier, policy engine, or human approver confirms that a semantic-delta envelope remains within an approved bound, and demoting execution to a replay class, forensic class, or observation-only class when drift, elevated risk, verifier insufficiency, or a digest mismatch is detected.
